(19) United States
(12) Patent Application Publication
(10) Pub. No.: US 2008/0105148 A1
(43) Pub. Date: May 8, 2008

(54) INK FEED CONTROL METHOD AND INK FEED CONTROL SYSTEM

(75) Inventors: Akehiro KUSAKA, Noda-shi (JP); Hiromitsu Numauchi, Tsukuba-shi (JP)

Correspondence Address: BIRCH STEWART KOLASCH & BIRCH, PO BOX 747, FALLS CHURCH, VA, 22040-0747, US

(73) Assignee: KOMORI CORPORATION, Tokyo (JP)

(21) Appl. No.: 11/927,541

(22) Filed: Oct. 29, 2007

(30) Foreign Application Priority Data
Oct. 30, 2006 (JP) 2006-293565

(51) Int. Cl. B41F 1/46

(52) U.S. Cl. 101/363; 101/484

(57) ABSTRACT

An ink feed control method for a printing press in which ink, supplied to an ink fountain roller from a gap between each ink fountain key and the ink fountain roller by the rotation of the ink fountain roller, is supplied to the printing plate by swing operation of an ink ductor roller, so that a print is eventually made on a print sheet with the ink supplied to the printing plate, the method including the steps of: measuring any one of the density and the ink film thickness of a first printing product made by the printing press; and controlling the number of times of the swing operation of the ink ductor roller relative to the rotation of the printing press in accordance with the value of the measured one of the density and the ink film thickness of the first printing product.

### BACKGROUND OF THE INVENTION

1. Field of the Invention

The present invention relates to an ink feed control method and an ink feed control system for a printing press.

2. Description of the Related Art

A printing press is provided with an inking device for supplying ink to a printing plate. FIG. 48 shows a schematic side view of an inking device 100 of a general printing press. Descriptions will be given below of the inking device 100 with reference to FIG. 48. Reference numeral 101 denotes a plate cylinder, which is pivotally supported by an unillustrated pair of left and right frames, and a plate for printing is mounted on the circumferential surface of the plate cylinder 101. Two pairs of ink form rollers 103 are detachably in contact with the surface of the plate cylinder 101. Each pair of ink form rollers 103 are supported by a corresponding one of a pair of oscillating rollers 102 with an arm in between. In addition, three distribution rollers 104 are provided above the oscillating rollers 102 in a manner that the circumferential surfaces of the distribution rollers 104 are in contact with one another.

One of these distribution rollers 104 is in contact with an oscillating roller 105. The group of rollers arranged as described above and an ink supply device 107, which will be described later, constitute the inking device 100. Specifically, the ink supply device 107 includes an ink fountain roller 108. The ink fountain roller 108 is linked to, and is thus driven by, the same drive system as those of the plate cylinder 101 and the oscillating rollers 102, 105 and the like, to intermittently rotate at a low speed. An ink fountain 112, in which ink 111 is stored, is formed by the circumferential surface of the ink fountain roller 108, ink fountain keys 109, and left and right ink dams 110.

An oscillating roller 113 is pivotally supported by the left and right frames with bearings in between at the middle portion between the ink fountain roller 108 and the oscillating roller 105 in a manner that the oscillating roller 113 can reciprocate in the axial direction thereof. In addition, a ductor roller 114 is provided between the oscillating roller 113 and the ink fountain roller 108, and reciprocates between the rollers 108 and 113 while being alternately brought into contact with these rollers 108 and 113. Moreover, a distribution roller 115 is disposed between the oscillating rollers 105 and 113 in a manner that the circumferential surface of the distribution roller 115 is in contact with both the rollers 105 and 113.

With this configuration, the ink 111 stored in the ink fountain 112 flows out from a gap between the circumferential surface of the ink fountain roller 108 and each of the ink fountain keys 109, and is then carried by the ink fountain roller 108 rotating in a direction indicated by the arrow in FIG. 48 so as to form an ink film on the circumferential surface of the ink fountain roller 108. This ink film is transferred to the oscillating roller 113 by the ductor roller 114, which reciprocally moves between the ink fountain roller 108 and the oscillating roller 113. After that, the ink film is leveled in each direction while being sequentially transferred by many rollers, and is eventually supplied to the plate surface of the plate cylinder 101 by the ink form rollers 103.

In the inking device 100 configured as described above, the ink fountain keys 109 are separated into a plurality of pieces in the axial direction of the ink fountain roller 108. The gap between each of the separated ink fountain keys 109 (109-1 to 109-N) and the circumferential surface of the ink fountain roller 108 is independently adjustable. This makes it possible to adjust an amount of ink to be applied to the key zone of each of the ink fountain keys 109-1 to 109-N.

In such an inking device 100, when printing products have a small image area each, the amount of ink to be transferred to the plate surface is also small, and thus a large amount of ink is caused to return into the inking device 100. For this reason, the printing density of the printing products is gradually increased with a normal printing condition. Accordingly, for the purpose of reducing the amount of ink to be supplied, the ink feeding operation of the ink ductor roll has conventionally been executed intermittently in accordance with an image area ratio so that the above-described problem can be solved. Japanese Patent Application Laid-open Publication No. 2004-202947 discloses an example of such an ink feeding method.

However, in the ink feeding method disclosed in Japanese Patent Application Laid-open Publication No. 2004-202947, it is difficult to make an accurate determination only with an image area ratio in the case of producing printing products with a thin ink film thickness, such as in the case of producing those by relief printing. Accordingly, as long as printing products to be printed have a thin ink film thickness, even if these printing products to be printed have a large image area ratio, the amount of supplied ink often becomes too large, leading to a gradual increase in the printing density of the printing products. Eventually, normal printing products cannot be produced.

### SUMMARY OF THE INVENTION

In view of above-described circumstances, it is an object of the present invention to provide an ink feed control method and an ink feed control system, each of which makes it possible to control the number of feedings in accordance with the printing density or the ink film thickness of printing products.

A first aspect of the present invention for achieving the above-described object provides an ink feed control method for a printing press that includes: an ink fountain roller; a plurality of ink fountain keys aligned in the axial direction of the ink fountain roller; an ink ductor roller swingably provided in an ink supply path from the ink fountain roller to a printing plate; and ink ductor roller swing means for swinging the ink ductor roller, in which printing press, ink, supplied to the ink fountain roller from a gap between each ink fountain key and the ink fountain roller by the rotation of the ink fountain roller, is supplied to the printing plate by swing operation of the ink ductor roller, so that a print is eventually made on a print sheet with the ink supplied to the printing plate. The ink feed control method includes the steps of: measuring any one of the density and the ink film thickness of a first printing product made by the printing press; and controlling the number of times of the swing operation of the ink ductor roller relative to the rotation of the printing press in accordance with the value of the measured one of the density and the ink film thickness.

A second aspect of the present invention for achieving the above-described object provides the ink feed control method according to the first aspect additionally, which includes the steps of: measuring the same one of the density and the ink film thickness of a second printing product, that has been measured for the first printing product, the second printing product being printed after a predetermined number of printing products subsequent to the first printing product are made by the printing press subsequent to the first printing product; calculating the difference between the values, for the first and the second printing products, of the measured one of the density and the ink film thickness; and controlling the number of times of the swing operation of the ink ductor roller relative to the rotation of the printing press in accordance with the calculated difference.

A third aspect of the present invention for achieving the above-described object provides the ink feed control method according to the first aspect having the following feature. Specifically, in the method, the number of times of the swing operation of the ink ductor roller relative to the rotation of the printing press is controlled in accordance with the value of the measured one of the density and the ink film thickness.

A fourth aspect of the present invention for achieving the above-described object provides the ink feed control method according to the first aspect, which includes a step of activating ink ductor roller stop means, which stops the swing of the ink ductor roller, in accordance with the value of the measured one of the density and the ink film thickness.

A fifth aspect of the present invention for achieving the above-described object provides the ink feed control method according to the first aspect, which includes a step of controlling the rotation speed of a dedicated motor, which is provided to the ink ductor roller swing means, in accordance with the value of the measured one of the density and the ink film thickness.

A sixth aspect of the present invention for achieving the above-described object provides an ink feed control system for a printing press that includes: an ink fountain roller; a plurality of ink fountain keys aligned in the axial direction of the ink fountain roller; an ink ductor roller swingably provided in an ink supply path from the ink fountain roller to a printing plate; and ink ductor roller swing means for swinging the ink ductor roller, in which printing press, ink, supplied to the ink fountain roller from a gap between each ink fountain key and the ink fountain roller by the rotation of the ink fountain roller, is supplied to the printing plate by swing operation of the ink ductor roller, so that a print is eventually made on a print sheet with the ink supplied to the printing plate. The ink feed control system includes any one of density measurement means, which measures the density of a first printing product made by the printing press, and ink-film-thickness measurement means, which measures the ink film thickness of the first printing product; and ink ductor roller swing number control means, which controls the number of times of the swing operation of the ink ductor roller relative to the rotation of the printing press, in accordance with the value of the measured one of the density and the ink film thickness.

A seventh aspect of the present invention for achieving the above-described object provides the ink feed control system according to the sixth aspect having the following feature. Specifically, in the ink feed control system, the same one of the density and the ink film thickness of a second printing product is measured, that has been measured for the first printing product, the second printing product being printed after a predetermined number of printing products subsequent to the first printing product are made by the printing press. Then, the difference between the values, for the first and the second printing products, of the measured one of the density and the ink film thickness is obtained. The number of times of the swing operation of the ink ductor roller relative to the rotation of the printing press is thus controlled in accordance with the obtained difference.

An eighth aspect of the present invention for achieving the above-described object provides the ink feed control system according to the sixth aspect having the following feature. Specifically, in the ink feed control system, the number of times of the swing operation of the ink ductor roller relative to the rotation of the printing press is controlled in accordance with an image area ratio of a printing product to be made by the printing press.

A ninth aspect of the present invention for achieving the above-described object provides the ink feed control system according to the sixth aspect having the following feature. Specifically, the ink feed control system further includes ink ductor roller stop means, which stops the swing of the ink ductor roller. In addition, in the ink feed control system, the ink ductor roller stop means is activated in accordance with the value of the measured one of the density and the ink film thickness.

A tenth aspect of the present invention for achieving the above-described object provides the ink feed control system according to the sixth aspect having the following feature. Specifically, the ink feed control system further includes a dedicated motor for the ink ductor roller swing means. In addition, in the ink feed control system, the rotation speed of the dedicated motor is controlled in accordance with the value of the measured one of the density and the ink film thickness.

### BRIEF DESCRIPTION OF THE DRAWINGS

The present invention will become more fully understood from the detailed description given hereinbelow and the accompanying drawings which are given by way of illustration only, and thus are not limitative of the present invention and wherein:

FIG. 1 shows a side view of principal parts of an inking device of a printing press according to first and fourth embodiments of the present invention;

FIG. 2 shows a side view of principal parts of an inking device of a printing press according to second and third embodiments of the present invention;

FIG. 3 shows a side view of a calorimeter according to the first and third embodiments of the present invention;

FIG. 4 shows a printing product that is printed by the printing press according to the first and third embodiments of the present invention;

FIG. 5 shows a plan view of an ink film thickness measuring device according to the second and fourth embodiments of the present invention;

FIG. 6 shows a side view of the ink film thickness measuring device according to the second and fourth embodiments of the present invention;

FIG. 7A shows a hardware block diagram of an ink supply amount control apparatus according to the first embodiment of the present invention;

FIG. 7B shows a hardware block diagram subsequent to FIG. 7A;

FIG. 8 shows a hardware block diagram of an ink feeding number control device according to the first embodiment;

FIG. 9 shows a hardware block diagram of an ink fountain roller rotation speed control device according to the first embodiment of the present invention;

FIG. 10 shows a hardware block diagram of an ink fountain key opening degree control device according to the first embodiment of the present invention;

FIG. 11A shows an operational flowchart of the ink supply amount control apparatus according to the first embodiment of the present invention;

FIG. 11B shows an operational flowchart subsequent to FIG. 11A;

FIG. 11C shows an operational flowchart subsequent to FIG. 11B;

FIG. 11D shows an operational flowchart subsequent to FIG. 11C;

FIG. 12A shows an operational flowchart subsequent to FIG. 11D;

FIG. 12B shows an operational flowchart subsequent to FIG. 12A;

FIG. 12C shows an operational flowchart subsequent to FIG. 12B;

FIG. 13A shows an operational flowchart subsequent to FIG. 12C;

FIG. 13B shows an operational flowchart subsequent to FIG. 13A;

FIG. 14A shows an operational flowchart of the ink fountain key opening degree control device, which controls the opening degree of each ink fountain key, according to the first embodiment of the present invention;

FIG. 14B shows an operational flowchart subsequent to FIG. 14A;

FIG. 15 shows an operational flowchart of the ink fountain roller rotation speed control device, which controls the rotation amount of each ink fountain roller, according to the first embodiment of the present invention;

FIG. 16 shows an operational flowchart of the ink feeding number control device, which controls the number of feedings of each ink, according to the first embodiment of the present invention;

FIG. 17A shows a hardware block diagram of an ink supply amount control apparatus according to the second embodiment of the present invention;

FIG. 17B shows a hardware block diagram subsequent to FIG. 17A;

FIG. 18 shows a hardware block diagram of an ink feeding number control device according to the second embodiment of the present invention;

FIG. 19 shows a hardware block diagram of an ink fountain roller rotation speed control device according to the second embodiment of the present invention;

FIG. 20 shows a hardware block diagram of an ink fountain key opening degree control device according to the second embodiment of the present invention;

FIG. 21A shows an operational flowchart of the ink supply amount control apparatus according to the second embodiment of the present invention;

FIG. 21B shows an operational flowchart subsequent to FIG. 21A;

FIG. 21C shows an operational flowchart subsequent to FIG. 21B;

FIG. 21D shows an operational flowchart subsequent to FIG. 21C;

FIG. 22A shows an operational flowchart subsequent to FIG. 21D;

FIG. 22B shows an operational flowchart subsequent to FIG. 22A;

FIG. 23A shows an operational flowchart subsequent to FIG. 22B;

FIG. 23B shows an operational flowchart subsequent to FIG. 22A;

FIG. 24A shows an operational flowchart of the ink fountain key opening degree control device, which controls the opening degree of each ink fountain key, according to the second embodiment of the present invention;

FIG. 24B shows an operational flowchart subsequent to FIG. 24A;

FIG. 25 shows an operational flowchart of the ink fountain roller rotation speed control device, which controls the rotation amount of each ink fountain roller, according to the second embodiment of the present invention;

FIG. 26 shows an operational flowchart of the ink feeding number control device, which controls the number of feedings of each ink, according to the second embodiment of the present invention;

FIG. 27A shows a hardware block diagram of an ink supply amount control apparatus according to the third embodiment of the present invention;

FIG. 27B shows a hardware block diagram subsequent to FIG. 27A;

FIG. 28 shows a hardware block diagram of an ink feeding number control device according to the third embodiment of the present invention;

FIG. 29 shows a hardware block diagram of an ink fountain roller rotation speed control device according to the third embodiment of the present invention;

FIG. 30 shows a hardware block diagram of an ink fountain key opening degree control device according to the third embodiment of the present invention;

FIG. 31A shows an operational flowchart of the ink supply amount control apparatus according to the third embodiment of the present invention;

FIG. 31B shows an operational flowchart subsequent to FIG. 31A;

FIG. 31C shows an operational flowchart subsequent to FIG. 31B;

FIG. 32A shows an operational flowchart subsequent to FIG. 31C;

FIG. 32B shows an operational flowchart subsequent to FIG. 32A;

FIG. 33A shows an operational flowchart subsequent to FIG. 32B;

FIG. 33B shows an operational flowchart subsequent to FIG. 33A;

FIG. 33C shows an operational flowchart subsequent to FIG. 33B;

FIG. 34A shows an operational flowchart subsequent to FIG. 33C;

FIG. 34B shows an operational flowchart subsequent to FIG. 34A;

FIG. 35A shows an operational flowchart of the ink fountain key opening degree control device, which controls the opening degree of each ink fountain key, according to the third embodiment of the present invention;

FIG. 35B shows an operational flowchart subsequent to FIG. 35A;

FIG. 36 shows an operational flowchart of the ink fountain roller rotation speed control device, which controls the rotation amount of each ink fountain roller, according to the third embodiment of the present invention;

FIG. 37 shows an operational flowchart of the ink feeding number control device, which controls the number of feedings of each ink, according to the third embodiment of the present invention;

FIG. 38A is a hardware block diagram of an ink supply amount control apparatus according to the fourth embodiment of the present invention;

FIG. 38B shows a hardware block diagram subsequent to FIG. 38A;

FIG. 39 shows a hardware block diagram of an ink feeding number control device according to the fourth embodiment of the present invention;

FIG. 40 shows a hardware block diagram of an ink fountain roller rotation speed control device according to the fourth embodiment of the present invention;

FIG. 41 shows a hardware block diagram of an ink fountain key opening degree control device according to the fourth embodiment of the present invention;

FIG. 42A shows an operational flowchart of the ink supply amount control apparatus according to the fourth embodiment of the present invention;

FIG. 42B shows an operational flowchart subsequent to FIG. 42A;

FIG. 42C shows an operational flowchart subsequent to FIG. 42B;

FIG. 43A shows an operational flowchart subsequent to FIG. 42C;

FIG. 43B shows an operational flowchart subsequent to FIG. 43A;

FIG. 44A shows an operational flowchart subsequent to FIG. 43B;

FIG. 44B shows an operational flowchart subsequent to FIG. 44A;

FIG. 45A shows an operational flowchart of the ink fountain key opening degree control device, which controls the opening degree of each ink fountain key, according to the fourth embodiment of the present invention;

FIG. 45B shows an operational flowchart subsequent to FIG. 45A;

FIG. 46 shows an operational flowchart of the ink fountain roller rotation speed control device, which controls the rotation amount of each ink fountain roller, according to the fourth embodiment of the present invention;

FIG. 47 shows an operational flowchart of the ink feeding number control device, which controls the number of feedings of each ink, according to the fourth embodiment of the present invention; and

FIG. 48 shows a schematic side view of an inking device of a general printing press.

### DETAILED DESCRIPTION OF THE INVENTION

Hereinafter, ink feed control systems according to the present invention will be described using the accompanying drawings.

### First Embodiment

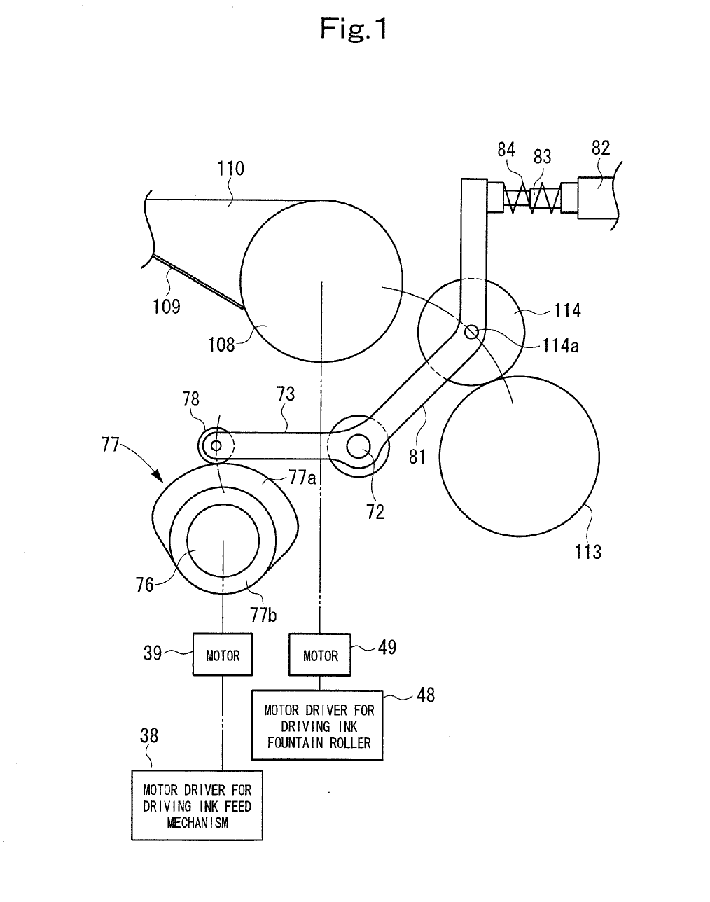

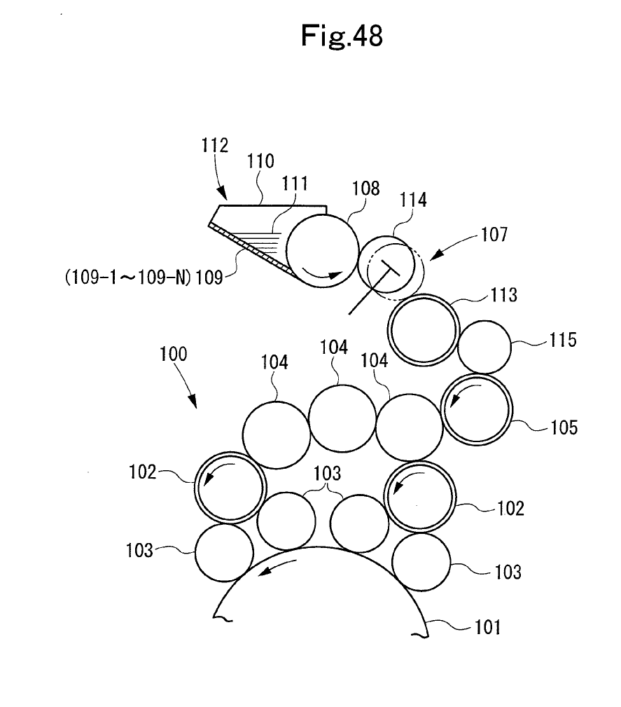

Firstly, descriptions will be given of the device configuration of an ink feed control system according to a first embodiment of the present invention. FIG. 1 is a side view showing principal parts of an inking device of a printing press according to the first embodiment of the present invention. In FIG. 1, the same reference numerals denote components that are the same as, or similar to, those described in the above-mentioned conventional technique shown in FIG. 48, and detailed descriptions of the same components will be omitted. An ink fountain roller 108 is provided as a roller on an upstream side in the ink transfer direction, while a distribution roller 113 is provided as a roller on the downstream side in the ink transfer direction. A ductor roller 114, and a ductor shaft 72, which serves as a swing fulcrum for swinging the ductor roller 114, are pivotally supported by the left and right frames (not illustrated) so as to rotate, between the ink fountain roller 108 and the distribution roller 113. One of the shaft ends of the ductor shaft 72 protrudes from the frame, and a cam lever 73 is provided to this protruding portion of the ductor shaft 72. The ink fountain roller 108 is driven by a motor 49 for driving the ink fountain roller 108. The motor 49 for driving the ink fountain roller is controlled by a motor driver 48 for driving the ink fountain roller 108.

A camshaft 76 is implanted into the frames at a position obliquely below the ductor shaft 72. A cam 77 is pivotally supported by the camshaft 76 so as to be rotatable. The cam 77 has a cam surface composed of a large-diameter portion 77a and a small-diameter portion 77b. A cam follower 78 provided at one end portion of the cam lever 73 faces, and is in contact with, the cam surface. The cam 77 is driven by a motor 39 for driving the ink feed mechanism. The motor 39 for driving the ink feed mechanism is controlled by a motor driver 38 for driving the ink feed mechanism. A pair of left and right swing levers 81 are pivotally mounted on the ductor shaft 72 inside the frames, while the ductor roller 114 is pivotally supported, at the two end shafts 114a, by the swing levers 81 so as to be rotatable. In the inking device of the printing press according to the first embodiment of the present invention, the ink feed mechanism, which includes the cam 77, the cam lever 73 and the like, constitutes ink ductor roller swing means.

The upper end portion of the swing lever 81 extends upward, and a spring shaft 83 is axially mounted on the upper end portion, while the spring shaft 83 is supported, at one end thereof, by a spring bearing 82, which projects from the frames. A compression coil spring 84 is mounted on the spring shaft 83. The compression coil spring 84 applies a rotational force to the ductor roller 114 so as to rotate the ductor roller 114 in the counterclockwise direction in FIG. 1, that is, so as to bring the ductor roller 114 into contact with the ink fountain roller 108. On the other hand, the rotation of a drive motor is transmitted to the distribution roller 113, so that the distribution roller 113 reciprocates once in the axial direction as the plate cylinder 101 (see FIG. 48) rotates twice.

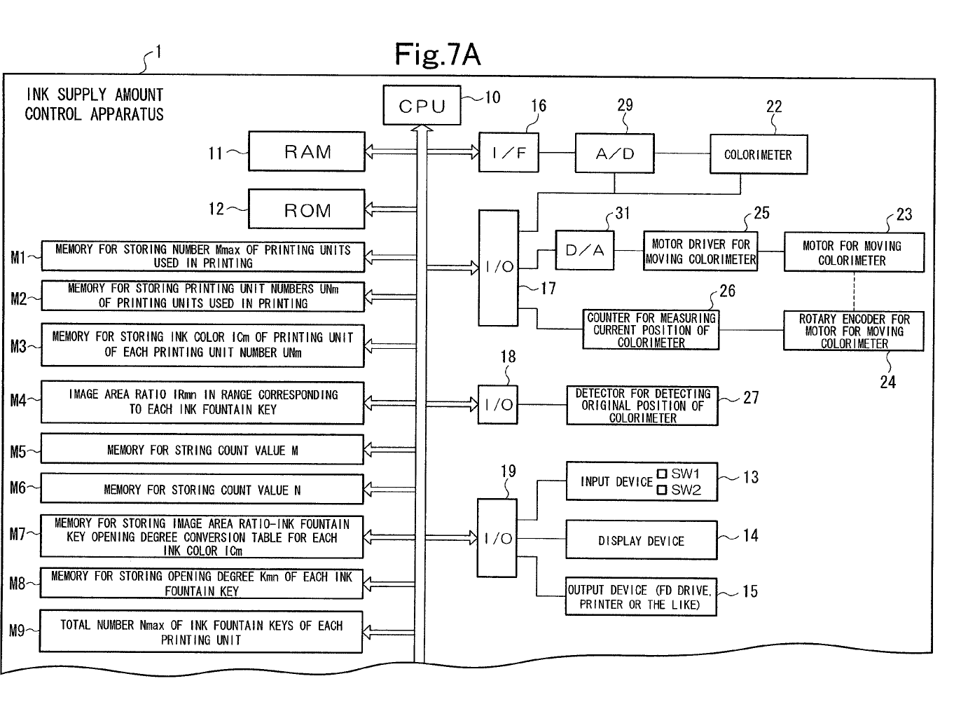

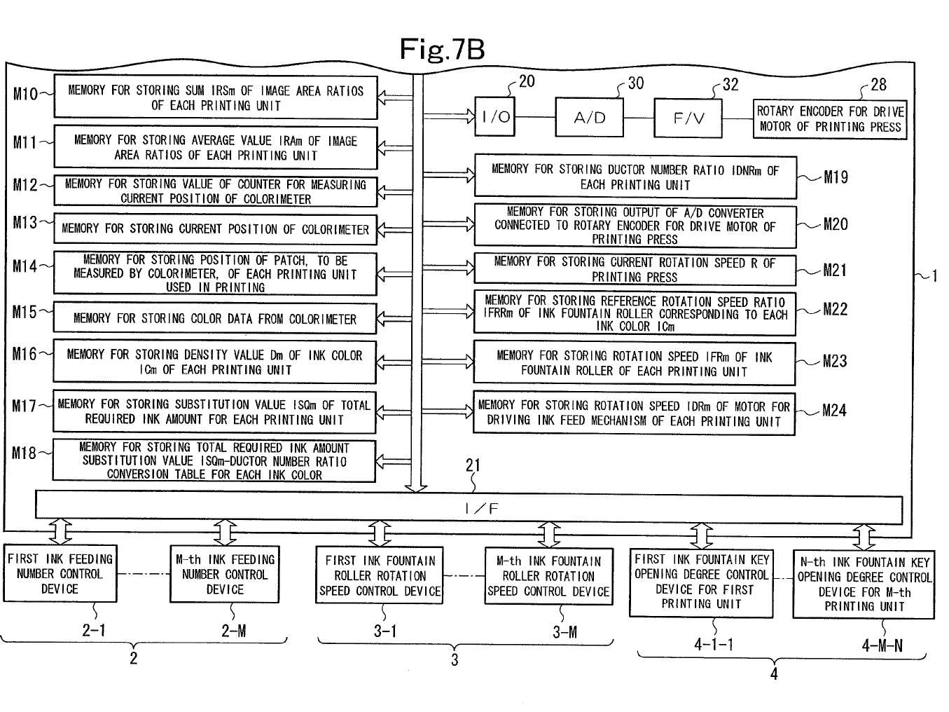

Next, an ink supply amount control apparatus according to the first embodiment of the present invention will be described. FIGS. 7A and 7B show hardware block diagrams of the ink supply amount control apparatus according to the first embodiment of the present invention. As shown in FIGS. 7A and 7B, the ink supply amount control apparatus 1 includes a CPU 10, a RAM 11, a ROM 12, an input device 13, a display device 14, an output device 15, input/output interfaces (I/O, I/F) 16 to 21, a colorimeter 22, a motor 23 for moving the colorimeter, a rotary encoder 24 for the motor for the moving the calorimeter, a motor driver 25 for moving the calorimeter, a counter 26 for measuring the current position of the calorimeter, a detector 27 for detecting the original position of the calorimeter, a rotary encoder 28 for the drive motor of the printing press, A/D converters 29 and 30, a D/A converter 31, an F/V converter 32, and memories M1 to M24.

The CPU 10 obtains various kinds of information which are inputted thereto through the interfaces 16 to 21, and operates in accordance with a program stored in the ROM 12, while accessing the RAM 11 as well as the memories M1 to M24. The input device 13 is provided with an ink preset switch SW1, a density-value measuring switch SW2 and the like. The motor driver 25 for moving the calorimeter controls the motor 23 for moving the calorimeter. The rotary encoder 24 for the motor for moving the colorimeter generates one rotation pulse for every predetermined number of rotations (angle) of the motor 23 for moving the calorimeter, and then outputs the rotation pulse to the counter 26 for measuring the current position of the calorimeter. The rotary encoder 28 for the drive motor of the printing press generates one rotation pulse for every predetermined number of rotations (angle) of the drive motor, and then outputs the rotation pulse to the input/output interface 20.

In the ink supply amount control apparatus 1, in the memory M1, the number Mmax of printing units used in the printing is stored. In the memory M2, the printing unit number UNm of each printing unit used in the printing is stored. In the memory M3, the ink color ICm of the printing unit of each printing unit number UNm is stored. In the memory M4, the image area ratio IRmn of a range corresponding to each ink fountain key is stored.

In the memory M5, a count value M is stored. In the memory M6, a count value N is stored. In the memory M7, a conversion table between an image area ratio corresponding to each ink color ICm and an opening degree of the ink fountain key (hereinafter, referred to as an image area ratio-ink fountain key opening degree conversion table for each ink color ICm) is stored. In the memory M8, the opening degree Kmn of each ink fountain key is stored. In the memory M9, the total number Nmax of ink fountain keys of each printing unit is stored.

In the memory M10, the sum IRSm of the image area ratios of each printing unit is stored. In the memory M11, the average value IRAm of the image area ratios of each printing unit is stored. In the memory M12, a value of the counter for measuring the current position of the colorimeter is stored. In the memory M13, the current position of the colorimeter is stored. In the memory M14, the position of a patch, which is to be measured by the calorimeter, of each printing unit used in the printing is stored.

In the memory M15, color data from the calorimeter is stored. In the memory M16, a density value Dm of the ink color ICm of each printing unit is stored. In the memory M17, a substitution value ISQm of the total required ink amount for each printing unit is stored. In the memory M18, a conversion table between a substitution value ISQm of a total required ink amount for each ink color ICm and a ductor number ratio (hereinafter, referred to as a total required ink amount substitution value ISQm-ductor number ratio conversion table for each ink color ICm) is stored. In the memory M19, a ductor number ratio IDNRm of each printing unit is stored.

In the memory M20, an output of the A/D converter connected to the rotary encoder 28 for the drive motor of the printing press is stored. In the memory M21, the current rotation speed R of the printing press is stored. In the memory M22, the reference rotation speed ratio IFRRm of the ink fountain roller corresponding to each ink color ICm is stored. In the memory M23, the rotation speed IFRm of the ink fountain roller of each printing unit is stored. In the memory M24, the rotation speed IDRm of the motor for driving the ink feed mechanism of each printing unit is stored.

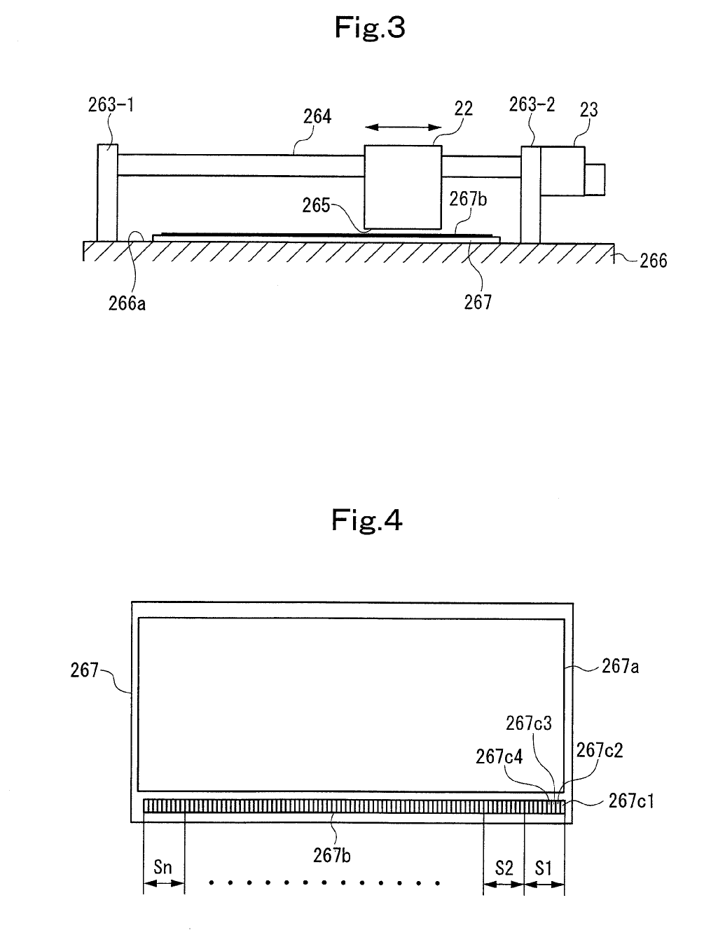

FIG. 3 is a side view showing the colorimeter (density measuring means) according to the first embodiment of the present invention. As shown in FIG. 3, the colorimeter 22 is attached to a ball screw (feed screw) 264 provided between supporting columns 263-1 and 263-2. The ball screw 264 is caused to rotate in both normal and reverse directions by the motor 23 for moving the calorimeter. The colorimeter 22 is caused to move between the supporting columns 263-1 and 263-2 by the normal and reverse rotations of the ball screw 264 while being guided by the ball screw 264. A head portion 265 of the colorimeter 22 is configured to face a surface 266a, on which a measurement subject is to be placed, of a measurement stage 266.

Now, a printing product that is printed by the printing press according to the first embodiment of the present invention is shown. FIG. 4 shows a printing product that is printed by the printing press according to the first embodiment of the present invention. A band-shaped color bar 267b is printed in a margin portion except for an image region 267a on a printing product. In general four-color printing, the color bar 267b is composed of regions S1 to Sn including density measurement patches (solid patches with a dot area ratio of 100%) 267c1, 267c2, 267c3 and 267c4 of black, cyan, magenta and yellow. The regions S1 to Sn correspond to the key zones of the respective ink fountain keys 109-1 to 109-N in the printing unit of each color in the printing press.

A reference density value is set in advance for the printing unit of each color. In other words, a reference density value is set in advance for each of the colors: black, cyan, magenta and yellow. In the printing of the printing product 267, a color matching operation is performed so that the density value of each color can match the reference density value. This color matching operation is performed by the ink supply amount control apparatus 1 on the basis of the density of each of the density measurement patches 267c of the respective colors (267c1, 267c2, 267c3 and 267c4) in the color bar 267b printed on the printing product 267.

At the time of color matching before the starting of a final printing, the operator sets the printing product 267 having been printed by the printing press on the measurement stage 266 (see FIG. 3) as the measurement subject. In this setting state, the color bar 267b having been printed on the printing product 267 is positioned below the head portion 265 (see FIG. 3) of the calorimeter 22. In this state, the operator gives an instruction to start the color matching operation by using the input device 13.

An ink feeding number control device 2, an ink fountain roller rotation speed control device 3 and an ink fountain key opening degree control device 4 are connected to the ink supply amount control apparatus 1 through the interface 21. The ink feeding number control device 2 controls the number of feedings of each ink. The ink fountain roller rotation speed control device 3 controls the rotation amount of each ink fountain roller. The ink fountain key opening degree control device 4 controls the opening degree of each of the ink fountain keys 109-1 to 109-N of each color.

The ink feeding number control device 2 includes first to M-th ink feeding number control devices 2-1 to 2-M. The ink fountain roller rotation speed control device 3 includes first to M-th ink fountain roller rotation speed control devices 3-1 to 3-M. The ink fountain key opening degree control device 4 includes a first ink fountain key opening degree control device 4-1-1 for first printing unit, to an N-th ink fountain key opening degree control device 4-M-N for M-th printing unit.

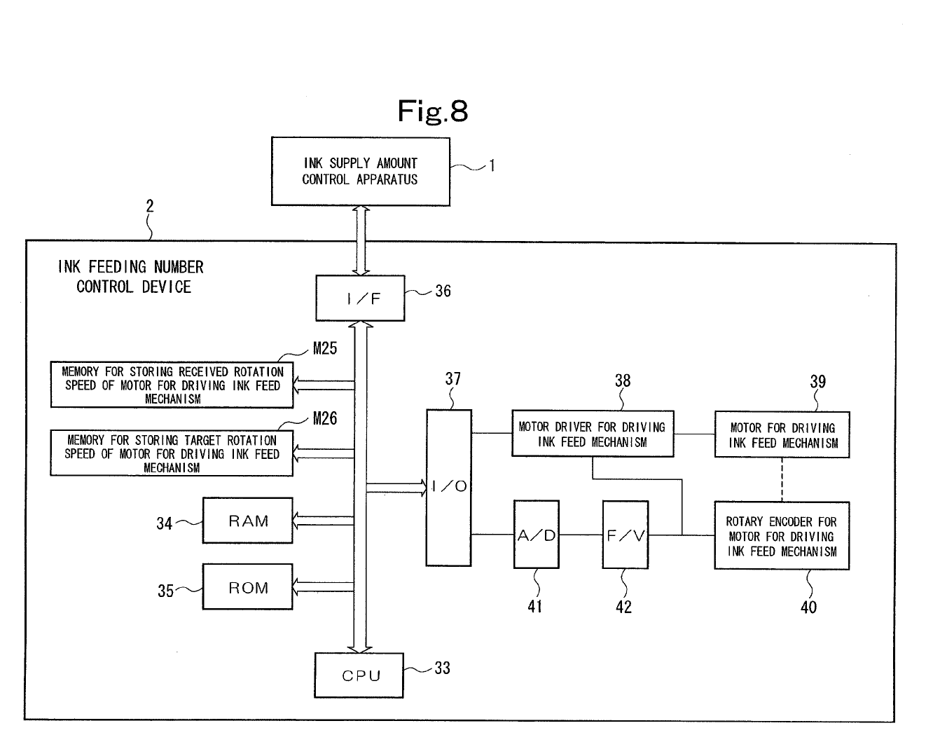

Next, the ink feeding number control device (ink ductor roller swing means) according to the first embodiment of the present invention will be described. FIG. 8 shows a hardware block diagram of the ink feeding number control device according to the first embodiment of the present invention. As shown in FIG. 8, the ink feeding number control device 2 includes a CPU 33, a RAM 34, a ROM 35, input/output interfaces (I/O, I/F) 36 and 37, a motor driver 38 for driving the ink feed mechanism, a motor 39 for driving the ink feed mechanism, a rotary encoder 40 for the motor for driving the ink feed mechanism, an A/D converter 41, an F/V converter 42, and memories M25 and M26.

The CPU 33 obtains various kinds of inputted information that are provided through the interfaces 36 and 37, and operates in accordance with a program stored in the ROM 35, while accessing the RAM 34 as well as the memories M25 and M26. The motor driver 38 for driving the ink feed mechanism controls the motor 39 for driving the ink feed mechanism. The rotary encoder 40 for the motor for driving the ink feed mechanism generates one rotation pulse for every predetermined number of rotations (angle) of the motor 39 for driving the ink feed mechanism, and then outputs the rotation pulse to the input/output interface 37.

In the ink feeding number control device 2, in the memory M25, a received rotation speed of the motor for driving the ink feed mechanism is stored. In the memory M26, a target rotation speed IDRm of the motor for driving the ink feed mechanism is stored.

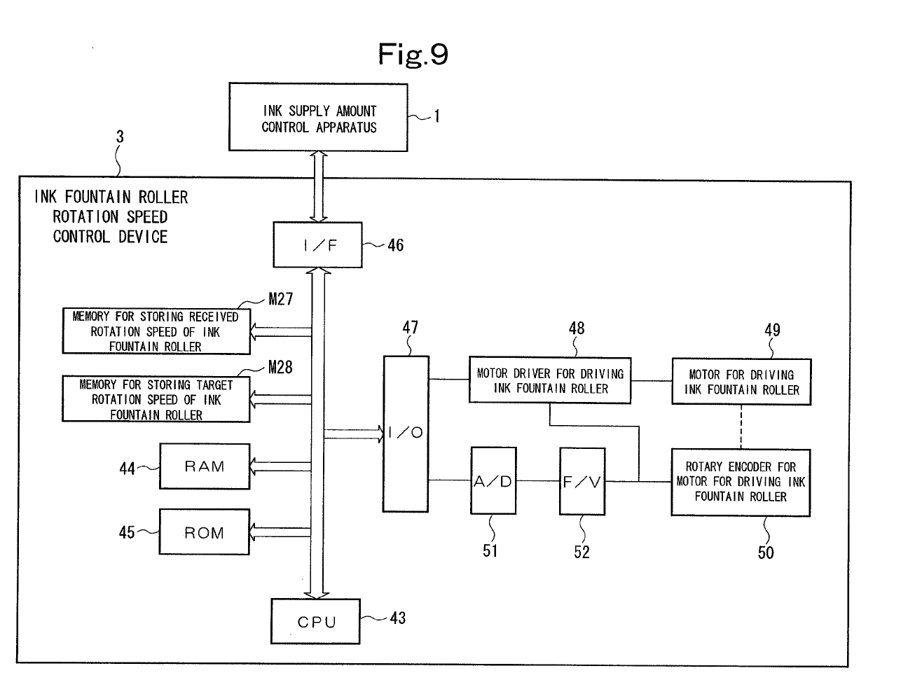

Next, the ink fountain roller rotation speed control device according to the first embodiment of the present invention will be described. FIG. 9 shows a hardware block diagram of the ink fountain roller rotation speed control device according to the first embodiment of the present invention. As shown in FIG. 9, the ink fountain roller rotation speed control device 3 includes a CPU 43, a RAM 44, a ROM 45, input/output interfaces (I/O, I/F) 46 and 47, a motor driver 48 for driving the ink fountain roller, a motor 49 for driving the ink fountain roller, a rotary encoder 50 for the motor for driving the ink fountain roller, an A/D converter 51, an F/V converter 52, and memories M27 and M28.

The CPU 43 obtains various kinds of information which are inputted thereto through the interfaces 46 and 47, and operates in accordance with a program stored in the ROM 45, while accessing the RAM 44 as well as the memories M27 and M28. The motor driver 48 for driving the ink fountain roller controls the motor 49 for driving the ink fountain roller. The rotary encoder 50 for the motor for driving the ink fountain roller generates one rotation pulse for every predetermined number of rotations (angle) of the motor 49 for driving the ink fountain roller, and then outputs the rotation pulse to the input/output interface 47.

In the ink fountain roller rotation speed control device 3, in the memory M27, a received rotation speed of the ink fountain roller is stored. In the memory M28, a target rotation speed of the ink fountain roller is stored.

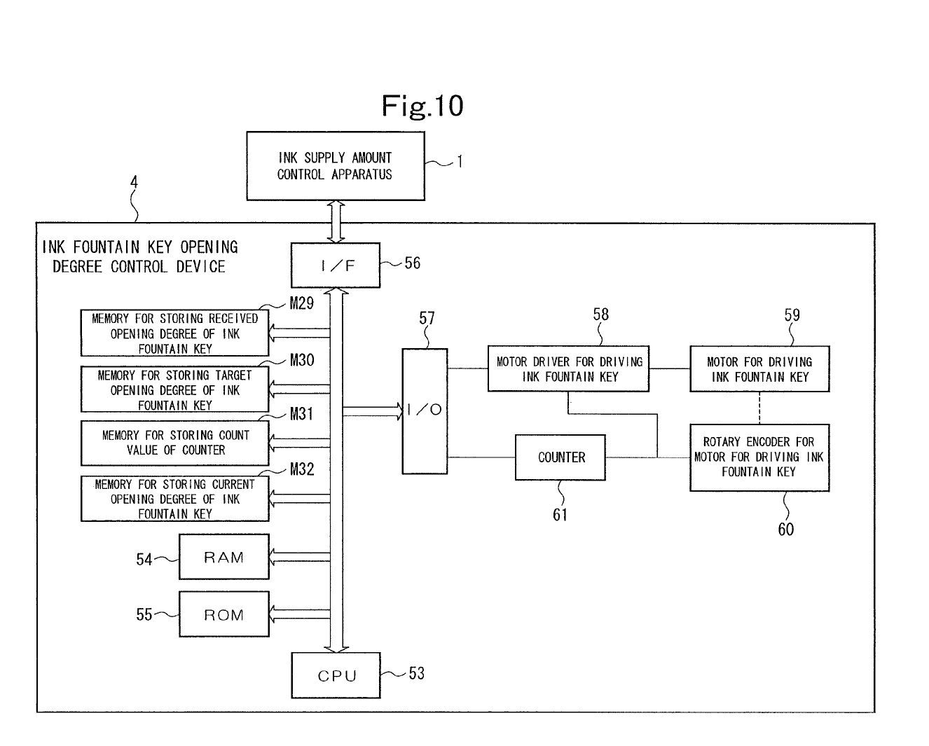

Next, the ink fountain key opening degree control device according to the first embodiment of the present invention will be described. FIG. 10 shows a hardware block diagram of the ink fountain key opening degree control device according to the first embodiment of the present invention. As shown in FIG. 10, the ink fountain key opening degree control device 4 includes a CPU 53, a RAM 54, a ROM 55, input/output interfaces (I/O, I/F) 56 and 57, a motor driver 58 for driving the ink fountain key 109, a motor 59 for driving the ink fountain key 109, a rotary encoder 60 for the motor for driving the ink fountain key 109, a counter 61, and memories M29 to M32.

The CPU 53 obtains various kinds of information which are inputted thereto through the interfaces 56 and 57, and operates in accordance with a program stored in the ROM 55, while accessing the RAM 54 as well as the memories M29 to M32.

In the ink fountain key opening degree control device 4, in the memory M29, a received opening degree of the ink fountain key 109 is stored. In the memory M30, a target opening degree of the ink fountain key 109 is stored. In the memory M31, a count value of the counter 61 is stored. In the memory M32, the current opening degree of the ink fountain key 109 is stored.

Note that, in FIG. 7B, the ink fountain key opening degree control devices 4-1-1 to 4-M-N are the ink fountain key opening degree control devices 4 provided for the respective ink fountain keys 109 (109-1 to 109-N) of the corresponding colors, which are shown in FIG. 48. With the ink fountain key opening degree control devices 4-1-1 to 4-M-N, the opening degrees of the ink fountain keys 109-1 to 109-N of each color are individually adjusted with respect to the corresponding ink fountain roller 108.

The ink fountain key opening degree control device 4 includes the motor driver 58 for driving the ink fountain key, the motor 59 for driving the ink fountain key, the rotary encoder 60 for the motor for driving the ink fountain key, and the counter 61. The ink fountain key opening degree control device 4 is connected to the CPU 10 of the ink supply amount control apparatus 1 through the interface 56. The rotary encoder 60 for the motor for driving the ink fountain key generates one rotation pulse for every predetermined number of rotations (angle) of the motor 59 for driving the ink fountain key, and then outputs the rotation pulse to the counter 61.

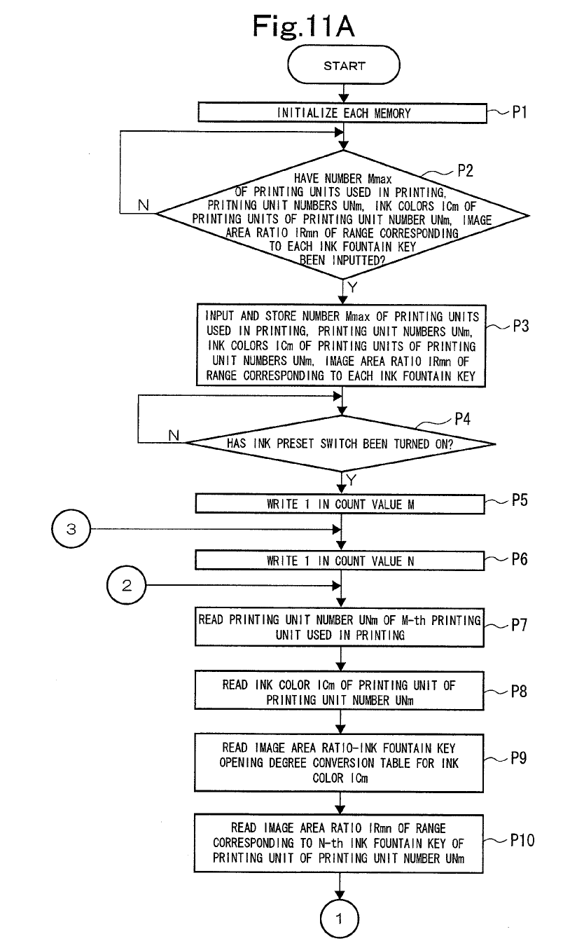

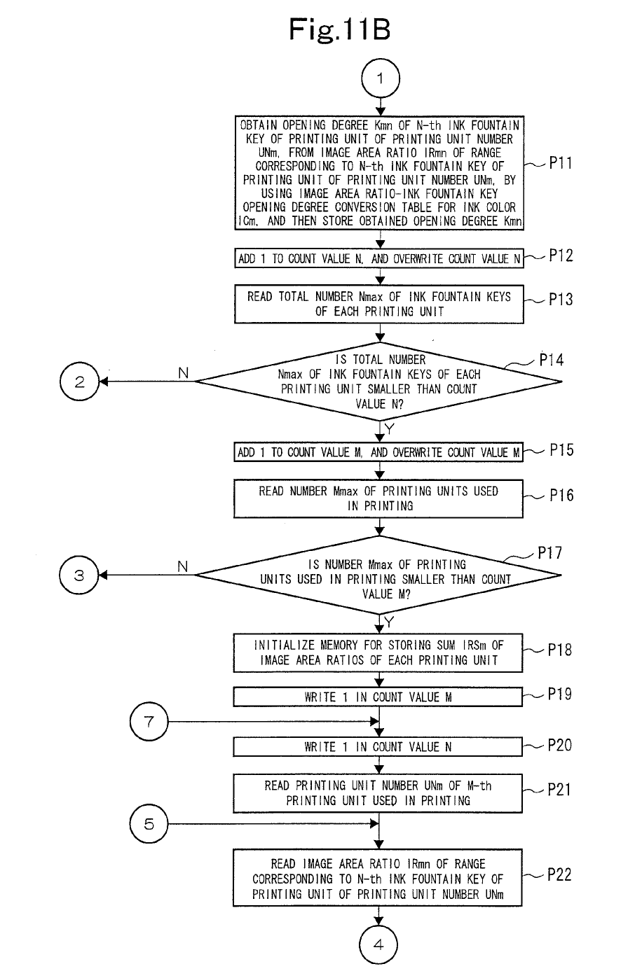

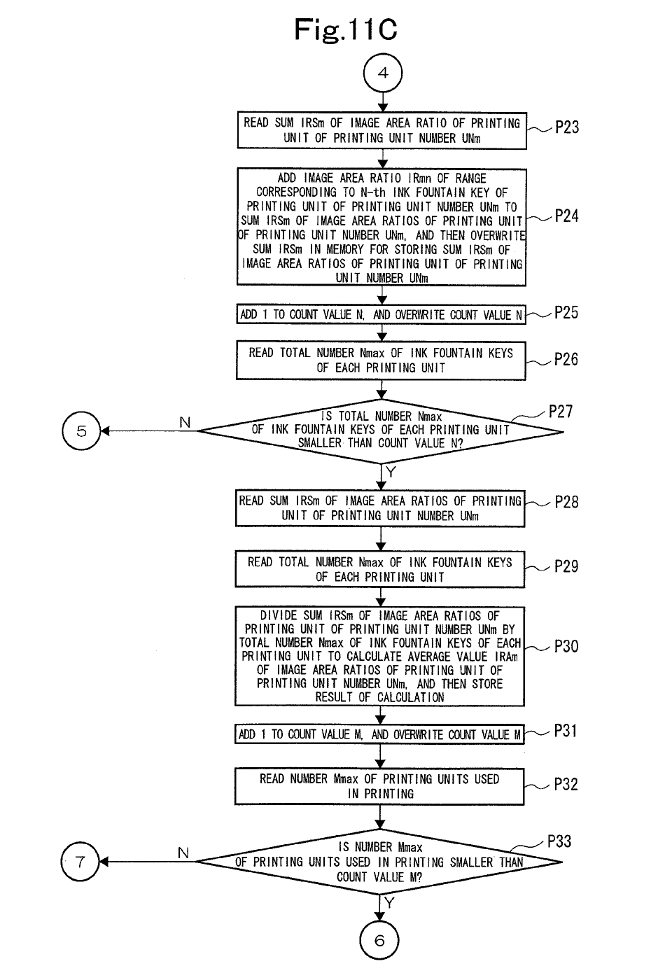

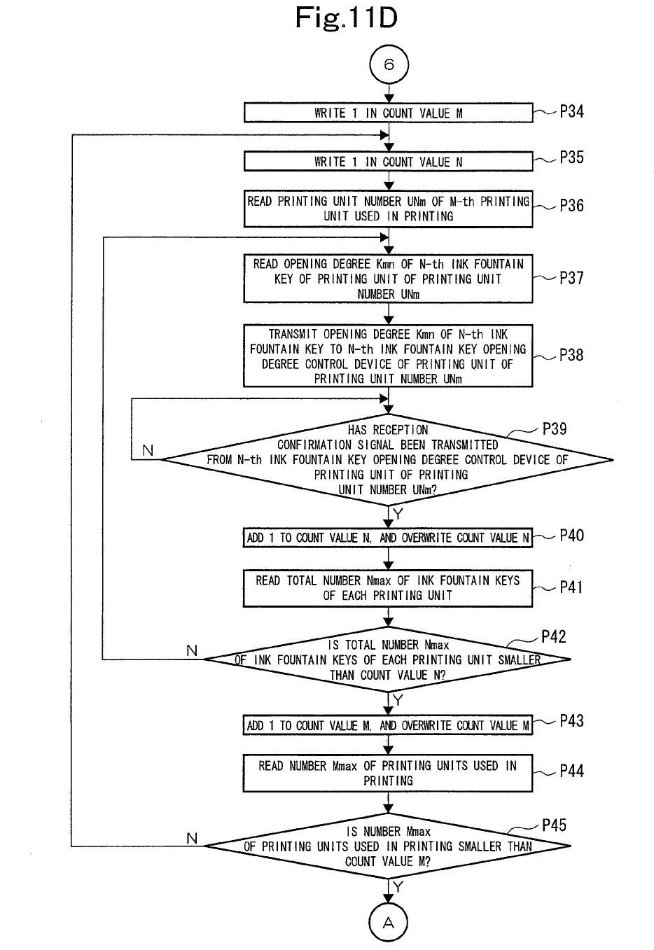

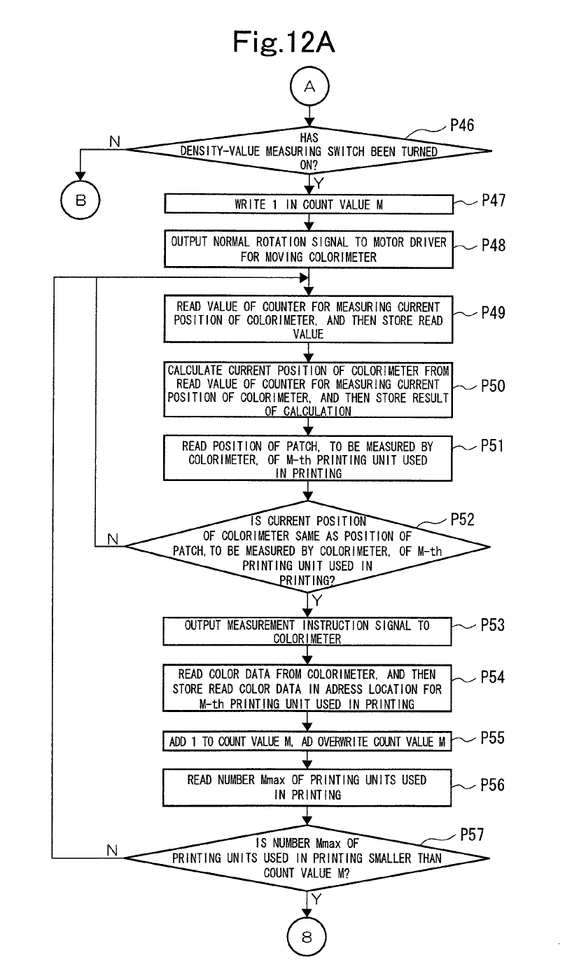

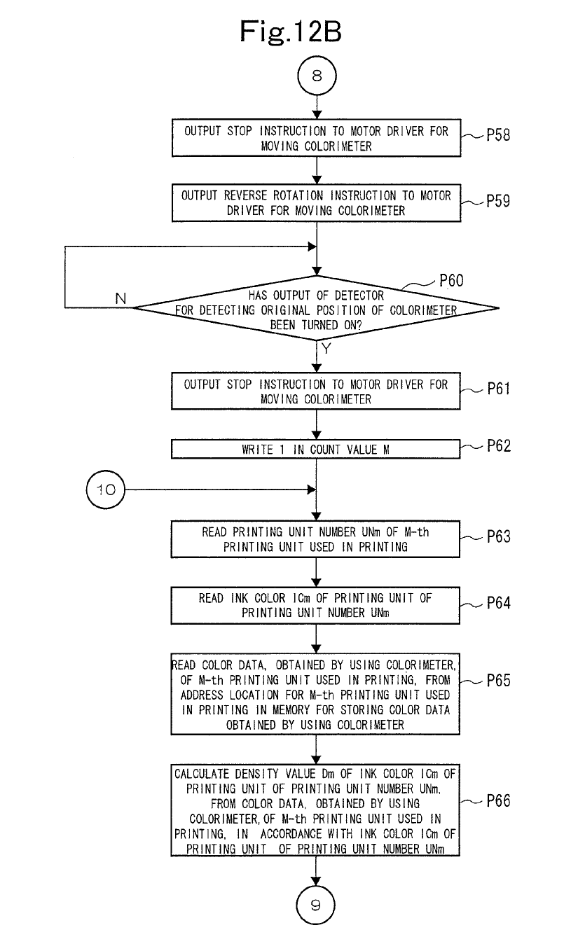

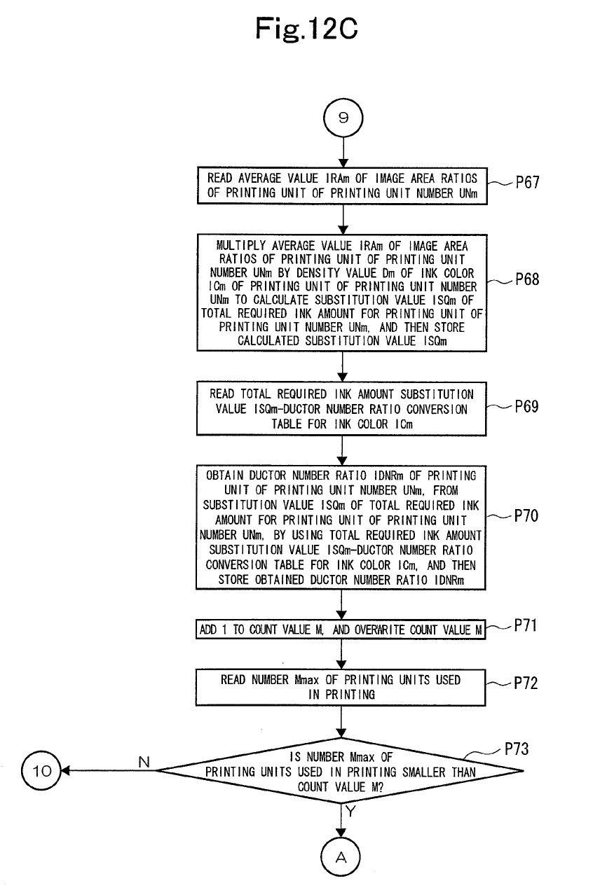

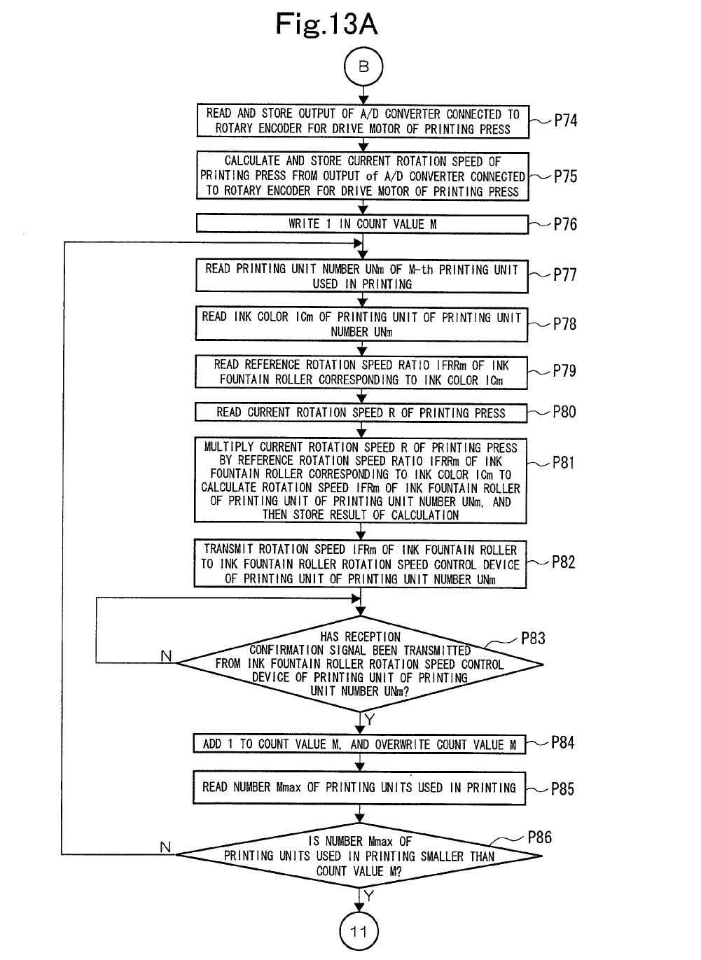

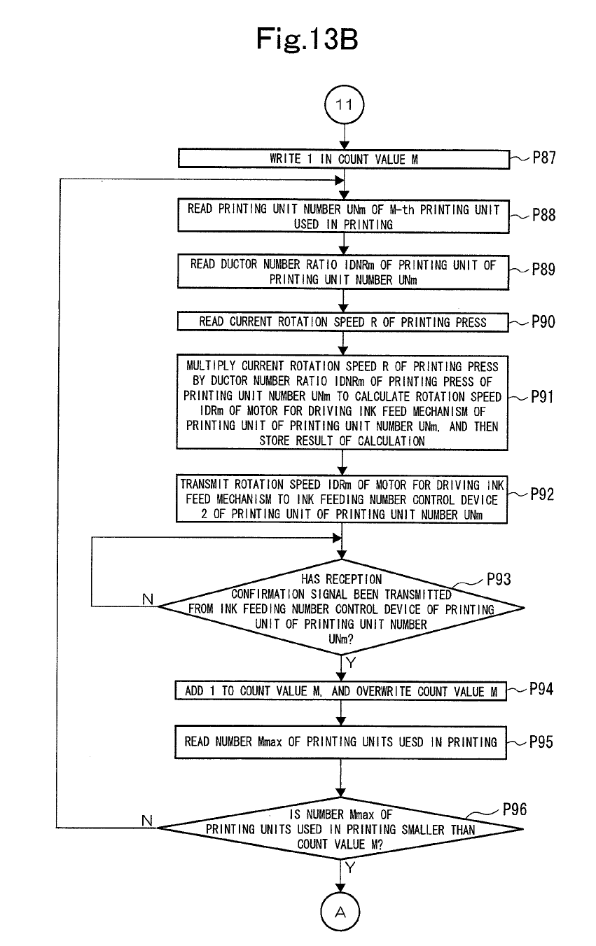

Next, the operation of the ink supply amount control apparatus according to the first embodiment of the present invention will be described. Each of FIGS. 11A to 11D, 12A to 12C, 13A and 13B shows an operational flowchart of the ink supply amount control apparatus according to the first embodiment of the present invention. Hereinafter, the content of the processing of each step will be described.

In Step P1, the CPU 10 initializes each memory. Upon completion of the processing of Step P1, the CPU 10 executes Step P2.

In Step P2, the CPU 10 determines whether or not the operator has inputted the number Mmax of printing units used in the printing, printing unit numbers UNm, ink colors ICm of the printing units of the printing unit numbers UNm, and an image area ratio IRmn of a range corresponding to each ink fountain key.

When the operator has inputted the number Mmax of printing units used in the printing, the printing unit numbers UNm, the ink colors ICm of the printing units of the printing unit numbers UNm, and the image area ratio IRmn of the range corresponding to each ink fountain key, the CPU 10 executes Step P3.

On the other hand, when the operator has not inputted the number Mmax of printing units used in the printing, the printing unit numbers UNm, the ink colors ICm of the printing units of printing unit numbers UNm, and the image area ratio IRmn of the range corresponding to each ink fountain key, the CPU 10 executes Step P2 again.

In Step P3, the CPU 10 inputs to store, the number Mmax of printing units used in the printing, the printing unit number UNm of each printing unit used in the printing, the ink colors ICm of the printing units of printing unit numbers UNm, and the image area ratio IRmn of the range corresponding to each ink fountain key, respectively in the memories M1, M2, M3, and M4. Upon completion of the processing of Step P3, the CPU 10 executes Step P4.

In Step P4, the CPU 10 determines whether or not the ink preset switch SW1 has been turned ON by the operator. When the ink preset switch SW1 has been turned ON, the CPU 10 executes Step P5. On the other hand, when the ink preset switch SW1 has not been turned ON, the CPU10 executes Step P4 again.

In Step P5, the CPU 10 writes 1 in the count value M, that is, the CPU 10 stores 1 in the memory M5. Upon completion of the processing of Step P5, the CPU 10 executes Step P6.

In Step P6, the CPU 10 writes 1 in the count value N, that is, the CPU 10 stores 1 in the memory M6. Upon completion of the processing of Step P6, the CPU 10 executes Step P7.

In Step P7, the CPU 10 reads, from the memory M2, the printing unit number UNm of the M-th printing unit used in the printing. Upon completion of the processing of Step P7, the CPU 10 executes Step P8.

In Step P8, the CPU reads, from the memory M3, the ink color ICm of the printing unit of the printing unit number UNm. Upon completion of the processing of Step P8, the CPU 10 executes Step P9.

In Step P9, the CPU 10 reads, from the memory M7, the image area ratio-ink fountain key opening degree conversion table for the ink color ICm. Upon completion of the processing of Step P9, the CPU 10 executes Step P10.

In Step P10, the CPU 10 reads, from the memory M4, the image area ratio IRmn of the range corresponding to the N-th ink fountain key of the printing unit of the printing unit number UNm. Upon completion of the processing of Step P10, the CPU 10 executes Step P11.

In Step P11, the CPU 10 obtains the opening degree Kmn of the N-th ink fountain key of the printing unit of the printing unit number UNm, from the image area ratio IRmn of the range corresponding to the N-th ink fountain key of the printing unit of the printing unit number UNm, by using the image area ratio-ink fountain key opening degree conversion table for the ink color ICm. Then, the CPU 10 stores the obtained opening degree Kmn in the memory M8. Upon completion of the processing of Step P11, the CPU 10 executes Step P12.

In Step P12, the CPU 10 adds 1 to the count value N stored in the memory M6, and then overwrites the count value N. Upon completion of the processing of Step P12, the CPU 10 executes Step P13.

In Step P13, the CPU 10 reads, from the memory M9, the total number Nmax of ink fountain keys of each printing unit. Upon completion of the processing of Step P13, the CPU 10 executes Step P14.

In Step P14, the CPU 10 determines whether or not the total number Nmax of ink fountain keys of each printing unit, which is stored in the memory M9, is smaller than the count value N, which is stored in the memory M6. When the total number Nmax of ink fountain keys of each printing unit is smaller than the count value N, the CPU 10 executes Step P15. On the other hand, when the total number Nmax of ink fountain keys of each printing unit is larger than, or is equal to, the count value N, the CPU 10 executes Step P7. With this loop, the CPU 10 obtains the opening degree K1n of each ink fountain key of the printing unit of the first color.

In Step P15, the CPU 10 adds 1 to the count value M stored in the memory M5, and then overwrites the count value M. Upon completion of the processing of Step P15, the CPU 10 executes Step P16.

In Step P16, the CPU 10 reads, from the memory M1, the number Mmax of printing units used in the printing. Upon completion of the processing of Step P16, the CPU 10 executes Step P17.

In Step P17, the CPU 10 determines whether or not the number Mmax of printing units used in the printing, which is stored in the memory M1, is smaller than the count value M, which is stored in the memory M5. When the number Mmax of printing units used in the printing is smaller than the count value M, the CPU 10 executes Step P18. On the other hand, when the number Mmax of printing units used in the printing is larger than, or is equal to, the count value M, the CPU 10 executes Step P6. With this loop, the CPU 10 obtains the opening degree Kmn of each ink fountain key of the printing unit of each of the first to M-th colors.

In Step P18, the CPU 10 initializes the memory M10 for storing the sum IRSm of the image area ratios of each printing unit. Upon completion of the processing of Step P18, the CPU 10 executes Step P19.

In Step P19, the CPU 10 writes 1 in the count value M, that is, the CPU 10 stores 1 in the memory M5. Upon completion of Step P19, the CPU 10 executes Step P20.

In Step P20, the CPU 10 writes 1 in the count value N, that is, the CPU 10 stores 1 in the memory M6. Upon completion of Step P20, the CPU 10 executes Step P21.

In Step P21, the CPU 10 reads, from the memory M2, the printing unit number UNm of the M-th printing unit used in the printing. Upon completion of the processing of Step P21, the CPU 10 executes Step P22.

In Step P22, the CPU 10 reads, from the memory M4, the image area ratio IRmn of the range corresponding to the N-th ink fountain key of the printing unit of the printing unit number UNm. Upon completion of the processing of Step P22, the CPU 10 executes Step P23.

In Step P23, the CPU 10 reads, from the memory M10, the sum IRSm of the image area ratios of the printing unit of the printing unit number UNm. Upon completion of the processing of Step P23, the CPU 10 executes Step P24.

In Step P24, the CPU 10 adds the image area ratio IRmn of the range corresponding to the N-th ink fountain key of the printing unit of the printing unit number UNm, to the sum IRSm of the image area ratios of the printing unit of the printing unit number UNm. The CPU 10 then overwrites the sum IRSm in the memory M10 for storing the sum IRSm of the image area ratios of the printing unit of the printing unit number UNm. Upon completion of the processing of Step P24, the CPU 10 executes Step P25.

In Step P25, the CPU 10 adds 1 to the count value N stored in the memory M6, and then overwrites the count value N. Upon completion of the processing of Step P25, the CPU 10 executes Step P26.

In Step P26, the CPU 10 reads, from the memory M9, the total number Nmax of ink fountain keys of each printing unit. Upon completion of the processing of Step P26, the CPU 10 executes Step P27.

In Step P27, the CPU 10 determines whether or not the total number Nmax of ink fountain keys of each printing unit, which is stored in the memory M9, is smaller than the count value N, which is stored in the memory M6. When the total number Nmax of ink fountain keys of each printing unit is smaller than the count value N, the CPU 10 executes Step P28. On the other hand, when the total number Nmax of ink fountain keys of each printing unit is larger than, or is equal to, the count value N, the CPU 10 executes Step P22. With this loop, the CPU 10 obtains the sum IRS1 of the image area ratios IR1n of the ranges corresponding to the respective ink fountain keys of the printing unit of the first color.

In Step P28, the CPU 10 reads, from the memory M10, the sum IRSm of the image area ratios of the printing unit of the printing unit number UNm. Upon completion of the processing of Step P28, the CPU 10 executes Step P29.

In Step P29, the CPU 10 reads, from the memory M9, the total number Nmax of ink fountain keys of each printing unit. Upon completion of the processing of Step P29, the CPU 10 executes Step P30.

In Step P30, the CPU 10 divides the sum IRSm of the image area ratios of the printing unit of the printing unit number UNm by the total number Nmax of ink fountain keys of each printing unit to calculate the average value IRAm of the image area ratios of the printing unit of the printing unit number UNm. The CPU 10 then stores the result of the calculation in the memory M11. Upon completion of the processing of Step P30, the CPU 10 executes Step P31.

In Step P31, the CPU 10 adds 1 to the count value M stored in the memory M5, and then overwrites the count value M. Upon completion of the processing of Step P31, the CPU 10 executes Step P32.

In Step P32, the CPU 10 reads, from the memory M1, the number Mmax of printing units used in the printing. Upon completion of the processing of Step P32, the CPU 10 executes Step P33.

In Step P33, the CPU 10 determines whether or not the number Mmax of printing units used in the printing, which is stored in the memory M1, is smaller than the count value M, which is stored in the memory M5. When the number Mmax of printing units used in the printing is smaller than the count value M, the CPU 10 executes Step P34. On the other hand, when the number Mmax of printing units used in the printing is larger than, or is equal to, the count value M, the CPU 10 executes Step P20. With this loop, the CPU 10 obtains the average value IRAm of the image area ratios IRmn of the ranges corresponding to the respective ink fountain keys of the printing unit of each of the first to M-th colors.

In Step P34, the CPU 10 writes 1 in the count value M, that is, the CPU 10 stores 1 in the memory M5. Upon completion of the processing of Step P34, the CPU 10 executes Step P35.

In Step P35, the CPU 10 writes 1 in the count value N, that is, the CPU 10 stores 1 in the memory M6. Upon completion of the processing of Step P35, the CPU 10 executes Step P36.

In Step P36, the CPU 10 reads, from the memory M2, the printing unit number UNm of the M-th printing unit used in the printing. Upon completion of the processing of Step P36, the CPU 10 executes Step P37.

In Step P37, the CPU 10 reads, from the memory M8, the opening degree Kmn of the N-th ink fountain key of the printing unit of the printing unit number UNm. Upon completion of the processing of Step P37, the CPU 10 executes Step P38.

In Step P38, the CPU 10 transmits the opening degree Kmn of the N-th ink fountain key to the N-th ink fountain key opening degree control device 4 of the printing unit of the printing unit number UNm. Upon completion of the processing of Step P38, the CPU 10 executes Step P39.

In Step P39, the CPU 10 determines whether or not a reception confirmation signal has been transmitted from the N-th ink fountain key opening degree control device 4 of the printing unit of the printing unit number UNm. When the reception confirmation signal has been transmitted from the N-th ink fountain key opening degree control device 4 of the printing unit of the printing unit number UNm, the CPU 10 executes Step P40. On the other hand, when the reception confirmation signal has not been transmitted from the N-th ink fountain key opening degree control device 4 of the printing unit of the printing unit number UNm, the CPU 10 executes Step P39 again.

In Step P40, the CPU 10 adds 1 to the count value N stored in the memory M6, and then overwrites the count value N. Upon completion of the processing of Step P40, the CPU 10 executes Step P41.

In Step P41, the CPU 10 reads, from the memory M9, the total number Nmax of ink fountain keys of each printing unit. Upon completion of the processing of Step P41, the CPU 10 executes Step P42.

In Step P42, the CPU 10 determines whether or not the total number Nmax of ink fountain keys of the printing unit, which is stored in the memory M9, is smaller than the count value N, which is stored in the memory M6. When the total number Nmax of ink fountain keys of the printing unit is smaller than the count value N, the CPU 10 executes Step P43. On the other hand, when the total number Nmax of ink fountain keys of the printing unit is larger than, or is equal to, the count value N, the CPU 10 executes Step P37. With this loop, the CPU 10 transmits the opening degree K1n of each ink fountain key to the corresponding fountain key opening degree control device 4-1-N of the printing unit of the first color.

In Step P43, the CPU 10 adds 1 to the count value M stored in the memory M5, and then overwrites the count value M. Upon completion of the processing of Step P43, the CPU 10 executes Step P44.

In Step P44, the CPU 10 reads, from the memory M1, the number Mmax of printing units used in the printing. Upon completion of the processing of Step P44, the CPU 10 executes Step P45.

In Step P45, the CPU 10 determines whether or not the number Mmax of printing units used in the printing, which is stored in the memory M1, is smaller than the count value M, which is stored in the memory M5. When the number Mmax of printing units used in the printing is smaller than the count value M, the CPU 10 executes Step P46. On the other hand, when the number Mmax of printing units used in the printing is larger than, or is equal to, the count value M, the CPU 10 executes Step P35. With this loop, the CPU 10 transmits the opening degree Kmn of each ink fountain key to the corresponding ink fountain key opening degree control device 4-M-N of the printing unit of each of the first to M-th colors.

In Step P46, the CPU 10 determines whether or not the density-value measuring switch SW2 has been turned ON by the operator. When the density-value measuring switch SW2 has been turned ON, the CPU 10 executes Step P47. On the other hand, when the density-value measuring switch SW2 has not been turned ON, the CPU 10 executes Step P74.

In Step P47, the CPU 10 writes 1 in the count value M, that is, the CPU 10 stores 1 in the memory M5. Upon completion of the processing of Step P47, the CPU 10 executes Step P48.

In Step P48, the CPU 10 outputs a normal rotation instruction to the motor driver 25 for moving the calorimeter. Upon completion of the processing of Step P48, the CPU 10 executes Step P49.

In Step P49, the CPU 10 reads the value of the counter 26 for measuring the current position of the calorimeter 22, and then stores the read value in the memory M12. Upon completion of the processing of Step P49, the CPU 10 executes Step P50.

In Step P50, the CPU 10 calculates the current position of the calorimeter 22 from the read value of the counter 26 for measuring the current position of the calorimeter 22, and then stores the result of the calculation in the memory M13. Upon completion of the processing of Step P50, the CPU 10 executes Step P51.

In Step P51, the CPU 10 reads, from the memory M14, the position of the patch, which is to be measured by the calorimeter 22, of the M-th printing unit used in the printing. Upon completion of the processing of Step P51, the CPU 10 executes Step P52.

In Step P52, the CPU 10 determines whether or not the current position of the colorimeter 22 is the same as the position of the patch, which is to be measured by the colorimeter 22, of the M-th printing unit used in the printing. When the current position of the calorimeter 22 is the same as the position of the patch, which is to be measured by the calorimeter 22, of the M-th printing unit used in the printing, the CPU 10 executes Step P53. On the other hand, when the current position of the colorimeter 22 is different from the position of the patch, which is to be measured by the calorimeter 22, of the M-th printing unit used in the printing, the CPU 10 executes Step P49.

In Step P53, the CPU 10 outputs a measurement instruction signal to the colorimeter 22. Upon completion of the processing of Step P53, the CPU 10 executes Step P54.

In Step P54, the CPU 10 reads color data from the calorimeter 22, which data is a digital value obtained by the conversion of the A/D converter 29, and then stores the color data in an address location, for the M-th printing unit used in the printing, in the memory M15. Upon completion of the processing of Step P54, the CPU 10 executes Step P55.

In Step P55, the CPU 10 adds 1 to the count value M stored in the memory M5, and then overwrites the count value M. Upon completion of the processing of Step P55, the CPU 10 executes Step P56.

In Step P56, the CPU 10 reads, from the memory M1, the number Mmax of printing units used in the printing. Upon completion of the processing of Step P56, the CPU 10 executes Step P57.

In Step P57, the CPU 10 determines whether or not the number Mmax of printing units used in the printing, which is stored in the memory M1, is smaller than the count value M, which is stored in the memory M5. When the number Mmax of printing units used in the printing is smaller than the count value M, the CPU 10 executes Step P58. On the other hand, when the number Mmax of printing units used in the printing is larger than, or is equal to, the count value M, the CPU 10 executes Step P49. With this loop, the CPU 10 measures the color data of each of the patches printed by each printing unit, and then stores the measured color data in the memory M15. Note that, in this case, the position of the patch printed by each printing unit is supposed to be located in a manner that the patches are printed respectively by the first, the second, . . . , and the M-th printing units in this order from a position closest to the original position of the motor 23 for moving the calorimeter.

In Step P58, the CPU 10 outputs a stop instruction to the motor driver 25 for moving the calorimeter. Upon completion of the processing of Step P58, the CPU 10 executes Step P59.

In Step P59, the CPU 10 outputs a reverse rotation instruction to the motor driver 25 for moving the calorimeter. Upon completion of the processing of Step P59, the CPU 10 executes Step P60.

In Step P60, the CPU 10 determines whether or not the output of the detector 27 for detecting the original position of the calorimeter has been turned ON. When the output of the detector 27 for detecting the original position of the calorimeter has been turned ON, the CPU 10 executes Step P61. On the other hand, when the output of the detector 27 for detecting the original position of the calorimeter has not been turned ON, the CPU 10 executes Step P60 again.

In Step P61, the CPU 10 outputs a stop instruction to the motor driver 25 for moving the calorimeter. Upon completion of the processing of Step P61, the CPU 10 executes Step P62.

In Step P62, the CPU 10 writes 1 in the count value M, that is the CPU 10 stores 1 in the memory M5. Upon completion of the processing of Step P62, the CPU 10 executes Step P63.

In Step P63, the CPU 10 reads, from the memory M2, the printing unit number UNm of the M-th printing unit used in the printing. Upon completion of the processing of Step P63, the CPU 10 executes Step P64.

In Step P64, the CPU 10 reads, from the memory M3, the ink color ICm of the printing unit of the printing unit number UNm. Upon completion of the processing of Step P64, the CPU 10 executes Step P65.

In Step P65, the CPU 10 reads the color data, measured by the calorimeter 22, of the M-th printing unit used in the printing, from the address location, for the M-th printing unit used in the printing, in the memory M15 for storing the color data from the calorimeter 22. Upon completion of the processing of Step P65, the CPU 10 executes Step P66.

In Step P66, the CPU 10 calculates a density value Dm of the ink color ICm of the printing unit of the printing unit number UNm, from the color data, measured by the calorimeter 22, of the M-th printing unit used in the printing, in accordance with the ink color ICm of the printing unit of the printing unit number UNm. The CPU 10 then stores the result of the calculation in the memory M16. Upon completion of the processing of Step P66, the CPU 10 executes Step P67.

In Step P67, the CPU 10 reads, from the memory M11, the average value IRAm of the image area ratios of the printing unit of the printing unit number UNm. Upon completion of the processing of Step P67, the CPU 10 executes Step P68.

In Step P68, the CPU 10 multiplies the average value IRAm of the image area ratios of the printing unit of the printing unit number UNm by the density value Dm of the ink color ICm of the printing unit of the printing unit number UNm to calculate a substitution value ISQm of the total required ink amount for the printing unit of the printing unit number UNm. Then the CPU 10 stores the calculated substitution value ISQm in the memory M17. Upon completion of the processing of Step P68, the CPU 10 executes Step P69.

In Step P69, the CPU 10 reads, from the memory M18, the total required ink amount substitution value ISQm-ductor number ratio conversion table for the ink color ICm. Upon completion of the processing of Step P69, the CPU 10 executes Step P70.

In Step P70, the CPU 10 obtains a ductor number ratio IDNRm of the printing unit of the printing unit number UNm, from the substitution value ISQm of the total required ink amount for the printing unit of the printing unit number UNm, by using the total required ink amount substitution value ISQm-ductor number ratio conversion table for the ink color ICm. The CPU 10 then stores the obtained ductor number ratio IDNRm in the memory M19. Upon completion of the processing of Step P70, the CPU 10 executes Step P71.

In Step P71, the CPU 10 adds 1 to the count value M stored in the memory M5, and then overwrites the count value M. Upon completion of the processing of Step P71, the CPU 10 executes Step P72.

In Step P72, the CPU 10 reads, from the memory M1, the number Mmax of printing units used in the printing. Upon completion of the processing of Step P72, the CPU 10 executes Step P73.

In Step P73, the CPU 10 determines whether or not the number Mmax of printing units used in the printing, which is stored in the memory M1, is smaller than the count value M, which is stored in the memory M5. When the number Mmax of printing units used in the printing is smaller than the count value M, the CPU 10 executes Step P74 via Step P46. On the other hand, when the number Mmax of printing units used in the printing is larger than, or is equal to, the count value M, the CPU 10 executes Step P63. With this loop, the CPU 10 obtains the ductor number ratio IDNRm of each printing unit.

In Step P74, the CPU 10 reads an output of the A/D converter 30 connected to the rotary encoder 28 for the drive motor of the printing press, and then stores the value of the output in the memory M20. Upon completion of the processing of Step P74, the CPU 10 executes Step P75.

In Step P75, the CPU 10 calculates the current rotation speed R of the printing press from the output, which is stored in the memory M20, of the A/D converter 30 connected to the rotary encoder 28 for the drive motor of the printing press. The CPU 10 then stores the result of the calculation in the memory M21. Upon completion of the processing of Step P75, the CPU 10 executes Step P76.

In Step P76, the CPU 10 writes 1 in the count value M, that is, the CPU 10 stores 1 in the memory M5. Upon completion of the processing of Step P76, the CPU 10 executes Step P77.

In Step P77, the CPU 10 reads, from the memory M2, the printing unit number UNm of the M-th printing unit used in the printing. Upon completion of the processing of Step P77, the CPU 10 executes Step P78.

In Step P78, the CPU 10 reads, from the memory M3, the ink color ICm of the printing unit of the printing unit number UNm. Upon completion of the processing of Step P78, the CPU 10 executes Step P79.

In Step P79, the CPU 10 reads, from the memory M22, the reference rotation speed ratio IFRRm of the ink fountain roller corresponding to the ink color ICm. Upon completion of the processing of Step P79, the CPU 10 executes Step P80.

In Step P80, the CPU 10 reads, from the memory M21, the current rotation speed R of the printing press. Upon completion of the processing of Step P80, the CPU 10 executes Step P81.

In Step P81, the CPU 10 multiplies the current rotation speed R of the printing press by the reference rotation speed ratio IFRRm of the ink fountain roller corresponding to the ink color ICm to calculate the rotation speed IFRm of the ink fountain roller of the printing unit of the printing unit number UNm. The CPU 10 then stores the result of the calculation in the memory M23. Upon completion of the processing of Step P81, the CPU 10 executes Step P82.

In Step P82, the CPU 10 transmits the rotation speed IFRm of the ink fountain roller to the ink fountain roller rotation speed control device 3 of the printing unit of the printing unit number UNm. Upon completion of the processing of Step P82, the CPU 10 executes Step P83.

In Step P83, the CPU 10 determines whether or not a reception confirmation signal has been transmitted from the ink fountain roller rotation speed control device 3 of the printing unit of the printing unit number UNm. When the reception confirmation signal has been transmitted from the ink fountain roller rotation speed control device 3 of the printing unit of the printing unit number UNm, the CPU 10 executes Step P84. On the other hand, when the reception confirmation signal has not been transmitted from the ink fountain roller rotation speed control device 3 of the printing unit of the printing unit number UNm, the CPU 10 executes Step P83 again.

In Step P84, the CPU 10 adds 1 to the count value M stored in the memory 5, and then overwrites the count value M. Upon completion of the processing of Step P84, the CPU 10 executes Step P85.

In Step P85, the CPU 10 reads, from the memory M1, the number Mmax of printing units used in the printing. Upon completion of the processing of Step P85, the CPU 10 executes Step P86.

In Step P86, the CPU 10 determines whether or not the number Mmax of printing units used in the printing at this time, which is stored in the memory M1, is smaller than the count value M, which is stored in the memory M5. When the number Mmax of printing units used in the printing at this time is smaller than the count value M, the CPU 10 executes Step P87. On the other hand, when the number Mmax of printing units used in the printing at this time is larger than, or is equal to, the count value M, the CPU 10 executes Step P77. With this loop, the CPU 10 transmits the rotation speed IFRm of the ink fountain key roller of each color to the ink fountain roller rotation speed control device 3 of the printing unit of the color.

In Step P87, the CPU 10 writes 1 in the count value M, that is, the CPU 10 stores 1 in the memory M5. Upon completion of the processing of Step P87, the CPU 10 executes Step P88.

In Step P88, the CPU 10 reads, from the memory M2, the printing unit number UNm of the M-th printing unit used in the printing. Upon completion of the processing of Step P88, the CPU 10 executes Step P89.

In Step P89, the CPU 10 reads, from the memory M19, the ductor number ratio IDNRm of the printing unit of the printing unit number UNm. Upon completion of the processing of Step P89, the CPU 10 executes Step P90.

In Step P90, the CPU 10 reads, from the memory M21, the current rotation speed R of the printing press. Upon completion of the processing of Step P90, the CPU 10 executes Step P91.

In Step P91, the CPU 10 multiplies the current rotation speed R of the printing press by the ductor number ratio IDNRm of the printing unit of the printing unit number UNm to calculate the rotation speed IDRm of the motor for driving the ink feed mechanism of the printing unit of the printing unit number UNm. The CPU 10 then stores the result of the calculation in the memory M24. Upon completion of the processing of Step P91, the CPU 10 executes Step P92.

In Step P92, the CPU 10 transmits the rotation speed IDRm of the motor for driving the ink feed mechanism to the ink feeding number control device 2 of the printing unit of the printing unit number UNm. Upon completion of the processing of Step P92, the CPU 10 executes Step P93.

In Step P93, th CPU 10 determines whether or not a reception confirmation signal has been transmitted from the ink feeding number control device 2 of the printing unit of the printing unit number UNm. When the reception confirmation signal has been transmitted from the ink feeding number control device 2 of the printing unit of the printing unit number UNm, the CPU 10 executes Step P94. On the other hand, when the reception confirmation signal has not been transmitted from the ink feeding number control device 2 of the printing unit of the printing unit number UNm, the CPU 10 executes Step P93 again.

In Step P94, the CPU 10 adds 1 to the count value M stored in the memory M5, and then overwrites the count value M. Upon completion of the processing of Step P94, the CPU 10 executes Step P95.

In Step P95, the CPU 10 reads, from the memory M1, the number Mmax of printing units used in the printing. Upon completion of the processing of Step P95, the CPU 10 executes Step P96.

In Step P96, the CPU 10 determines whether or not the number Mmax of printing units used in the printing at this time, which is stored in the memory M1, is smaller than the count value M, which is stored in the memory M5. When the number Mmax of printing units used in the printing at this time is smaller than the count value M, the CPU 10 executes Step P46. On the other hand, the number Mmax of printing units used in the printing at this time is larger than, or is equal to, the count value M, the CPU 10 executes Step P88. With this loop, the CPU 10 transmits the rotation speed IDRm of the motor for driving the ink feed mechanism of each color to the ink feeding number control device 2 of the printing unit of the color.

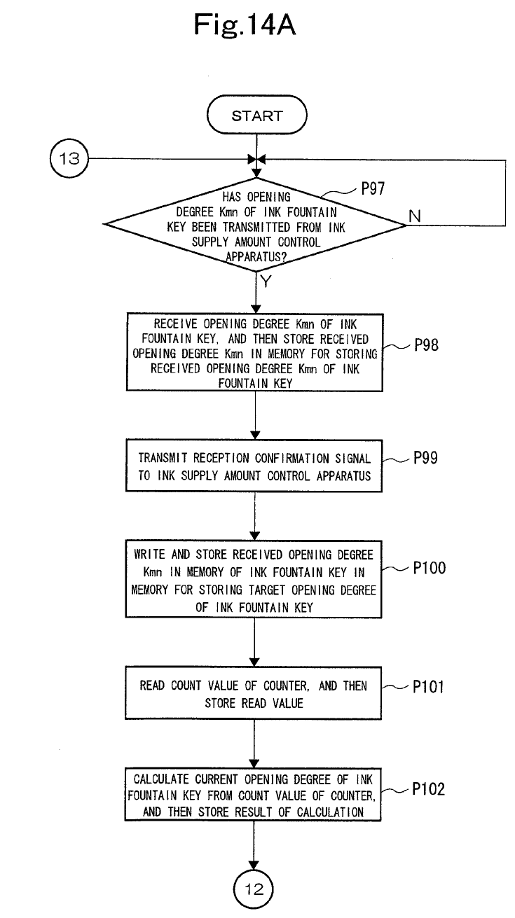

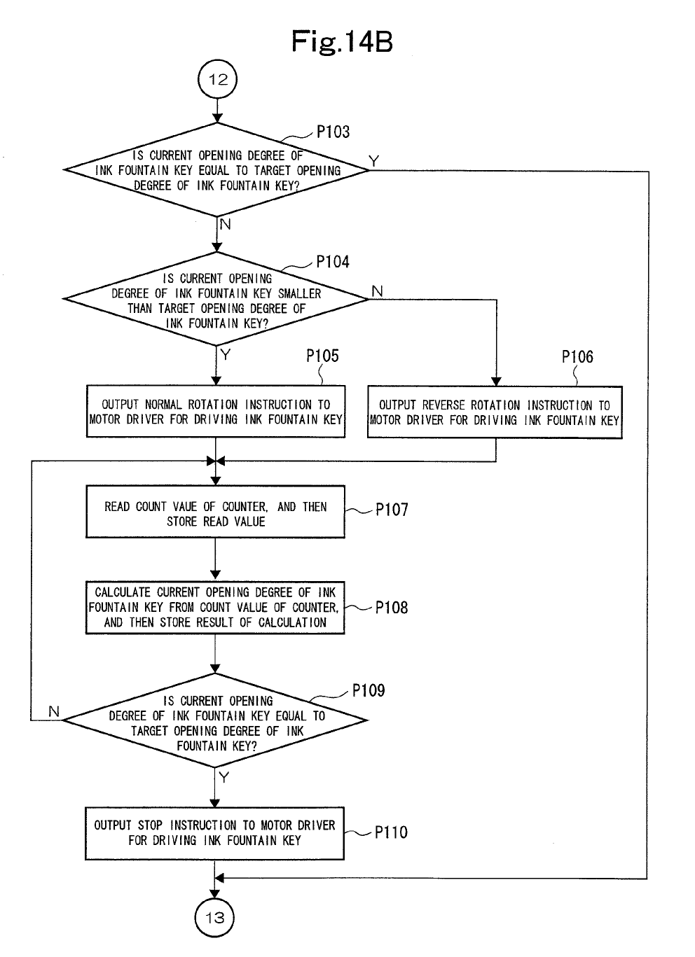

Next, descriptions will be given of the operation of the ink fountain key opening degree control device 4, which controls the opening degree of each of the ink fountain keys 109-1 to 109-N of each color, according to the first embodiment of the present invention. Each of FIGS. 14A to 14D shows an operational flowchart of the ink fountain key opening degree control device 4, which controls the opening degree of each of the ink fountain keys 109-1 to 109-N of each color, according to the first embodiment of the present invention. Hereinafter, the content of the processing of each step will be described.

In Step P97, the CPU 53 determines whether or not the opening degree Kmn of the corresponding ink fountain key has been transmitted from the ink supply amount control apparatus 1. When the opening degree Kmn of the ink fountain key has been transmitted from the ink supply amount control apparatus 1, the CPU 53 executes Step P98. On the other hand, when the opening degree Kmn of the ink fountain key has not been transmitted from the ink supply amount control apparatus 1, the CPU 53 executes Step P97 again.

In Step P98, the CPU 53 receives the opening degree Kmn of the ink fountain key, and then stores the received opening degree Kmn of the ink fountain key in the memory M29. Upon completion of the processing of Step P98, the CPU 53 executes Step P99.

In Step P99, the CPU 53 transmits a reception confirmation signal to the ink supply amount control apparatus 1. Upon completion of the processing of Step P99, the CPU 53 executes Step P100.

In Step P100, the CPU 53 writes and stores the received opening degree Kmn of the ink fountain key in the memory M30 for storing the target opening degree of the ink fountain key. Upon completion of the processing of Step P100, the CPU 53 executes Step P101.

In Step P101, the CPU 53 reads the count value of the counter 61, and then stores the read value in the memory M31. Upon completion of the processing of Step P101, the CPU 53 executes Step P102.

In Step P102, the CPU 53 calculates the current opening degree of the ink fountain key from the count value of the counter 61, and then stores the result of the calculation in the memory M32. Upon completion of the processing of Step P102, the CPU 53 executes Step P103.

In Step P103, the CPU 53 determines whether or not the current opening degree of the ink fountain key is equal to the target opening degree of the ink fountain key. When the current opening degree of the ink fountain key is equal to the target opening degree of the ink fountain key, the CPU 53 executes Step P97. On the other hand, when the current opening degree of the ink fountain key is not equal to the target opening degree of the ink fountain key, the CPU 53 executes Step P104.

In Step P104, the CPU 53 determines whether or not the current opening degree of the ink fountain key is smaller than the target opening degree of the ink fountain key. When the current opening degree of the ink fountain key is smaller than the target opening degree of the ink fountain key, the CPU 53 executes Step P105. On the other hand, when the current opening degree of the ink fountain key is larger than the target opening degree of the ink fountain key, the CPU 53 executes Step P106.

In Step P105, the CPU 53 outputs a normal rotation instruction to the motor driver 58 for driving the ink fountain key. Upon completion of the processing of Step P105, the CPU 53 executes Step P107.

In Step P106, the CPU 53 outputs a reverse rotation instruction to the motor driver 58 for driving the ink fountain key. Upon completion of the processing of Step P105, the CPU 53 executes Step P107.

In Step P107, the CPU 53 reads the count value of the counter 61, and then stores the read value in the memory M31. Upon completion of the processing of Step P107, the CPU 53 executes Step P108.

In Step P108, the CPU 53 calculates the current opening degree of the ink fountain key from the count value stored in the memory M31, and then stores the result of the calculation in the memory M32. Upon completion of the processing of Step P108, the CPU 53 executes Step P109.

In Step P109, the CPU 53 determines whether or not the current opening degree of the ink fountain key, which is stored in the memory M32, is equal to the target opening degree of the ink fountain key, which is stored in the memory M30. When the current opening degree of the ink fountain key is equal to the target opening degree of the ink fountain key, the CPU 53 executes Step P110. On the other hand, when the current opening degree of the ink fountain key is not equal to the target opening degree of the ink fountain key, the CPU 53 executes Step P107.

In Step P110, the CPU 53 outputs a stop instruction to the motor driver 58 for driving the ink fountain key. Upon completion of the processing of Step P110, the CPU 53 executes Step P97.

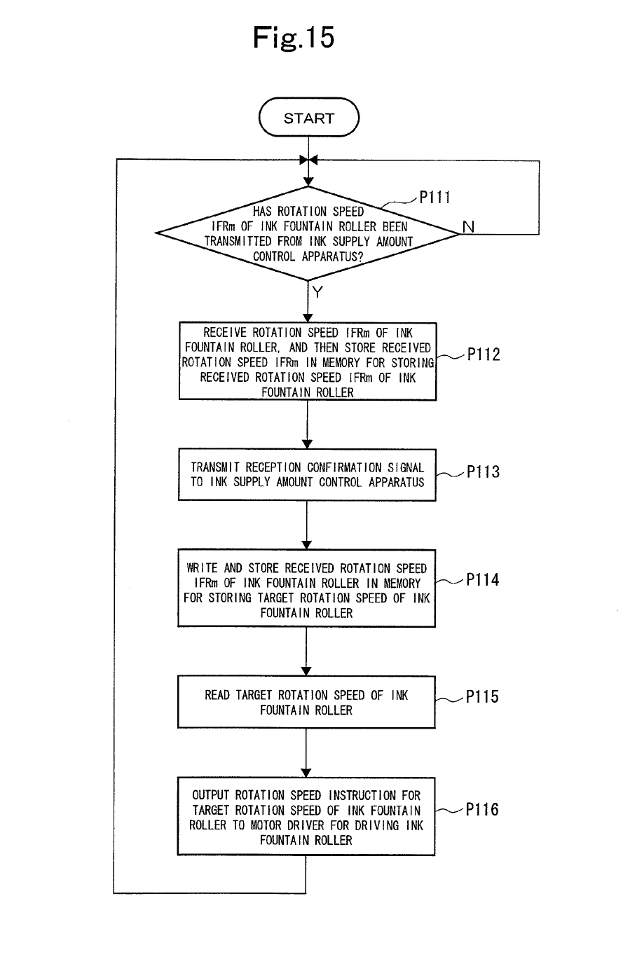

Next, descriptions will be given of the operation of the ink fountain roller rotation speed control device 3, which controls the rotation amount of each ink fountain roller, according to the first embodiment of the present invention. FIG. 15 shows an operational flowchart of the ink fountain roller rotation speed control device 3, which controls the rotation amount of each ink fountain roller, according to the first embodiment of the present invention. Hereinafter, the content of the processing of each step will be described.

In Step P111, the CPU 43 determines whether or not the rotation speed IFRm of the ink fountain roller has been transmitted from the ink supply amount control apparatus 1. When the rotation speed IFRm of the ink fountain roller has been transmitted from the ink supply amount control apparatus 1, the CPU 43 executes Step P112. On the other hand, when the rotation speed IFRm of the ink fountain roller has not been transmitted from the ink supply amount control apparatus 1, the CPU 43 executes Step P111 again.

In Step P112, the CPU 43 receives the rotation speed IFRm of the ink fountain roller, and then stores the received rotation speed IFRm of the ink fountain roller in the memory M27. Upon completion of the processing of Step P112, the CPU 43 executes Step P113.

In Step P113, the CPU 43 transmits a reception confirmation signal to the ink supply amount control apparatus 1. Upon completion of the processing of Step P113, the CPU 43 executes Step P114.

In Step P114, the CPU 43 writes and stores the received rotation speed IFRm of the ink fountain roller in the memory M28 for storing the target rotation speed of the ink fountain roller. Upon completion of the processing of Step P114, the CPU 43 executes Step P115.

In Step P115, the CPU 43 reads, from the memory M28, the target rotation speed of the ink fountain roller. Upon completion of the processing of Step P115, the CPU 43 executes Step P116.

In Step P116, the CPU 43 outputs a rotation speed instruction, for causing the ink fountain roller to rotate at the target rotation speed, to the motor driver 48 for driving the ink fountain roller. Upon completion of the processing of Step P116, the CPU 43 executes Step P111.

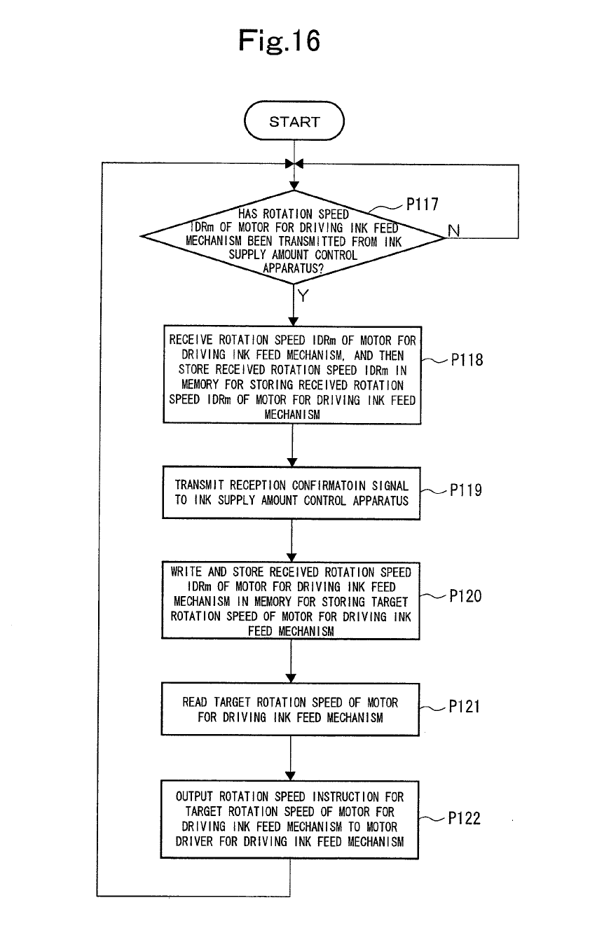

Next, descriptions will be given of the operation of the ink feeding number control device 2, which controls the number of feedings of each ink, according to the first embodiment of the present invention. FIG. 16 shows an operational flowchart of the ink feeding number control device 2, which controls the number of feedings of each ink, according to the first embodiment of the present invention. Hereinafter, the content of the processing of each step will be described.

In Step P117, the CPU 33 determines whether or not the rotation speed IDRm of the motor for driving the ink feed mechanism has been transmitted from the ink supply amount control apparatus 1. When the rotation speed IDRm of the motor for driving the ink feed mechanism has been transmitted from the ink supply amount control apparatus 1, the CPU 33 executes Step P118. On the other hand, when the rotation speed IDRm of the motor for driving the ink feed mechanism has not been transmitted from the ink supply amount control apparatus 1, the CPU 33 executes Step P117 again.

In Step P118, the CPU 33 receives the rotation speed IDRm of the motor for driving the ink feed mechanism, and then stores the received rotation speed IDRm of the motor for driving the ink feed mechanism in the memory M25. Upon completion of the processing of Step P118, the CPU 33 executes Step P119.

In Step P119, the CPU 33 transmits a reception confirmation signal to the ink supply amount control apparatus 1. Upon completion of the processing of Step P119, the CPU 33 executes Step P120.

In Step P120, the CPU 33 writes and stores the received rotation speed IDRm of the motor for driving the ink feed mechanism in the memory M26 for storing the target rotation speed of the motor for driving the ink feed mechanism. Upon completion of the processing of Step P120, the CPU 10 executes Step P121.

In Step P121, the CPU 33 reads, from the memory M26, the target rotation speed of the motor for driving the ink feed mechanism. Upon completion of the processing of Step P121, the CPU 33 executes Step P122.

In Step P122, the CPU 33 outputs a rotation speed instruction, for causing the motor for driving the ink feed mechanism to rotate at the target rotation speed, to the motor driver 38 for driving the ink feed mechanism. Upon completion of the processing of Step P122, the CPU 33 executes Step P117.

### Second Embodiment

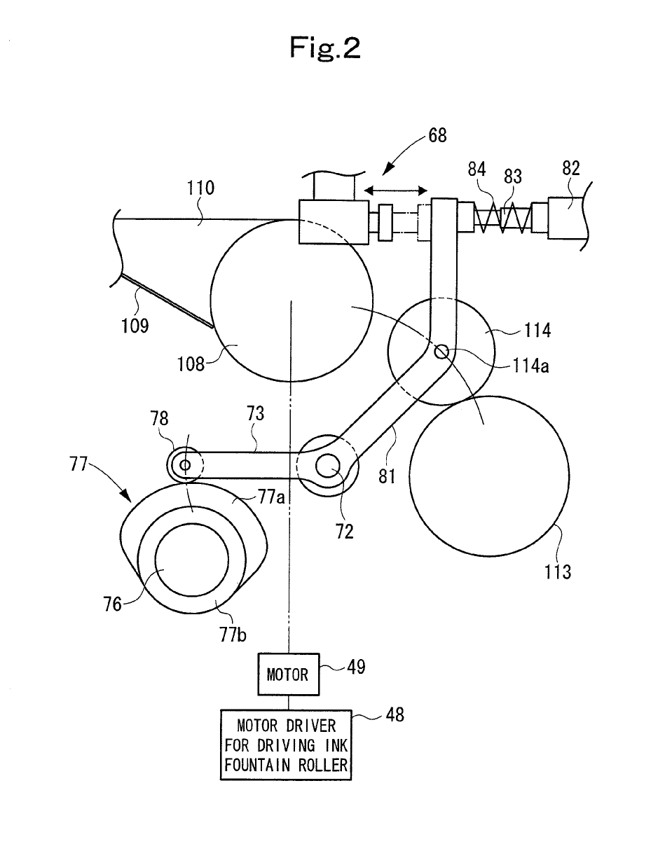

Firstly, descriptions will be given of the device configuration of an ink feed control system according to a second embodiment of the present invention. FIG. 2 shows a side view of principal parts of an inking device of a printing press according to the second embodiment of the present invention. In FIG. 2, the same reference numerals denote components that are the same as, or similar to, those described in the above-mentioned conventional technique shown in FIG. 48, and detailed descriptions of the same components will be omitted. In addition, in the second embodiment of the present invention, the basic driving of the ink feed mechanism is performed by using a cam 77 and the like, that is, the same as that in the first embodiment, and thus descriptions thereof will be omitted. The cam 77 is driven by a drive motor of the printing press. A ductor roller 114 and a ductor shaft 72, which serves as a swing fulcrum for swinging the ductor roller 114, are pivotally supported by left and right frames (not illustrated) so as to be rotatable, between an ink fountain roller 108 and an distribution roller 113. The ink fountain roller 108 is provided as a roller on the upstream side in the ink transfer direction, while the distribution roller 113 is provided as a roller on the downstream side in the ink transfer direction. One of the shaft ends of the ductor shaft 72 protrudes from the frame, and a cam lever 73 is provided to this protruding portion of the ductor shaft 72. The ink fountain roller 108 is driven by a motor 49 for driving the ink fountain roller 108. The motor 49 for driving the ink fountain roller is controlled by a motor driver 48 for driving the ink fountain roller 108.

A pair of left and right swing levers 81 are pivotally mounted on the ductor shaft 72 inside the frames, while the ductor roller 114 is pivotally supported, at the two end shafts 114a, by the swing levers 81 so as to be rotatable. A feeding stop air cylinder 68 is provided on a side of the end portion of the swing levers 81. The feeding stop air cylinder 68 is configured to extend so as to stop the feeding of ink. The feeding stop air cylinder 68 is normally in a state where the feeding stop air cylinder 68 is not in contact with the swing levers 81. Only when the feeding stop air cylinder 68 is activated, the front end of a piston thereof presses the swing levers 81 as indicated by the dashed line in FIG. 2. The feeding stop air cylinder 68 is controlled by an ink feeding number control device 2, which is to be described later. On the other hand, the rotation of a drive motor is transmitted to the distribution roller 113, so that the distribution roller 113 reciprocates once in the axial direction as the plate cylinder 101 (see FIG. 48) rotates twice.

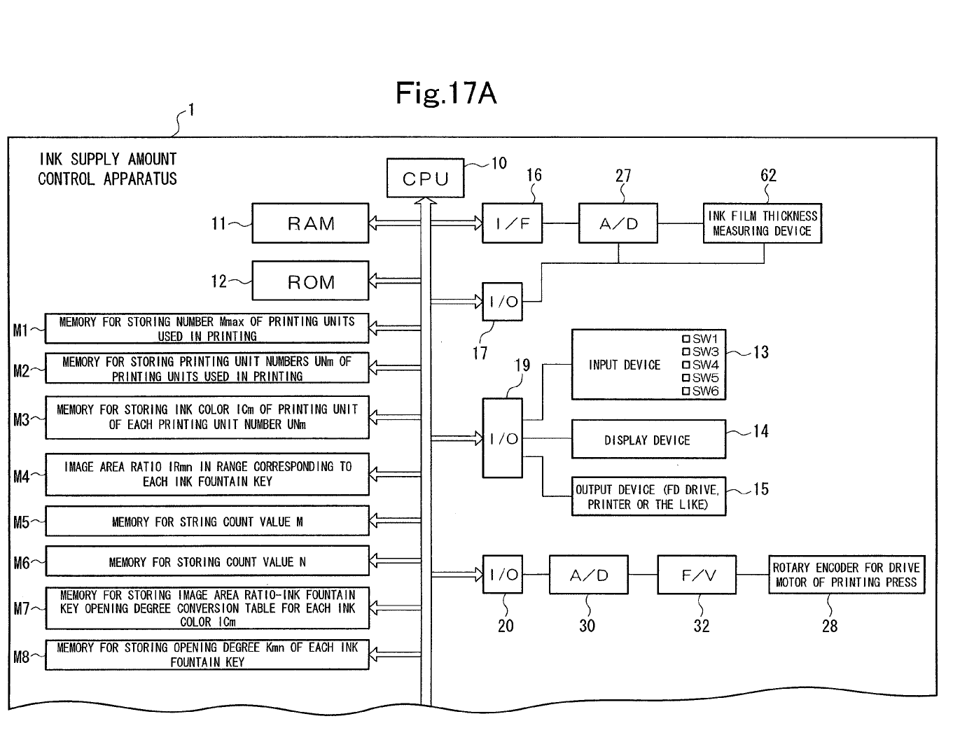

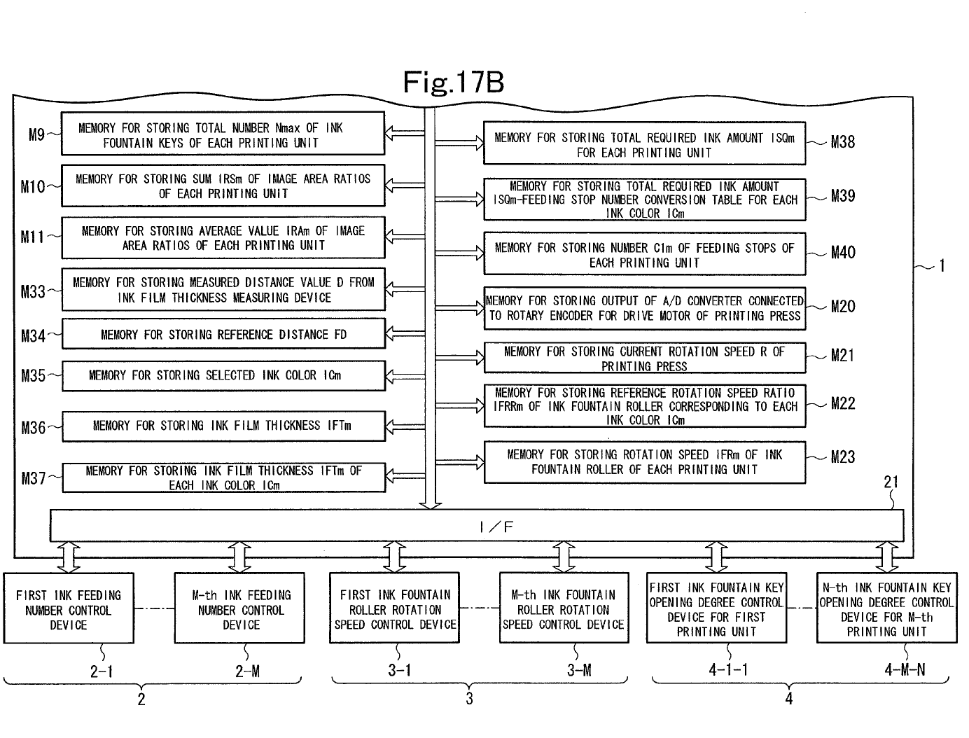

Next, an ink supply amount control apparatus according to the second embodiment of the present invention will be described. FIGS. 17A and 17B show hardware block diagrams of the ink supply amount control apparatus according to the second embodiment of the present invention. As shown in FIGS. 17A and 17B, the ink supply amount control apparatus 1 includes a CPU 10, a RAM 11, a ROM 12, an input device 13, a display device 14, an output device 15, input/output interfaces (I/O, I/F) 16, 17, 19, 20 and 21, a rotary encoder 28 for the drive motor of the printing press, A/D converters 27 and 30, an F/V converter 32, an ink film thickness measuring device 62, and memories M1 to M11, M20 to M23, and M33 to M40.

The CPU 10 obtains various kinds of information which are inputted thereto through the interfaces 16, 17, 19, and 21, and operates in accordance with a program stored in the ROM 12, while accessing the RAM 11 as well as the memories M1 to M11, M20 to M23, and M33 to M40. The input device 13 is provided with an ink preset switch SW1, a reference-distance measuring switch SW3, an ink-film-thickness measuring switch SW4, an ink-color-ICm selecting switch SW5, a feed-control starting switch SW6 and the like. The rotary encoder 28 for the drive motor of the printing press generates a rotation pulse for every predetermined number of rotations (angle) of the drive motor, and then outputs the rotation pulse to the input/output interface 20.

In the ink supply amount control apparatus 1, in the memory M1, the number Mmax of printing units used in the printing is stored. In the memory M2, the printing unit number of each printing unit used in the printing is stored. In the memory M3, the ink color ICm of the printing unit of each printing unit number UNm is stored. In the memory M4, the image area ratio IRmn of a range corresponding to each ink fountain key is stored. In the memory M5, a count value M is stored.

In the memory M6, a count value N is stored. In the memory M7, an image area ratio-ink fountain key opening degree conversion table for each ink color ICm is stored. In the memory M8, the opening degree Kmn of each ink fountain key is stored. In the memory M9, the total number Nmax of ink fountain keys of each printing unit is stored. In the memory M10, the sum IRSm of the image area ratios of each printing unit is stored. In the memory M11, the average value IRAm of the image area ratios of each printing unit is stored.

In the memory M20, an output of the A/D converter connected to the rotary encoder 28 for the drive motor of the printing press is stored. In the memory M21, the current rotation speed R of the printing press is stored. In the memory M22, the reference rotation speed ratio IFRm of the ink fountain roller corresponding to each ink color ICm is stored. In the memory M23, the rotation speed IFRm of the ink fountain roller of each printing unit is stored.

In the memory M33, the measured distance value D from the ink film thickness measuring device 62 is stored. In the memory M34, a reference distance FD is stored. In the memory M35, a selected ink color ICm is stored. In the memory M36, an ink film thickness IFTm is stored. In the memory M37, an ink film thickness IFTm of each ink color ICm is stored. In the memory M38, the total required ink amount ISQm for each printing unit is stored. In the memory M39, a conversion table between a total required ink amount ISQm for each ink color ICm and the number of feeding stops (hereinafter, referred to as a total required ink amount ISQm-feeding stop number conversion table for each ink color ICm) is stored. In the memory M40, the number C1m of feeding stops of each printing unit is stored.

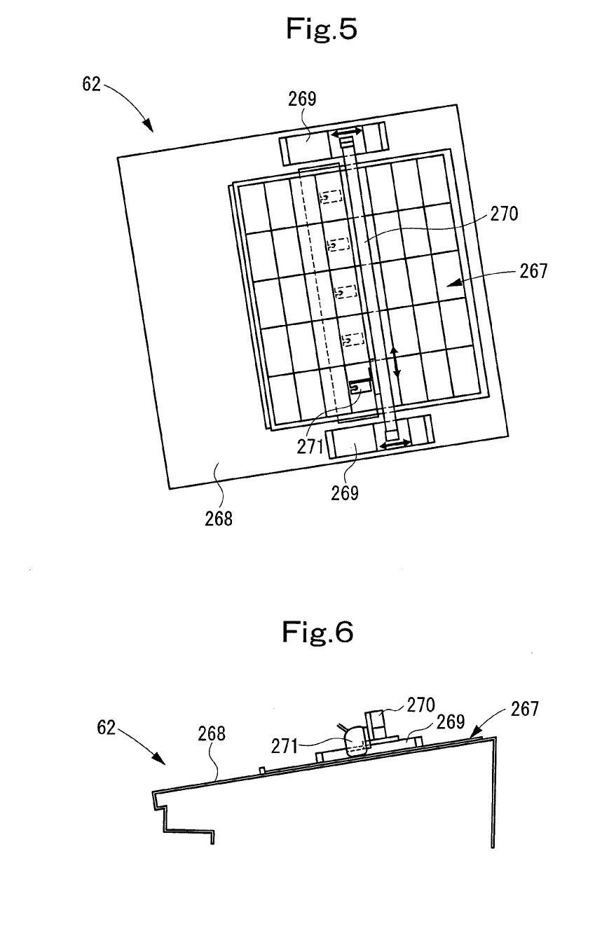

FIG. 5 shows a plan view of an ink film thickness measuring device (ink film thickness measuring means) according to the second embodiment of the present invention. As shown in FIG. 5, the ink film thickness measuring device 62 measures, by using a distance measuring device 271 such as a laser displacement meter, the ink film thickness of a printing product 267 on which a print is made by the printing press according to the second embodiment of the present invention. FIG. 6 shows a side view of the ink film thickness measuring device according to the second embodiment of the present invention. The ink film thickness measuring device 62 is provided on an ink film thickness measuring device body 268 placed outside the printing press. The ink film thickness measuring device 62 can be moved in the top-and-bottom direction by a pair of left and right electric slide cylinders 269, which is driven by a top-and-bottom direction movement motor. The ink film thickness measuring device 62 can be also moved in the left and right direction by a single electric slide cylinder 270, which is driven by a left-and-right direction movement motor. Accordingly, the ink film thickness measuring device 62 can directly measure the ink film thickness of a printed image on the printing product 267 placed on the ink film thickness measuring device body 268. Specifically, the ink film thickness=the distance (reference distance FD) from the distance measuring device 271 to a portion, where no ink is placed, of the printing product 67—the distance from the distance measuring device 271 to the ink on the printing product 267.

The ink feeding number control device 2, an ink fountain roller rotation speed control device 3, and an ink fountain key opening degree control device 4 are connected to the ink supply amount control apparatus 1 through the interface 21. The ink feeding number control device 2 controls the number of feedings of each ink. The ink fountain roller rotation speed control device 3 controls the rotation amount of each ink fountain roller. The ink fountain key opening degree control device 4 controls the opening degree of each of the ink fountain keys 109-1 to 109-N of each color.

The ink feeding number control device 2 includes first to M-th ink feeding number control devices 2-1 to 2-M. The ink fountain roller rotation speed control device 3 includes first to M-th ink fountain roller rotation speed control devices 3-1 to 3-M. The ink fountain key opening degree control device 4 includes a first ink fountain key opening degree control device 4-1-1 for first printing unit to an N-th ink fountain key opening degree control device 4-M-N for M-th printing unit.

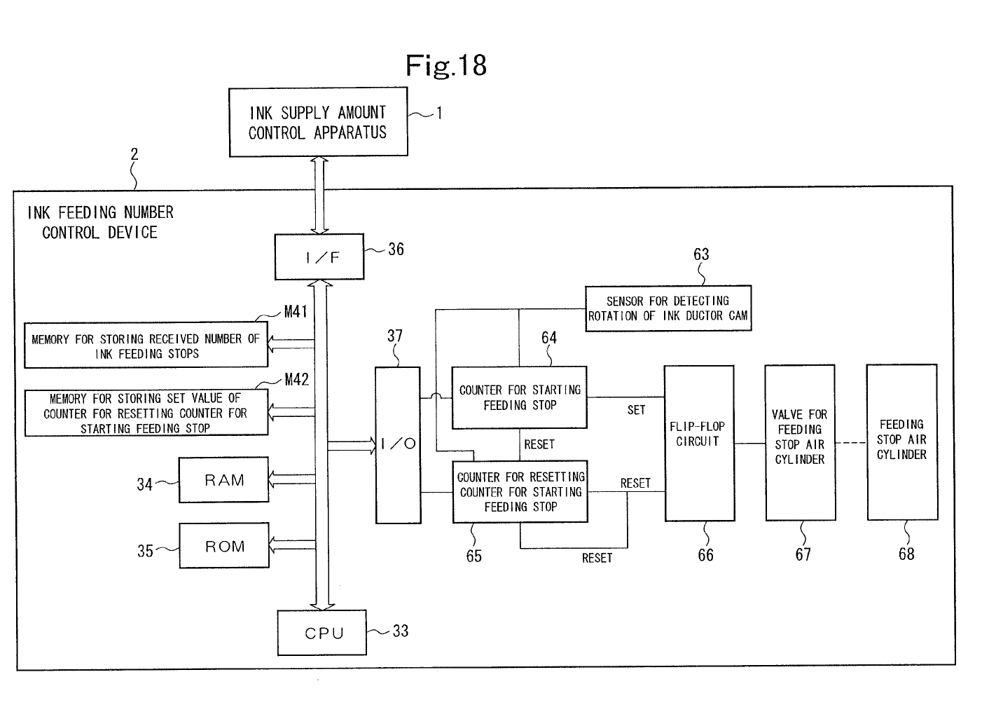

Next, the ink feeding number control device (the ink ductor roller swing means) according to the second embodiment of the present invention will be described. FIG. 18 shows a hardware block diagram of the ink feeding number control device according to the second embodiment of the present invention. As shown in FIG. 18, the ink feeding number control device 2 includes a CPU 33, a RAM 34, a ROM 35, input/output interfaces (I/O, I/F) 36 and 37, a sensor 63 for detecting the rotation of an ink ductor cam, a counter 64 for starting feeding stop, a counter 65 for resetting the counter for starting feeding stop, a flip-flop circuit 66, a valve 67 for the feeding stop air cylinder, the feeding stop air cylinder 68 (the ink ductor roller stop means), and memories M41 and M42.

The CPU 33 obtains various kinds of information which are inputted thereto through the interfaces 36 and 37, and operates in accordance with a program stored in the ROM 35, while accessing the RAM 34 as well as the memories M41 and M42. From the sensor 63 for detecting the rotation of the ink ductor cam, a pulse is transmitted to the counter 64 for starting feeding stop, and to the counter 65 for resetting the counter for starting feeding stop, for every one rotation of the cam. The counter 64 for starting feeding stop transmits a set signal to the flip-flop circuit 66, in accordance with a predetermined number of pulses, that is, a predetermined number of rotations of the ink ductor cam, which is set in advance with the input/output interface 37. With this set signal, the valve 67 for the feeding stop air cylinder is operated to extend the feeding stop air cylinder 68, so that the ductor roller 114 is stopped. On the other hand, the counter 65 for resetting the counter for starting feeding stop transmits reset signals respectively to the flip-flop circuit 66, the counter 64 for starting feeding stop, and the counter 65 for resetting the counter for starting feeding stop itself, in accordance with a predetermined number of pulses, that is, a predetermined number of rotations of the cam, which is set in advance with the input/output interface 37. With the reset signals, the valve 67 for the feeding stop air cylinder is operated to contract the feeding stop air cylinder 68, so that the ductor roller 114 is activated again.

In the ink feeding number control device 2, in the memory M41, a received number C1m of feeding stops is stored. In the memory M42, a set value C2m of the counter 65 for resetting the counter for starting feeding stop is stored.

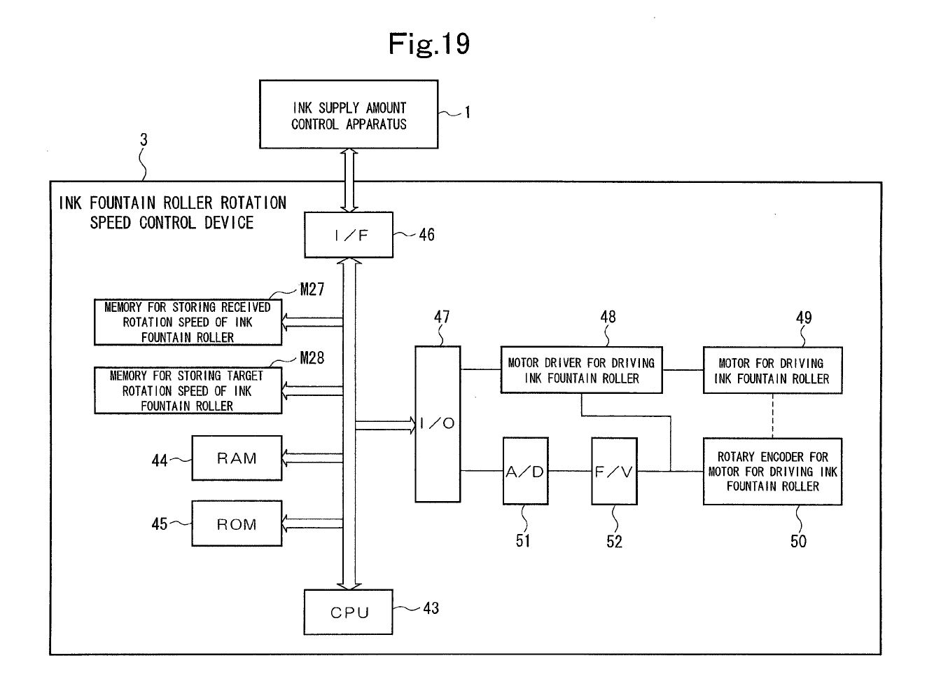

Next, an ink fountain roller rotation speed control device according to the second embodiment of the present invention will be described. FIG. 19 shows a hardware block diagram of the ink fountain roller rotation speed control device according to the second embodiment of the present invention. As shown in FIG. 19, the ink fountain roller rotation speed control device 3 includes a CPU 43, a RAM 44, a ROM 45, input/output interfaces (I/O, I/F) 46 and 47, a motor driver 48 for driving the ink fountain roller, a motor 49 for driving the ink fountain roller, a rotary encoder 50 for the motor for driving the ink fountain roller, an A/D converter 51, an F/V converter 52, and memories M27 and 28.

The CPU 43 obtains various kinds of information which are inputted thereto through the interfaces 46 and 47, and operates in accordance with a program stored in the ROM 45, while accessing the RAM 44 as well as the memories M27 and M28. The motor driver 48 for driving the ink fountain roller controls the motor 49 for driving the ink fountain roller. The rotary encoder 50 for the motor for driving the ink fountain roller generates one rotation pulse for every predetermined number of rotations (angle) of the motor 49 for driving the ink fountain roller, and then outputs the rotation pulse to the input/output interface 47.

In the ink fountain roller rotation speed control device 3, in the memory M27, a received rotation speed of the ink fountain roller is stored. In the memory M28, a target rotation speed of the ink fountain roller is stored.

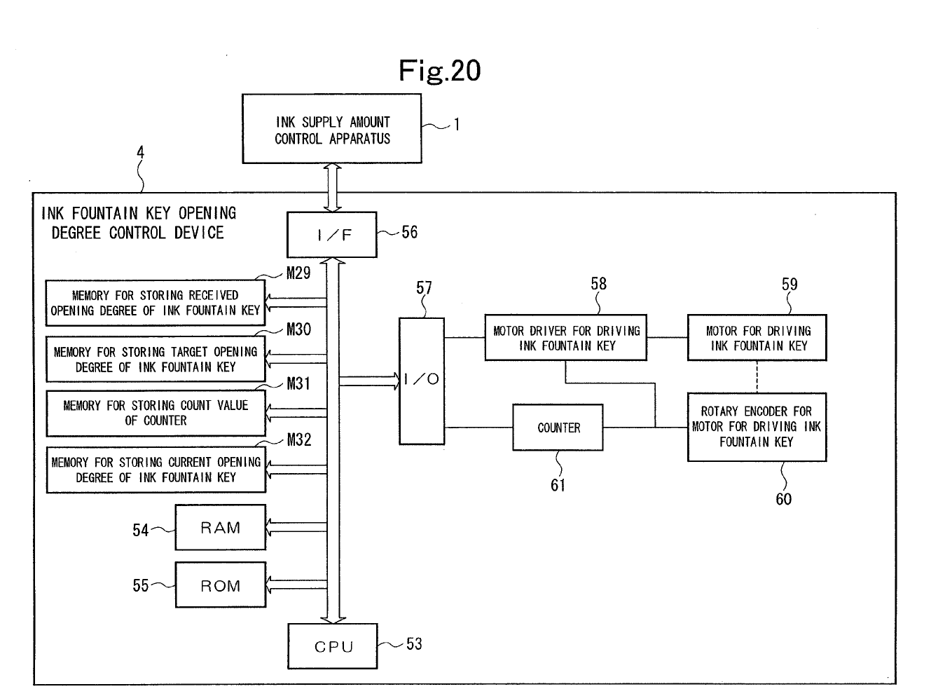

Next, the ink fountain key opening degree control device according to the second embodiment of the present invention will be described. FIG. 20 shows a hardware block diagram of the ink fountain key opening degree control device according to the first embodiment of the present invention. As shown in FIG. 20, the ink fountain key opening degree control device 4 includes a CPU 53, a RAM 54, a ROM 55, input/output interfaces (I/O, I/F) 56 and 57, a motor driver 58 for driving the ink fountain key, a motor 59 for driving the ink fountain key, a rotary encoder 60 for the motor for driving the ink fountain key, a counter 61, and memories M29 to M32.

The CPU 53 obtains various kinds of information which are inputted thereto through the interfaces 56 and 57, and operates in accordance with a program stored in the ROM 55, while accessing the RAM 54 as well as the memories M29 to M32.

In the ink fountain key opening degree control device 4, in the memory M29, a received opening degree of the ink fountain key 109 is stored. In the memory M30, a target opening degree of the ink fountain key 109 is stored. In the memory M31, a count value of the counter 61 is stored. In the memory M32, the current opening degree of the ink fountain key 109 is stored.

Note that, in FIG. 17B, the ink fountain key opening degree control devices 4-1-1 to 4-M-N are the ink fountain key opening degree control devices 4 provided for the respective ink fountain keys 109 (109-1 to 109-N) of the corresponding colors, which are shown in FIG. 48. With the ink fountain key opening degree control devices 4-1-1 to 4-M-N, the opening degrees of the ink fountain keys 109-1 to 109-N of each color are individually adjusted with respect to the corresponding ink fountain roller 108.

The ink fountain key opening degree control device 4 includes the motor driver 58 for driving the ink fountain key, the motor 59 for driving the ink fountain key, the rotary encoder 60 for the motor for driving the ink fountain key, and the counter 61. The ink fountain key opening degree control device 4 is connected to the CPU 10 of the ink supply amount control apparatus 1 through the interface 56. The rotary encoder 60 for the motor for driving the ink fountain key generates one rotation pulse for every predetermined number of rotations (angle) of the motor 59 for driving the ink fountain key, and then outputs the rotation pulse to the counter 61.

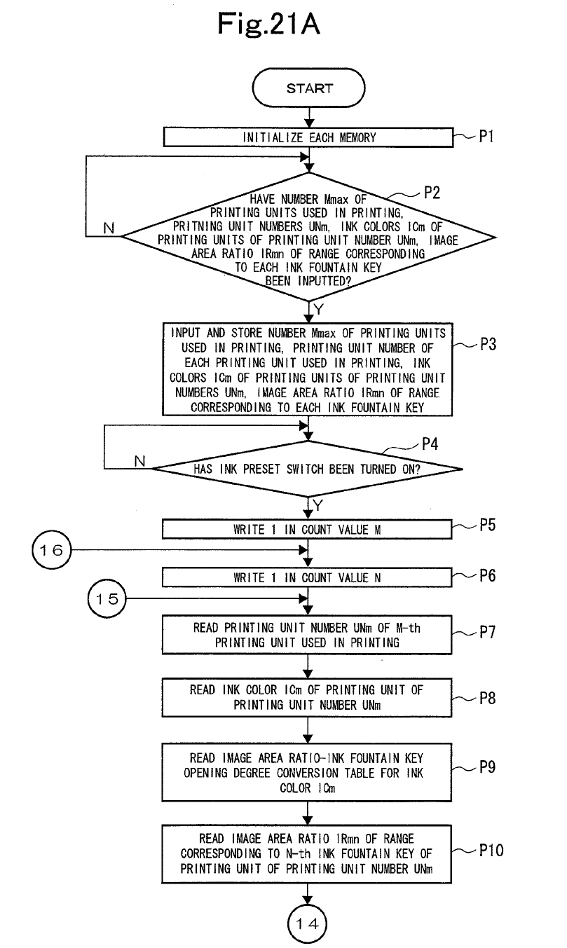

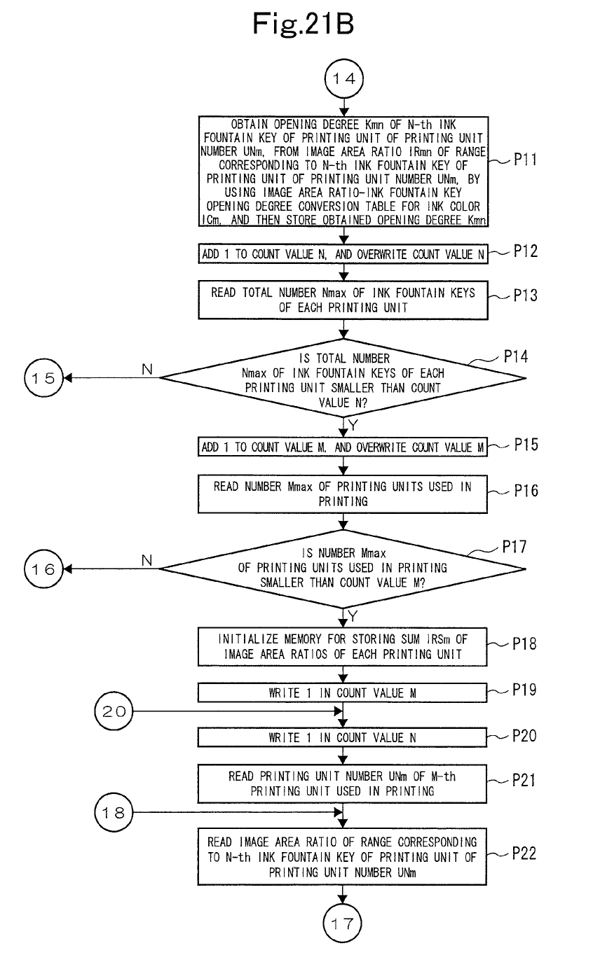

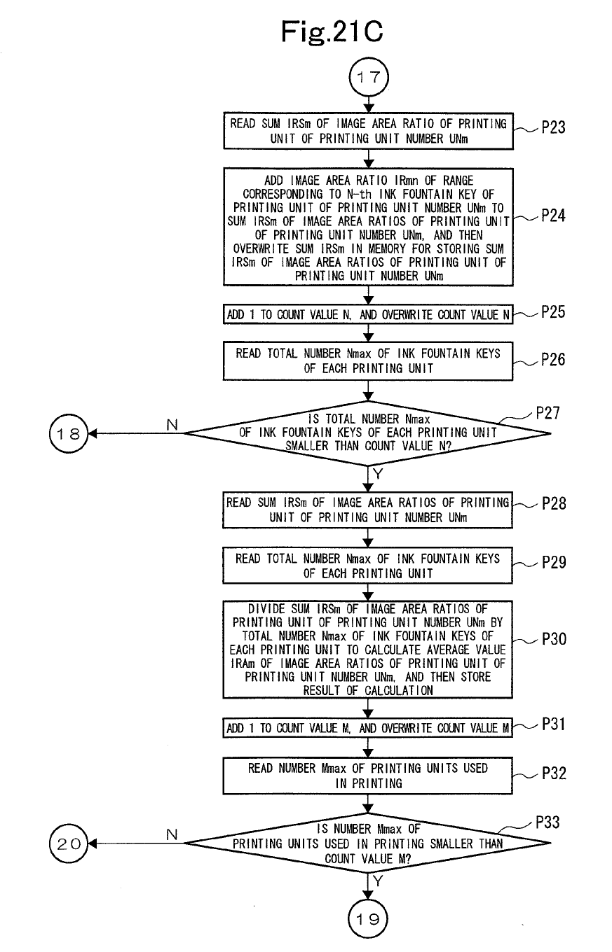

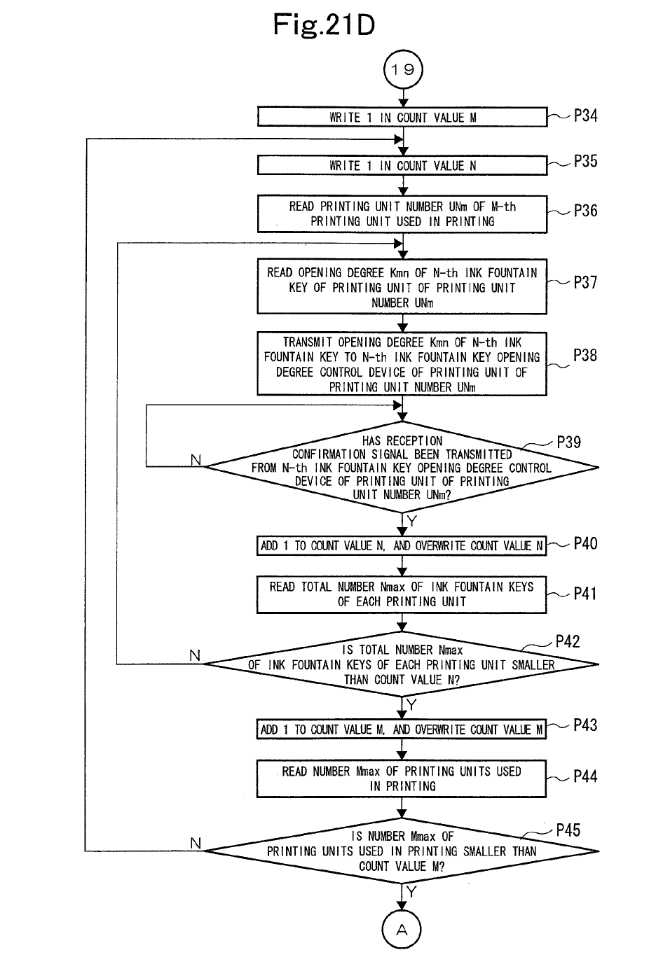

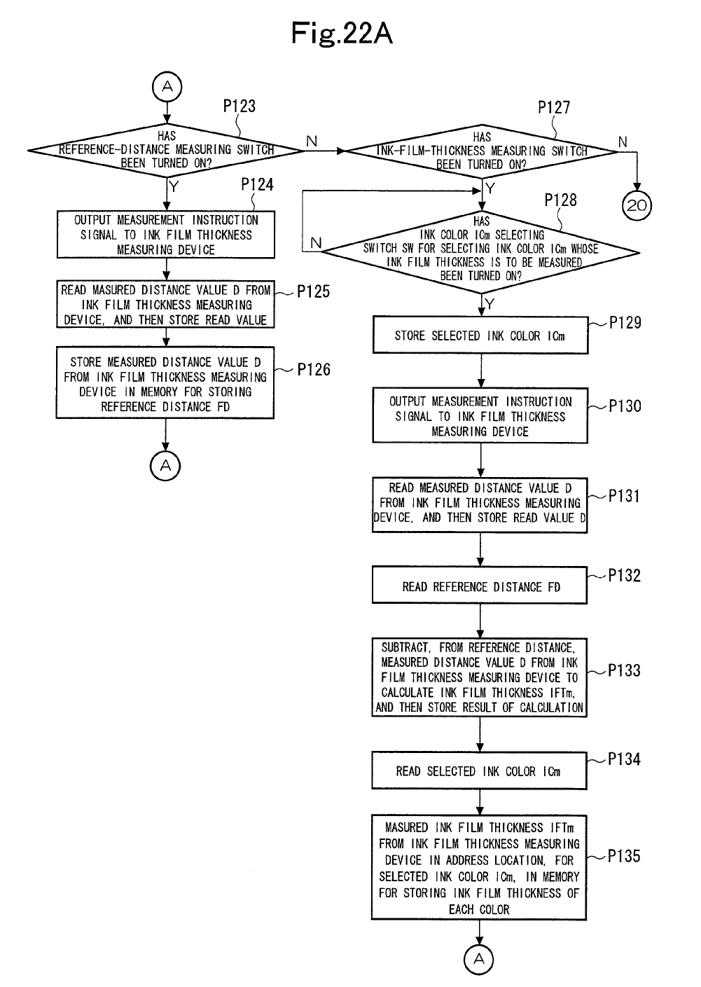

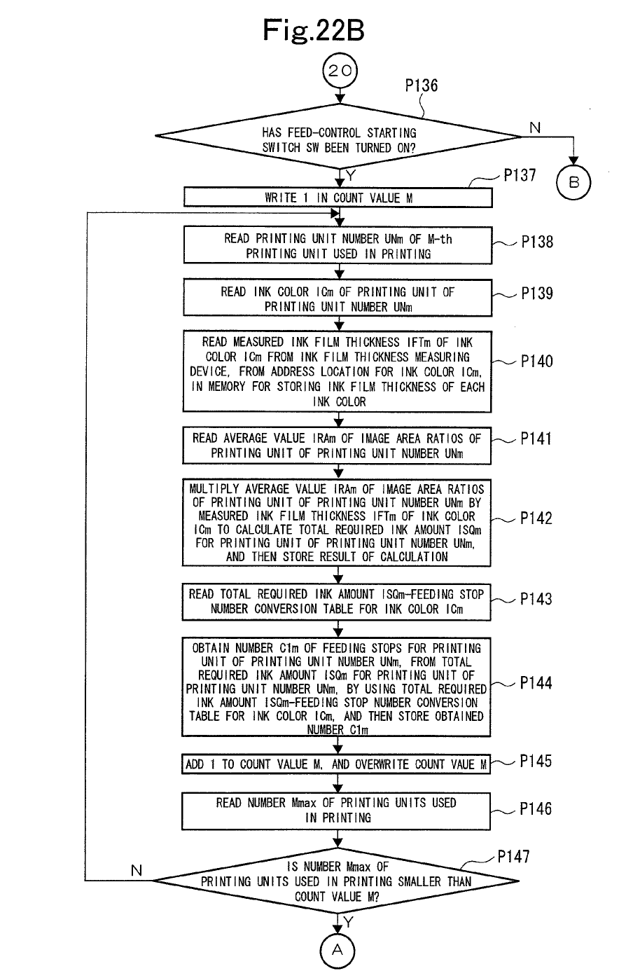

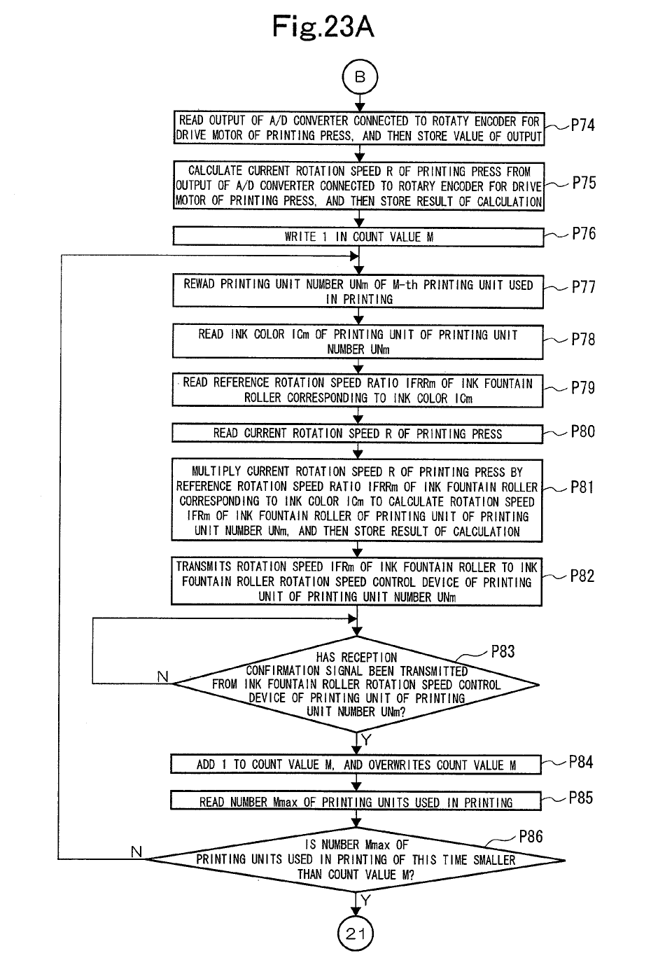

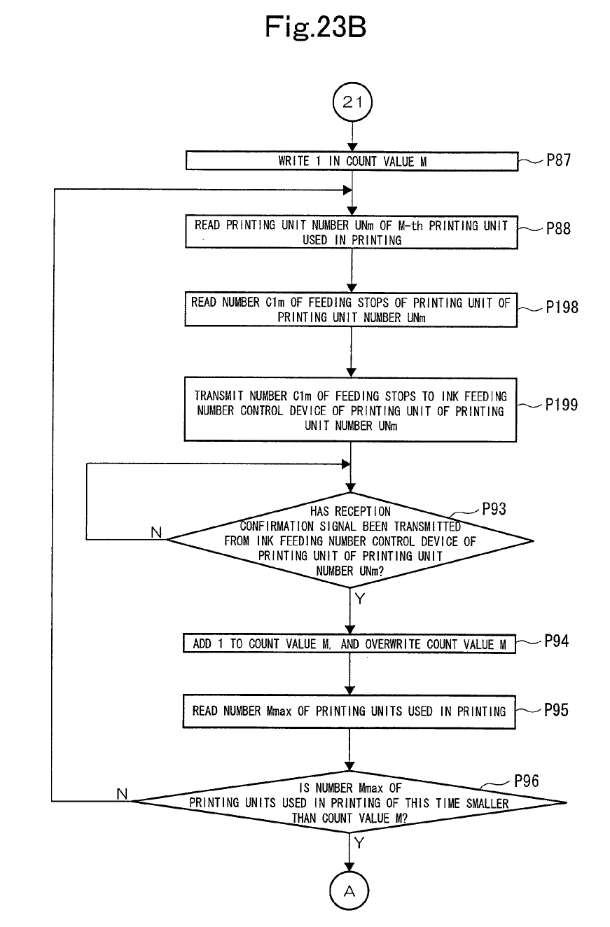

Next, the operation of the ink supply amount control apparatus according to the second embodiment of the present invention will be described. Each of FIGS. 21A to 21D, 22A, 22B, 23A and 23B shows an operational flowchart of the ink supply amount control apparatus according to the second embodiment of the present invention. Hereinafter, the content of the processing of each step will be described.

In Step P1, the CPU 10 initializes each memory. Upon completion of the processing of Step P1, the CPU 10 executes Step P2.

In Step P2, the CPU 10 determines whether or not the operator has inputted the number Mmax of printing units used in the printing, printing unit numbers UNm, ink colors ICm of the printing units of the printing unit numbers UNm, and an image area ratio IRmn of a range corresponding to each ink fountain key.

When the operator has inputted the number Mmax of printing units used in the printing, the printing unit numbers UNm, the ink colors ICm of the printing units of the printing unit numbers UNm, and the image area ratio IRmn of the range corresponding to each ink fountain key, the CPU 10 executes Step P3.

On the other hand, when the operator has not inputted the number Mmax of printing units used in the printing, the printing unit numbers UNm, the ink colors ICm of the printing units of printing unit numbers UNm, and the image area ratio IRmn of the range corresponding to each ink fountain key, the CPU 10 executes Step P2 again.

In Step P3, the CPU 10 inputs to store, the number Mmax of printing units used in the printing, the printing unit number UNm of each printing unit used in the printing, the ink colors ICm of the printing units of printing unit numbers UNm, and the image area ratio IRmn of the range corresponding to each ink fountain key, respectively in the memories M1, M2, M3, and M4. Upon completion of the processing of Step P3, the CPU 10 executes Step P4.

In Step P4, the CPU 10 determines whether or not the ink preset switch SW1 has been turned ON by the operator. When the ink preset switch SW1 has been turned ON, the CPU 10 executes Step P5. On the other hand, when the ink preset switch SW1 has not been turned ON, the CPU 10 executes Step P4 again.

In Step P5, the CPU 10 writes 1 in the count value M, that is, the CPU 10 stores 1 in the memory M5. Upon completion of the processing of Step P5, the CPU 10 executes Step P6.

In Step P6, the CPU 10 writes 1 in the count value N, that is, the CPU 10 stores 1 in the memory M6. Upon completion of the processing of Step P6, the CPU 10 executes Step P7.

In Step P7, the CPU 10 reads, from the memory M2, the printing unit number UNm of the M-th printing unit used in the printing. Upon completion of the processing of Step P7, the CPU 10 executes Step P8.

In Step P8, the CPU reads, from the memory M3, the ink color ICm of the printing unit of the printing unit number UNm. Upon completion of the processing of Step P8, the CPU 10 executes Step P9.

In Step P9, the CPU 10 reads, from the memory M7, the image area ratio-ink fountain key opening degree conversion table for the ink color ICm. Upon completion of the processing of Step P9, the CPU 10 executes Step P10.

In Step P10, the CPU 10 reads, from the memory M4, the image area ratio IRmn of the range corresponding to the N-th ink fountain key of the printing unit of the printing unit number UNm. Upon completion of the processing of Step P10, the CPU 10 executes Step P1.

In Step P11, the CPU 10 obtains the opening degree Kmn of the N-th ink fountain key of the printing unit of the printing unit number UNm, from the image area ratio IRmn of the range corresponding to the N-th ink fountain key of the printing unit of the printing unit number UNm, by using the image area ratio-ink fountain key opening degree conversion table for the ink color ICm. Then, the CPU 10 stores the obtained opening degree Kmn in the memory M8. Upon completion of the processing of Step P11, the CPU 10 executes Step P12.

In Step P12, the CPU 10 adds 1 to the count value N stored in the memory M6, and then overwrites the count value N. Upon completion of the processing of Step P12, the CPU 10 executes Step P13.

In Step P13, the CPU 10 reads, from the memory M9, the total number Nmax of ink fountain keys of each printing unit. Upon completion of the processing of Step P13, the CPU 10 executes Step P14.

In Step P14, the CPU 10 determines whether or not the total number Nmax of ink fountain keys of each printing unit, which is stored in the memory M9, is smaller than the count value N, which is stored in the memory M6. When the total number Nmax of ink fountain keys of each printing unit is smaller than the count value N, the CPU 10 executes Step P15. On the other hand, when the total number Nmax of ink fountain keys of each printing unit is larger than, or is equal to, the count value N, the CPU 10 executes Step P7. With this loop, the CPU 10 obtains the opening degree Kln of each ink fountain key of the printing unit of the first color.

In Step P15, the CPU 10 adds 1 to the count value M stored in the memory M5, and then overwrites the count value M. Upon completion of the processing of Step P15, the CPU 10 executes Step P16.

In Step P16, the CPU 10 reads, from the memory M1, the number Mmax of printing units used in the printing. Upon completion of the processing of Step P16, the CPU 10 executes Step P17.

In Step P17, the CPU 10 determines whether or not the number Mmax of printing units used in the printing, which is stored in the memory M1, is smaller than the count value M, which is stored in the memory M5. When the number Mmax of printing units used in the printing is smaller than the count value M, the CPU 10 executes Step P18. On the other hand, when the number Mmax of printing units used in the printing is larger than, or is equal to, the count value M, the CPU 10 executes Step P6. With this loop, the CPU 10 obtains the opening degree Kmn of each ink fountain key of the printing unit of each of the first to M-th colors.

In Step P18, the CPU 10 initializes the memory M10 for storing the sum IRSm of the image area ratios of each printing unit. Upon completion of the processing of Step P18, the CPU 10 executes Step P19.

In Step P19, the CPU 10 writes 1 in the count value M, that is, the CPU 10 stores 1 in the memory M5. Upon completion of Step P19, the CPU 10 executes Step P20.

In Step P20, the CPU 10 writes 1 in the count value N, that is, the CPU 10 stores 1 in the memory M6. Upon completion of Step P20, the CPU 10 executes Step P21.

In Step P21, the CPU 10 reads, from the memory M2, the printing unit number UNm of the M-th printing unit used in the printing. Upon completion of the processing of Step P21, the CPU 10 executes Step P22.

In Step P22, the CPU 10 reads, from the memory M4, the image area ratio IRmn of the range corresponding to the N-th ink fountain key of the printing unit of the printing unit number UNm. Upon completion of the processing of Step P22, the CPU 10 executes Step P23.

In Step P23, the CPU 10 reads, from the memory M10, the sum IRSm of the image area ratios of the printing unit of the printing unit number UNm. Upon completion of the processing of Step P23, the CPU 10 executes Step P24.

In Step P24, the CPU 10 adds the image area ratio IRmn of the range corresponding to the N-th ink fountain key of the printing unit of the printing unit number UNm, to the sum IRSm of the image area ratios of the printing unit of the printing unit number UNm. The CPU 10 then overwrites the sum IRSm in the memory M10 for storing the sum IRSm of the image area ratios of the printing unit of the printing unit number UNm. Upon completion of the processing of Step P24, the CPU 10 executes Step P25.

In Step P25, the CPU 10 adds 1 to the count value N stored in the memory M6, and then overwrites the count value N. Upon completion of the processing of Step P25, the CPU 10 executes Step P26.

In Step P26, the CPU 10 reads, from the memory M9, the total number Nmax of ink fountain keys of each printing unit. Upon completion of the processing of Step P26, the CPU 10 executes Step P27.

In Step P27, the CPU 10 determines whether or not the total number Nmax of ink fountain keys of each printing unit, which is stored in the memory M9, is smaller than the count value N, which is stored in the memory M6. When the total number Nmax of ink fountain keys of each printing unit is smaller than the count value N, the CPU 10 executes Step P28. On the other hand, when the total number Nmax of ink fountain keys of each printing unit is larger than, or is equal to, the count value N, the CPU 10 executes Step P22. With this loop, the CPU 10 obtains the sum IRS1 of the image area ratios IR1n of the ranges corresponding to the respective ink fountain keys of the printing unit of the first color.

In Step P28, the CPU 10 reads, from the memory M10, the sum IRSm of the image area ratios of the printing unit of the printing unit number UNm. Upon completion of the processing of Step P28, the CPU 10 executes Step P29.

In Step P29, the CPU 10 reads, from the memory M9, the total number Nmax of ink fountain keys of each printing unit. Upon completion of the processing of Step P29, the CPU 10 executes Step P30.

In Step P30, the CPU 10 divides the sum IRSm of the image area ratios of the printing unit of the printing unit number UNm by the total number Nmax of ink fountain keys of each printing unit to calculate the average value IRAm of the image area ratios of the printing unit of the printing unit number UNm. The CPU 10 then stores the result of the calculation in the memory M11. Upon completion of the processing of Step P30, the CPU 10 executes Step P31.

In Step P31, the CPU 10 adds 1 to the count value M stored in the memory M5, and then overwrites the count value M. Upon completion of the processing of Step P31, the CPU 10 executes Step P32.

In Step P32, the CPU 10 reads, from the memory M1, the number Mmax of printing units used in the printing. Upon completion of the processing of Step P32, the CPU 10 executes Step P33.

In Step P33, the CPU 10 determines whether or not the number Mmax of printing units used in the printing, which is stored in the memory M1, is smaller than the count value M, which is stored in the memory M5. When the number Mmax of printing units used in the printing is smaller than the count value M, the CPU 10 executes Step P34. On the other hand, when the number Mmax of printing units used in the printing is larger than, or is equal to, the count value M, the CPU 10 executes Step P20. With this loop, the CPU 10 obtains the average value IRAm of the image area ratios IRmn of the ranges corresponding to the respective ink fountain keys of the printing unit of each of the first to M-th colors.

In Step P34, the CPU 10 writes 1 in the count value M, that is, the CPU 10 stores 1 in the memory M5. Upon completion of the processing of Step P34, the CPU 10 executes Step P35.

In Step P35, the CPU 10 writes 1 in the count value N, that is, the CPU 10 stores 1 in the memory M6. Upon completion of the processing of Step P35, the CPU 10 executes Step P36.

In Step P36, the CPU 10 reads, from the memory M2, the printing unit number UNm of the M-th printing unit used in the printing. Upon completion of the processing of Step P36, the CPU 10 executes Step P37.

In Step P37, the CPU 10 reads, from the memory M8, the opening degree Kmn of the N-th ink fountain key of the printing unit of the printing unit number UNm. Upon completion of the processing of Step P37, the CPU 10 executes Step P38.

In Step P38, the CPU 10 transmits the opening degree Kmn of the N-th ink fountain key to the N-th ink fountain key opening degree control device 4 of the printing unit of the printing unit number UNm. Upon completion of the processing of Step P38, the CPU 10 executes Step P39.

In Step P39, the CPU 10 determines whether or not a reception confirmation signal has been transmitted from the N-th ink fountain key opening degree control device 4 of the printing unit of the printing unit number UNm. When the reception confirmation signal has been transmitted from the N-th ink fountain key opening degree control device 4 of the printing unit of the printing unit number UNm, the CPU 10 executes Step P40. On the other hand, when the reception confirmation signal has not been transmitted from the N-th ink fountain key opening degree control device 4 of the printing unit of the printing unit number UNm, the CPU 10 executes Step P39 again.

In Step P40, the CPU 10 adds 1 to the count value N stored in the memory M6, and then overwrites the count value N. Upon completion of the processing of Step P40, the CPU 10 executes Step P41.

In Step P41, the CPU 10 reads, from the memory M9, the total number Nmax of ink fountain keys of each printing unit. Upon completion of the processing of Step P41, the CPU 10 executes Step P42.

In Step P42, the CPU 10 determines whether or not the total number Nmax of ink fountain keys of the printing unit, which is stored in the memory M9, is smaller than the count value N, which is stored in the memory M6. When the total number Nmax of ink fountain keys of the printing unit is smaller than the count value N, the CPU 10 executes Step P43. On the other hand, when the total number Nmax of ink fountain keys of the printing unit, is larger than, or is equal to, the count value N, the CPU 10 executes Step P37. With this loop, the CPU 10 transmits the opening degree K1n of each ink fountain key to the corresponding ink fountain key opening degree control device 4-1-N of the printing unit of the first color.

In Step P43, the CPU 10 adds 1 to the count value M stored in the memory M5, and then overwrites the count value M. Upon completion of the processing of Step P43, the CPU 10 executes Step P44.

In Step P44, the CPU 10 reads, from the memory M1, the number Mmax of printing units used in the printing. Upon completion of the processing of Step P44, the CPU 10 executes Step P45.

In Step P45, the CPU 10 determines whether or not the number Mmax of printing units used in the printing, which is stored in the memory M1, is smaller than the count value M, which is stored in the memory M5. When the number Mmax of printing units used in the printing is smaller than the count value M, the CPU 10 executes Step P123. On the other hand, when the number Mmax of printing units used in the printing is larger than, or is equal to, the count value M, the CPU 10 executes Step P35. With this loop, the CPU 10 transmits the opening degree Kmn of each ink fountain key to the corresponding ink fountain key opening degree control device 4-M-N of the printing unit of each of the first to M-th colors.

In Step P123, the CPU 10 determines whether or not the reference-distance measuring switch SW3 has been turned ON by the operator. When the reference-distance measuring switch SW3 has been turned ON, the CPU 10 executes Step P124. On the other hand, when the reference-distance measuring switch SW3 has not been turned ON, the CPU 10 executes Step P127.

In Step P124, the CPU 10 outputs a measurement instruction signal to the ink film thickness measuring device 62. Upon completion of the processing of Step P124, the CPU 10 executes Step P125.

In Step P125, the CPU 10 reads the measured distance value D from the ink film thickness measuring device 62, which value is a digital value obtained by the conversion of the A/D converter 29. The CPU 10 then stores the read value in the memory M33. Upon completion of the processing of Step P125, the CPU 10 executes Step P126.

In step P126, the CPU 10 stores the measured distance value D from the ink film thickness measuring device 62 in the memory M34. Upon completion of the processing of Step P126, the CPU 10 executes Step P127 via Step P123.

In Step P127, the CPU 10 determines whether or not the ink-film-thickness measuring switch SW4 has been turned ON by the operator. When the ink-film-thickness measuring switch SW4 has been turned ON, the CPU 10 executes Step P128. On the other hand, when the ink-film-thickness measuring switch SW4 has not been turned ON, the CPU 10 executes Step P136.

In Step P128, the CPU 10 determines whether or not the ink-color-ICm selecting switch SW5 for selecting an ink color ICm to be measured has been turned ON by the operator. When the ink-color-ICm selecting switch SW5 has been turned ON, the CPU 10 executes Step P129. On the other hand, when the ink-color-ICm selecting switch SW5 has not been turned ON, the CPU 10 executes Step P128 again. It should be noted that the operator operates the electric slide cylinders 69 and the electric slide cylinder 70 for each time of measurement so as to move the distance measuring device 71 of the ink film thickness measuring device 62 to a position of an image or a mark of an ink color ICm to be measured.

In Step P129, the CPU 10 stores the selected ink color ICm in the memory M35. Upon completion of the processing of Step P129, the CPU 10 executes Step P130.

In Step P130, the CPU 10 outputs a measurement instruction signal to the ink film thickness measuring device 62. Upon completion of the processing of Step P130, the CPU 10 executes Step P131.

In Step P131, the CPU 10 reads the measured distance value D from the ink film thickness measuring device 62, and then stores the read value D in the memory M33. Upon completion of the processing of Step P131, the CPU 10 executes Step P132.

In Step P132, the CPU 10 reads, from the memory M34, the reference distance FD. Upon completion of the processing of Step P132, the CPU 10 executes Step P133.

In Step P133, the CPU 10 subtracts, from the reference distance FD, the measured distance value D from the ink film thickness measuring device 62, to calculate an ink film thickness IFTm. The CPU 10 then stores the result of the calculation in the memory M36. Upon completion of the processing of Step P133, the CPU 10 executes Step P134.

In Step P134, the CPU 10 reads, from the memory M35, the selected ink color ICm. Upon completion of the processing of Step P134, the CPU 10 executes Step P135.

In Step P135, the CPU 10 stores the measured ink film thickness IFTm, obtained by using the ink film thickness measuring device 62, in an address location, for the selected ink color ICm, in the memory M37 for storing the ink film thickness of each ink color. Upon completion of the processing of Step P135, the CPU 10 executes Step P136 via Step P123.

In Step P136, the CPU 10 determines whether or not the feed-control starting switch SW6 has been turned ON by the operator. When the feed-control starting switch SW6 has been turned ON, the CPU 10 executes Step P137. On the other hand, when the feed-control starting switch SW6 has not been turned ON, the CPU 10 executes Step P74.

In Step P137, the CPU 10 writes 1 in the count value M, that is, the CPU 10 stores 1 in the memory M5. Upon completion of the processing of Step P137, the CPU 10 executes Step P138.

In Step P138, the CPU 10 reads, from the memory M2, the printing unit number UNm of the M-th printing unit used in the printing. Upon completion of the processing of Step P138, the CPU 10 executes Step P139.

In Step P139, the CPU 10 reads, from the memory M3, the ink color ICm of the printing unit of the printing unit number UNm. Upon completion of the processing of Step P139, the CPU 10 executes Step P140.

In Step P140, the CPU 10 reads the measured ink film thickness IFTm, obtained by using the ink film thickness measuring device 62, of the ink color ICm from the address location, for the ink color ICm, in the memory M37 for storing the ink film thickness of each ink color. Upon completion of the processing of Step P140, the CPU 10 executes Step P141.

In Step P141, the CPU 10 reads, from the memory M11, the average value IRAm of the image area ratios of the printing unit of the printing unit number UNm. Upon completion of the processing of Step P141, the CPU 10 executes Step P142.

In Step P142, the CPU 10 multiplies the average value IRAm of the image area ratios of the printing unit of the printing unit number UNm by the measured ink film thickness IFTm of the ink color ICm to calculate a total required ink amount ISQm for the printing unit of the printing unit number UNm. The CPU 10 then stores the result of the calculation in the memory M38. Upon completion of the processing of Step P142, the CPU 10 executes Step P143.

In Step P143, the CPU 10 reads, from the memory M39, the total required ink amount ISQm-feeding stop number conversion table for the ink color ICm. Upon completion of the processing of Step P143, the CPU 10 executes Step P144.

In Step P144, the CPU 10 obtains the number C1m of feeding stops for the printing unit of the printing unit number UNm, from the total required ink amount ISQm for the printing unit of the printing unit number UNm, by using the total required ink amount ISQm-feeding stop number conversion table for the ink color ICm. The CPU 10 then stores the obtained value in the memory M40. Upon completion of the processing of Step P144, the CPU 10 executes Step P145.

In Step P145, the CPU 10 adds 1 to the count value M stored in the memory M5, and then overwrites the count value M. Upon completion of the processing of Step P145, the CPU 10 executes Step P146.

In Step P146, the CPU 10 reads, from the memory M1, the number Mmax of printing units used in the printing. Upon completion of the processing of Step P146, the CPU 10 executes Step P147.

In Step P147, the CPU 10 determines whether or not the number Mmax of printing units used in the printing, which is stored in the memory M1, is smaller than the count value M, which is stored in the memory M5. When the number Mmax of printing units used in the printing is smaller than the count value M, the CPU 10 executes Step P123. On the other hand, when the number Mmax of printing units used in the printing is larger than, or is equal to, the count value M, the CPU 10 executes Step P138. With this loop, the CPU 10 obtains the number C1m of feeding stops for each printing unit.

In Step P74, the CPU 10 reads an output of the A/D converter 30 connected to the rotary encoder 28 for the drive motor of the printing press, and then stores the value of the output in the memory M20. Upon completion of the processing of Step P74, the CPU 10 executes Step P75.

In Step P75, the CPU 10 calculates the current rotation speed R of the printing press from the output, which is stored in the memory M20, of the A/D converter 30 connected to the rotary encoder 28 for the drive motor of the printing press. The CPU 10 then stores the result of the calculation in the memory M21. Upon completion of the processing of Step P75, the CPU 10 executes Step P76.

In Step P76, the CPU 10 writes 1 in the count value M, that is, the CPU 10 stores 1 in the memory M5. Upon completion of the processing of Step P76, the CPU 10 executes Step P77.

In Step P77, the CPU 10 reads, from the memory M2, the printing unit number UNm of the M-th printing unit used in the printing. Upon completion of the processing of Step P77, the CPU 10 executes Step P78.

In Step P78, the CPU 10 reads, from the memory M3, the ink color ICm of the printing unit of the printing unit number UNm. Upon completion of the processing of Step P78, the CPU 10 executes Step P79.

In Step P79, the CPU 10 reads, from the memory M22, the reference rotation speed ratio IFRRm of the ink fountain roller corresponding to the ink color ICm. Upon completion of the processing of Step P79, the CPU 10 executes Step P80.

In Step P80, the CPU 10 reads, from the memory M21, the current rotation speed R of the printing press. Upon completion of the processing of Step P80, the CPU 10 executes Step P81.

In Step P81, the CPU 10 multiplies the current rotation speed R of the printing press by the reference rotation speed ratio IFRRm of the ink fountain roller corresponding to the ink color ICm to calculate the rotation speed IFRm of the ink fountain roller of the printing unit of the printing unit number UNm. The CPU 10 then stores the result of the calculation in the memory M23. Upon completion of the processing of Step P81, the CPU 10 executes Step P82.

In Step P82, the CPU 10 transmits the rotation speed IFRm of the ink fountain roller to the ink fountain roller rotation speed control device 3 of the printing unit of the printing unit number UNm. Upon completion of the processing of Step P82, the CPU 10 executes Step P83.

In Step P83, the CPU 10 determines whether or not a reception confirmation signal has been transmitted from the ink fountain roller rotation speed control device 3 of the printing unit of the printing unit number UNm. When the reception confirmation signal has been transmitted from the ink fountain roller rotation speed control device 3 of the printing unit of the printing unit number UNm, the CPU 10 executes Step P84. On the other hand, when the reception confirmation signal has not been transmitted from the ink fountain roller rotation speed control device 3 of the printing unit of the printing unit number UNm, the CPU 10 executes Step P83 again.

In Step P84, the CPU 10 adds 1 to the count value M stored in the memory M5, and then overwrites the count value M. Upon completion of the processing of Step P84, the CPU 10 executes Step P85.

In Step P85, the CPU 10 reads, from the memory M1, the number Mmax of printing units used in the printing. Upon completion of the processing of Step P85, the CPU 10 executes Step P86.

In Step P86, the CPU 10 determines whether or not the number Mmax of printing units used in the printing at this time, which is stored in the memory M1, is smaller than the count value M, which is stored in the memory M5. When the number Mmax of printing units used in the printing at this time is smaller than the count value M, the CPU 10 executes Step P87. On the other hand, when the number Mmax of printing units used in the printing at this time is larger than, or is equal to, the count value M, the CPU 10 executes Step P77. With this loop, the CPU 10 transmits the rotation speed IFRm of the ink fountain roller of each color to the ink fountain roller rotation speed control device 3 of the printing unit of the color.

In Step P87, the CPU 10 writes 1 in the count value M, that is, the CPU 10 stores 1 in the memory M5. Upon completion of the processing of Step P87, the CPU 10 executes Step P88.

In Step P88, the CPU 10 reads, from the memory M2, the printing unit number UNm of the M-th printing unit used in the printing. Upon completion of the processing of Step P88, the CPU 10 executes Step P198.

In Step P198, the CPU 10 reads, from the memory M40, the number C1m of feeding stops of the printing unit of the printing unit number UNm. Upon completion of the processing of Step P198, the CPU 10 executes Step P199.

In Step P199, the CPU 10 transmits the number C1m of feeding stops to the ink feeding number control device 2 of the printing unit of the printing unit number UNm. Upon completion of the processing of Step P199, the CPU 10 executes Step P93.

In Step P93, the CPU 10 determines whether or not a reception confirmation signal has been transmitted from the ink feeding number control device 2 of the printing unit of the printing unit number UNm. When the reception confirmation signal has been transmitted from the ink feeding number control device 2 of the printing unit of the printing unit number UNm, the CPU 10 executes Step P94. On the other hand, when the reception confirmation signal has not been transmitted from the ink feeding number control device 2 of the printing unit of the printing unit number UNm, the CPU 10 executes Step P93 again.

In Step P94, the CPU 10 adds 1 to the count value M stored in the memory M5, and then overwrites the count value M. Upon completion of the processing of Step P94, the CPU 10 executes Step P95.

In Step P95, the CPU 10 reads, from the memory M1, the number Mmax of printing units used in the printing. Upon completion of the processing of Step P95, the CPU 10 executes Step P96.

In Step P96, the CPU 10 determines whether or not the number Mmax of printing units used in the printing at this time, which is stored in the memory M1, is smaller than the count value M, which is stored in the memory M5. When the number Mmax of printing units used in the printing at this time is smaller than the count value M, the CPU 10 executes Step P123. On the other hand, the number Mmax of printing units used in the printing at this time is larger than, or is equal to, the count value M, the CPU 10 executes Step P88. With this loop, the CPU 10 transmits the number C1m of feeding stops to the ink feeding number control device 2 of the printing unit of each color.

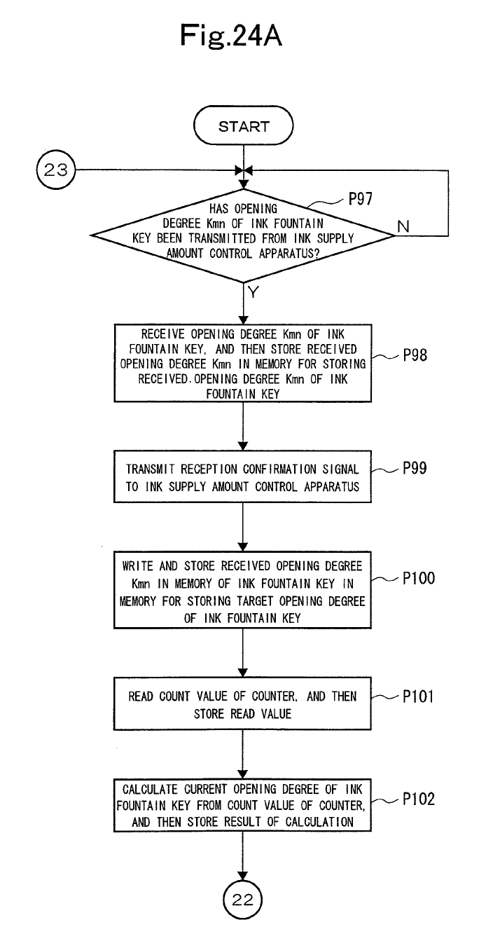

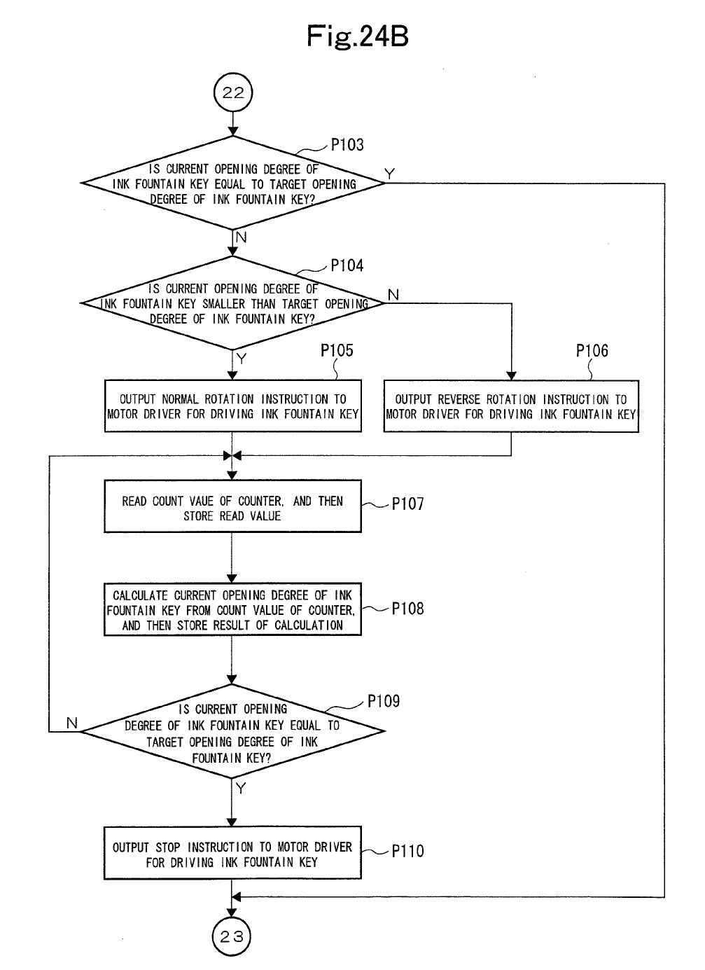

Next, descriptions will be given of the operation of the ink fountain key opening degree control device 4, which controls the opening degree of each ink fountain key of each color, according to the second embodiment of the present invention. Each of FIGS. 24A and 24B shows an operational flowchart of the ink fountain key opening degree control device 4, which controls the opening degree of each ink fountain key of each color, according to the second embodiment of the present invention. Hereinafter, the content of the processing of each step will be described.

In Step P97, the CPU 53 determines whether or not the opening degree Kmn of the corresponding ink fountain key has been transmitted from the ink supply amount control apparatus 1. When the opening degree Kmn of the ink fountain key has been transmitted from the ink supply amount control apparatus 1, the CPU 53 executes Step P98. On the other hand, when the opening degree Kmn of the ink fountain key has not been transmitted from the ink supply amount control apparatus 1, the CPU 53 executes Step P97 again.

In Step P98, the CPU 53 receives the opening degree Kmn of the ink fountain key, and then stores the received opening degree Kmn of the ink fountain key in the memory M29. Upon completion of the processing of Step P98, the CPU 53 executes Step P99.

In Step P99, the CPU 53 transmits a reception confirmation signal to the ink supply amount control apparatus 1. Upon completion of the processing of Step P99, the CPU 10 executes Step P100.

In Step P100, the CPU 53 writes and stores the received opening degree Kmn of the ink fountain key in the memory M30 for storing the target opening degree of the ink fountain key. Upon completion of the processing of Step P100, the CPU 53 executes Step P101.

In Step P101, the CPU 53 reads the count value of the counter 61, and then stores the read value in the memory M31. Upon completion of the processing of Step P101, the CPU 53 executes Step P102.

In Step P102, the CPU 53 calculates the current opening degree of the ink fountain key from the count value of the counter 61, and then stores the result of the calculation in the memory M32. Upon completion of the processing of Step P102, the CPU 53 executes Step P103.

In Step P103, the CPU 53 determines whether or not the current opening degree of the ink fountain key is equal to the target opening degree of the ink fountain key. When the current opening degree of the ink fountain key is equal to the target opening degree of the ink fountain key, the CPU 53 executes Step P97. On the other hand, when the current opening degree of the ink fountain key is not equal to the target opening degree of the ink fountain key, the CPU 53 executes Step P104.

In Step P104, the CPU 53 determines whether or not the current opening degree of the ink fountain key is smaller than the target opening degree of the ink fountain key. When the current opening degree of the ink fountain key is smaller than the target opening degree of the ink fountain key, the CPU 53 executes Step P105. On the other hand, when the current opening degree of the ink fountain key is larger than the target opening degree of the ink fountain key, the CPU 53 executes Step P106.

In Step P105, the CPU 53 outputs a normal rotation instruction to the motor driver 58 for driving the ink fountain key. Upon completion of the processing of Step P105, the CPU 53 executes Step P107.

In Step P106, the CPU 53 outputs a reverse rotation instruction to the motor driver 58 for driving the ink fountain key. Upon completion of the processing of Step P105, the CPU 53 executes Step P107.

In Step P107, the CPU 53 reads the count value of the counter 61, and then stores the read value in the memory M31. Upon completion of the processing of Step P107, the CPU 53 executes Step P108.

In Step P108, the CPU 53 calculates the current opening degree of the ink fountain key from the count value stored in the memory M31, and then stores the result of the calculation in the memory M32. Upon completion of the processing of Step P108, the CPU 53 executes Step P109.

In Step P109, the CPU 53 determines whether or not the current opening degree of the ink fountain key, which is stored in the memory M32, is equal to the target opening degree of the ink fountain key, which is stored in the memory M30. When the current opening degree of the ink fountain key is equal to the target opening degree of the ink fountain key, the CPU 53 executes Step P110. On the other hand, when the current opening degree of the ink fountain key is not equal to the target opening degree of the ink fountain key, the CPU 53 executes Step P107.

In Step P110, the CPU 53 outputs a stop instruction to the motor driver 58 for driving the ink fountain key. Upon completion of the processing of Step P110, the CPU 53 executes Step P97.

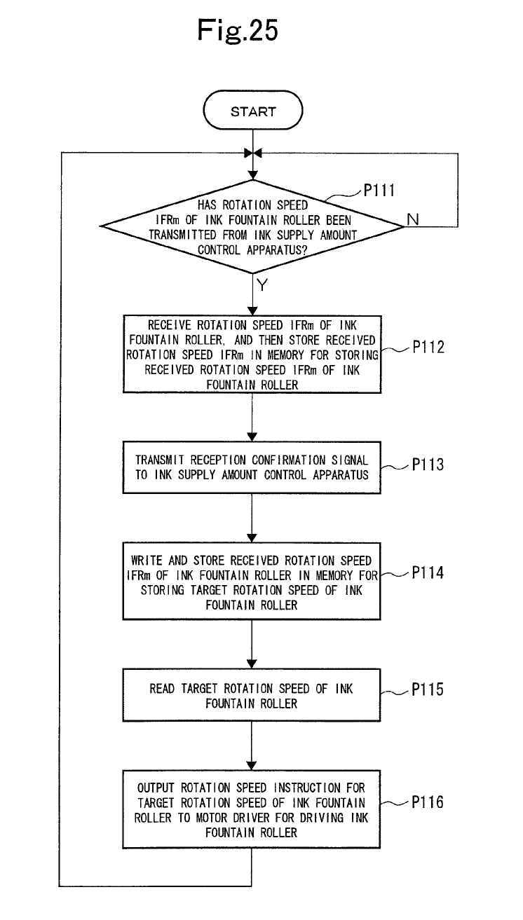

Next, descriptions will be given of the operation of the ink fountain roller rotation speed control device 3, which controls the rotation amount of each ink fountain roller, according to the second embodiment of the present invention. FIG. 25 shows an operational flowchart of the ink fountain roller rotation speed control device 3, which controls the rotation amount of each ink fountain roller, according to the second embodiment of the present invention. Hereinafter, the content of the processing of each step will be described.

In Step P111, the CPU 43 determines whether or not the rotation speed IFRm of the ink fountain roller has been transmitted from the ink supply amount control apparatus 1. When the rotation speed IFRm of the ink fountain roller has been transmitted from the ink supply amount control apparatus 1, the CPU 43 executes Step P112. On the other hand, when the rotation speed IFRm of the ink fountain roller has not been transmitted from the ink supply amount control apparatus 1, the CPU 43 executes Step P111 again.

In Step P112, the CPU 43 receives the rotation speed IFRm of the ink fountain roller, and then stores the received rotation speed IFRm of the ink fountain roller in the memory M27. Upon completion of the processing of Step P112, the CPU 43 executes Step P113.

In Step P113, the CPU 43 transmits a reception confirmation signal to the ink supply amount control apparatus 1. Upon completion of the processing of Step P113, the CPU 43 executes Step P114.

In Step P114, the CPU 43 writes and stores the received rotation speed IFRm of the ink fountain roller in the memory M28 for storing the target rotation speed of the ink fountain roller. Upon completion of the processing of Step P114, the CPU 43 executes Step P115.

In Step P115, the CPU 43 reads, from the memory M28, the target rotation speed of the ink fountain roller. Upon completion of the processing of Step P115, the CPU 43 executes Step P116.

In Step P116, the CPU 43 outputs a rotation speed instruction, for causing the ink fountain roller to rotate at the target rotation speed, to the motor driver 48 for driving the ink fountain roller. Upon completion of the processing of Step P116, the CPU 43 executes Step P111.

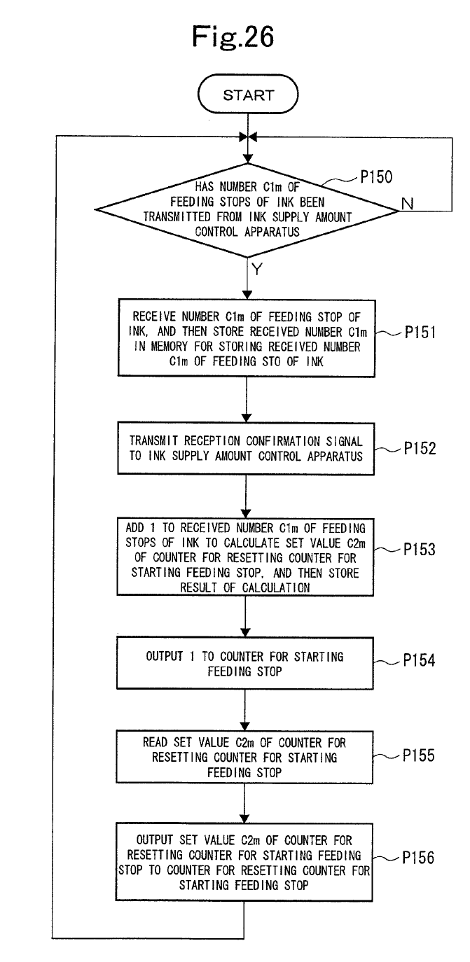

Next, descriptions will be given of the operation of the ink feeding number control device 2, which controls the number of feedings of each ink, according to the second embodiment of the present invention. FIG. 26 shows an operational flowchart of the ink feeding number control device 2, which controls the number of feedings of each ink, according to the second embodiment of the present invention. Hereinafter, the content of the processing of each step will be described.

In Step P150, the CPU 33 determines whether or not the number C1m of feeding stops has been transmitted from the ink supply amount control apparatus 1. When the number C1m of feeding stops has been transmitted from the ink supply amount control apparatus 1, the CPU 33 executes Step P151. On the other hand, when the number C1m of feeding stops has not been transmitted from the ink supply amount control apparatus 1, the CPU 33 executes Step P150 again.

In Step P151, the CPU 33 receives the number C1m of feeding stops, and then stores the received number C1m of feeding stops in the memory M41. Upon completion of the processing of Step P151, the CPU 33 executes Step P152.

In Step P152, the CPU 33 transmits a reception confirmation signal to the ink supply amount control apparatus 1. Upon completion of the processing of Step P152, the CPU 33 executes Step P153.

In Step P153, the CPU 33 adds 1 to the received number C1m of feeding stops to calculate a set value C2m of the counter 65 for resetting the counter for starting feeding stop. The CPU 33 then stores the result of the calculation in the memory M42. Upon completion of the processing of Step P153, the CPU 33 executes Step P154.

In Step P154, the CPU 33 outputs 1 to the counter 64 for starting feeding stop. Upon completion of the processing of Step P154, the CPU 33 executes Step P155.

In Step P155, the CPU 33 reads, from the memory M42, the set value C2m of the counter 65 for resetting the counter for starting feeding stop. Upon completion of the processing of Step P155, the CPU 33 executes Step P156.

In Step P156, the CPU 33 outputs the set value C2m of the counter 65 for resetting the counter for starting feeding stop to the counter 65 for resetting the counter for starting feeding stop. Upon completion of the processing of Step P156, the CPU 33 executes Step P150. Accordingly, the counter 64 for starting feeding stop and the counter 65 for resetting the counter for starting feeding stop are set. By this setting, the feeding operation of the ductor roller 114 is stopped and restarted in the following manner. Specifically, the count of the counter 64 for starting feeding stop is incremented upon reception of a first pulse transmitted from the sensor 63 for detecting the rotation of the ink ductor cam in accordance with the rotation of the cam 77, which swings the ductor roller 114 with the rotation of the printing press. The counter 64 then outputs a signal to a set terminal of the flip-flop circuit 66 to set the flip-flop circuit 66. The flip-flop circuit 66 thus outputs a signal to turn ON the valve 67 for the feeding stop air cylinder. Consequently, the feeding stop air cylinder 68 is activated, so that the feeding operation of the ductor roller 114 is stopped. After that, the count of the counter 65 for resetting the counter for starting feeding stop is incremented upon reception of a C2m-th, that is, (C1m+1)-th pulse transmitted from the sensor 63 for detecting the rotation of the ink ductor cam in accordance with the subsequent rotation of the printing press, where C2m is the set value of the counter 65 for resetting the counter for starting feeding stop, and C1m is the number of feeding stops. The counter 65 for resetting the counter for starting feeding stop then outputs a signal to a reset terminal of the flip-flop circuit 66 to reset the flip-flop circuit 66. With this signal, the flip-flop circuit 66 stops the output to the valve 67 for the feeding stop air cylinder, turning OFF the valve 67 for the feeding stop air cylinder. Consequently, the operation of the feeding stop air cylinder 68 is stopped, so that the feeding operation of the ductor roller 114 is restarted. Accordingly, the ductor roller 114 performs the feeding operation once after stopping the feeding operation for C1m times, where C1m is the number of feeding stops, and thereafter repeats this operation.

### Third Embodiment

Firstly, descriptions will be given of the device configuration of an ink feed control system according to a third embodiment of the present invention. FIG. 2 shows a side view of principal parts of an inking device of a printing press according to the third embodiment of the present invention. In FIG. 2, the same reference numerals denote components that are the same as, or similar to, those described in the above-mentioned conventional technique shown in FIG. 48, and detailed descriptions of the same components will be omitted. In addition, in the third embodiment of the present invention as well, the basic driving of the ink feed mechanism is performed by using a cam 77 and the like, that is, the same as that in the first embodiment, and thus descriptions thereof will be omitted. The cam 77 is driven by a drive motor of the printing press. A ductor roller 114 and a ductor shaft 72, which serves as a swing fulcrum for swinging the ductor roller 114, are pivotally supported by left and right frames (not illustrated) so as to be rotatable, between an ink fountain roller 108 and an distribution roller 113. The ink fountain roller 108 is provided as a roller on the upstream side in the ink transfer direction, while the distribution roller 113 is provided as a roller on the downstream side in the ink transfer direction. One of the shaft ends of the ductor shaft 72 protrudes from the frame, and a cam lever 73 is provided to the protruding portion of the ductor shaft 72. The ink fountain roller 108 is driven by a motor 49 for driving the ink fountain roller 108. The motor 49 for driving the ink fountain roller is controlled by a motor driver 48 for driving the ink fountain roller 108.

A pair of left and right swing levers 81 are pivotally mounted on the ductor shaft 72 inside the frames, while the ductor roller 114 is pivotally supported, at the two end shafts 114a, by the swing levers 81 so as to be rotatable. A feeding stop air cylinder 68 is provided on a side of the end portion of the swing levers 81. The feeding stop air cylinder 68 is configured to extend so as to stop the feeding of ink. The feeding stop air cylinder 68 is normally in a state where the feeding stop air cylinder 68 is not in contact with the swing levers 81. Only when the feeding stop air cylinder 68 is activated, the front end of a piston thereof presses the swing levers 81 as indicated by the dashed line in FIG. 2. The feeding stop air cylinder 68 is controlled by an ink feeding number control device 2, which is to be described later. On the other hand, the rotation of a drive motor is transmitted to the distribution roller 113, so that the distribution roller 113 reciprocates once in the axial direction as the plate cylinder 101 (see FIG. 48) rotates twice.

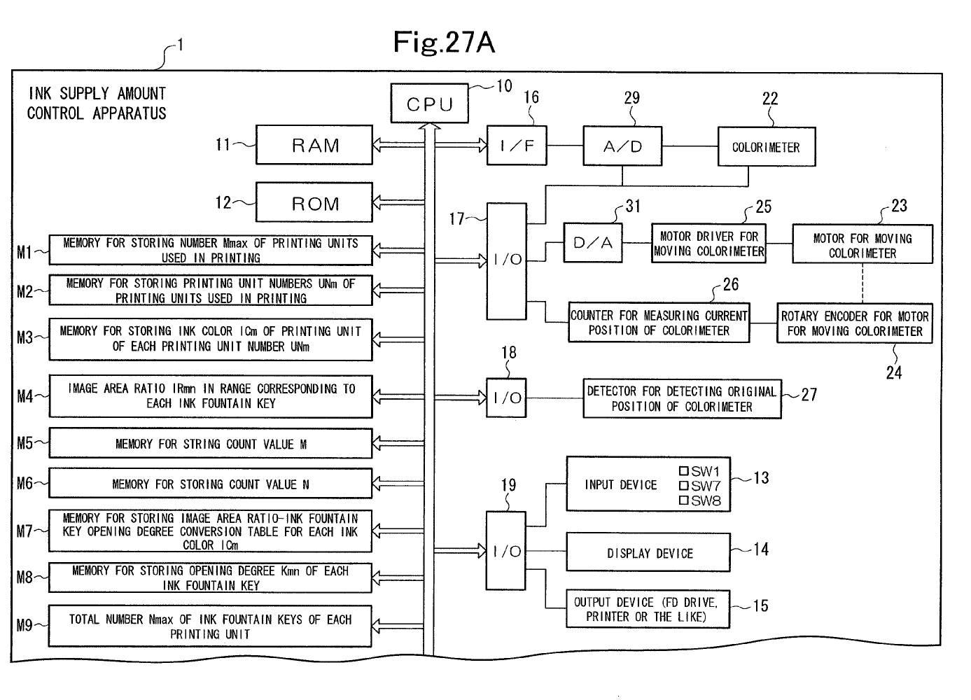

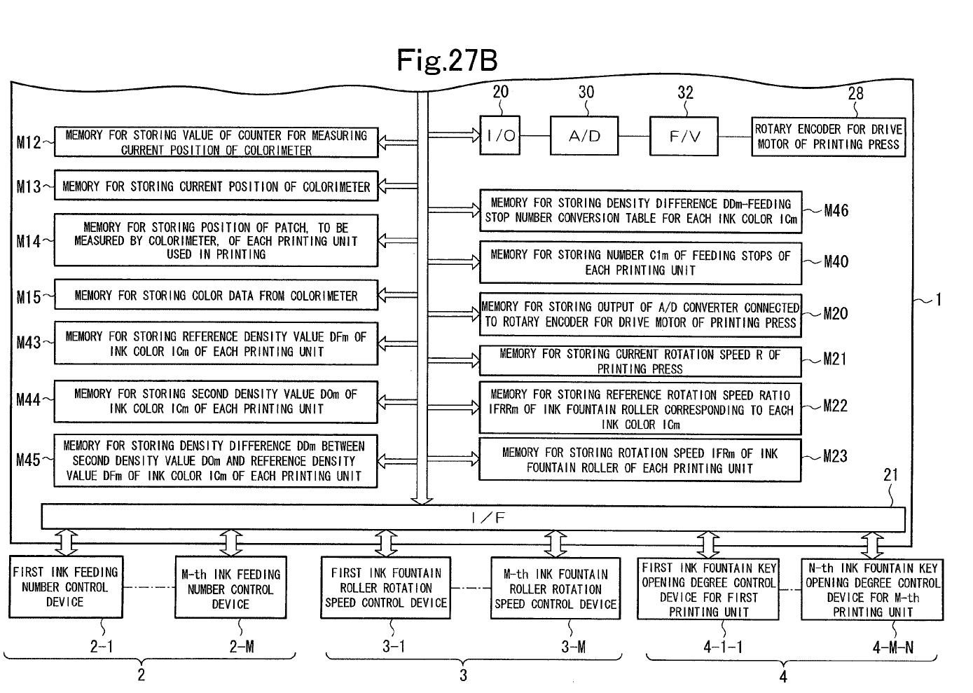

Next, an ink supply amount control apparatus according to the third embodiment of the present invention will be described. FIGS. 27A and 27B show hardware block diagrams of the ink supply amount control apparatus according to the third embodiment of the present invention. As shown in FIGS. 27A and 27B, the ink supply amount control apparatus 1 includes a CPU 10, a RAM 11, a ROM 12, an input device 13, a display device 14, an output device 15, input/output interfaces (I/O, I/F) 16 to 21, a colorimeter 22, a motor 23 for moving the colorimeter, a rotary encoder 24 for the motor for moving the colorimeter, a motor driver 25 for moving the calorimeter, a counter 26 for measuring the current position of the calorimeter, a detector 27 for detecting the original position of the calorimeter, a rotary encoder 28 for the drive motor of the printing press, A/D converters 29 and 30, a D/A converter 31, an F/V converter 32, and memories M1 to M9, M12 to M15, M20 to M23, M40, and M43 to M46.

The CPU 10 obtains various kinds of information which are inputted thereto through the interfaces 16 to 21, and operates in accordance with a program stored in the ROM 12, while accessing the RAM 11, the memories M1 to M9, M12 to M15, M20 to M23, M40, and M43 to M46. The input device 13 is provided with an ink preset switch SW1, a reference-density-value measuring switch SW7, a second-density-value measuring switch SW8 and the like. The motor driver 25 for moving the calorimeter controls the motor 23 for moving the calorimeter. The rotary encoder 24 for the motor for moving the calorimeter generates one rotation pulse for every predetermined number of rotations (angle) of the motor 23 for moving the calorimeter, and then outputs the rotation pulse to the counter 26 for measuring the current position of the calorimeter. The rotary encoder 28 for the drive motor of the printing press generates one rotation pulse for every predetermined number of rotations (angle) of the drive motor, and then outputs the rotation pulse to the input/output interface 20. Note that, the calorimeter 22 according to the third embodiment of the present invention is the same as that of the first embodiment, and hence descriptions thereof will be omitted.

In the ink supply amount control apparatus 1, in the memory M1, the number Mmax of printing units used in the printing is stored. In the memory M2, the printing unit number UNm of each printing unit used in the printing is stored. In the memory M3, the ink color ICm of the printing unit of each printing unit number UNm is stored.

In the memory M4, the image area ratio IRmn of a range corresponding to each ink fountain key is stored. In the memory M5, a count value M is stored. In the memory M6, a count value N is stored. In the memory M7, an image area ratio-ink fountain key opening degree conversion table for each ink color ICm is stored.

In the memory M8, the opening degree Kmn of each ink fountain key is stored. In the memory M9, the total number Nmax of ink fountain keys of each printing unit is stored.

In the memory M12, a value of the counter for measuring the current position of the calorimeter is stored. In the memory M13, the current position of the calorimeter is stored. In the memory M14, the position of each patch, which is to be measured by the colorimeter, of each printing unit used in the printing is stored.

In the memory M15, color data from the calorimeter is stored. In the memory M20, an output of the A/D converter connected to the rotary encoder 28 for the drive motor of the printing press is stored. In the memory M21, the current rotation speed R of the printing press is stored. In the memory M22, the reference rotation speed ratio IFRRm of the ink fountain roller corresponding to each ink color ICm is stored.

In the memory M23, the rotation speed IFRm of the ink fountain roller of each printing unit is stored. In the memory M40, the number C1m of feeding stops of each printing unit is stored. In the memory M43, a reference density value DFm of the ink color ICm of each printing unit is stored.

In the memory M44, a second density value DOm of the ink color ICm of each printing unit is stored. In the memory M45, a density difference DDm between the second density value DOm and the reference density value DFm of the ink color ICm of each printing unit is stored. In the memory M46, a conversion table between a density difference DDm of each ink color ICm and the number of feeding stops (hereinafter, referred to as a density difference DDm-feeding stop number conversion table for each ink color ICm) is stored.

An ink feeding number control device 2, an ink fountain roller rotation speed control device 3 and an ink fountain key opening degree control device 4 are connected to the ink supply amount control apparatus 1 through the interface 21. The ink feeding number control device 2 controls the number of feedings of each ink. The ink fountain roller rotation speed control device 3 controls the rotation amount of each ink fountain roller. The ink fountain key opening degree control device 4 controls the opening degree of each of the ink fountain keys 109-1 to 109-N of each color.

The ink feeding number control device 2 includes first to M-th ink feeding number control devices 2-1 to 2-M. The ink fountain roller rotation speed control device 3 includes first to M-th ink fountain roller rotation speed control devices 3-1 to 3-M. The ink fountain key opening degree control device 4 includes a first ink fountain key opening degree control device for first printing unit 4-1-1 to an N-th ink fountain key opening degree control device for M-th printing unit 4-M-N.

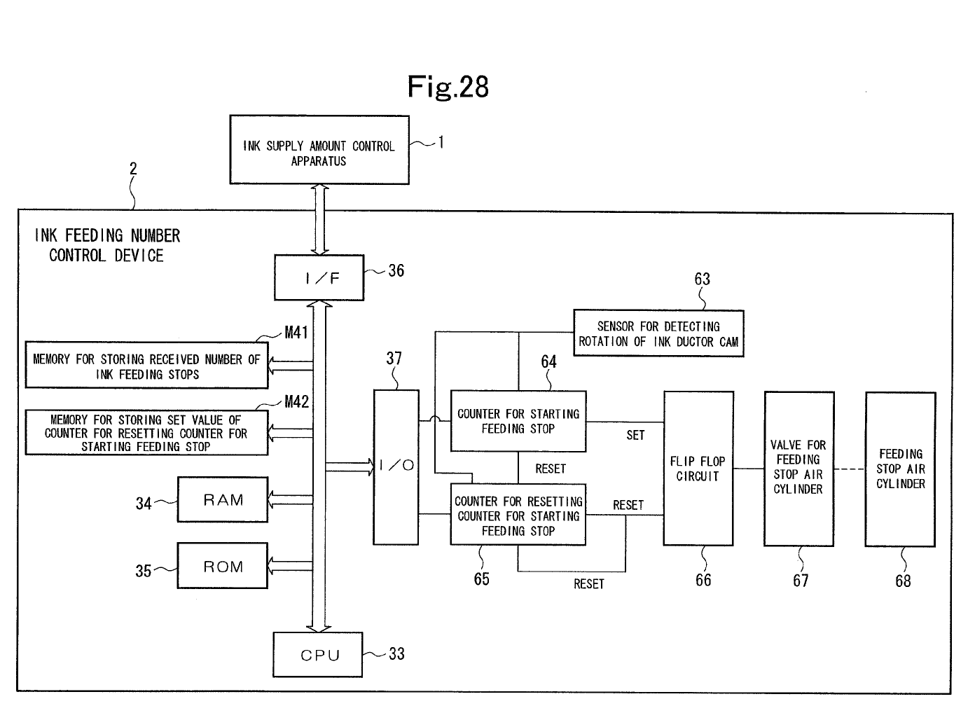

Next, the ink feeding number control device (ink ductor roller swing means) according to the third embodiment of the present invention will be described. FIG. 28 shows a hardware block diagram of the ink feeding number control device according to the third embodiment of the present invention. As shown in FIG. 28, the ink feeding number control device 2 includes a CPU 33, a RAM 34, a ROM 35, input/output interfaces (I/O, I/F) 36 and 37, a sensor 63 for detecting the rotation of an ink ductor cam, a counter 64 for starting feeding stop, a counter 65 for resetting the counter for starting feeding stop, a flip-flop circuit 66, a valve 67 for the feeding stop air cylinder, the feeding stop air cylinder 68 (the ink ductor roller stop means), and memories M41 and M42.

The CPU 33 obtains various kinds of information which are inputted thereto through the interfaces 36 and 37, and operates in accordance with a program stored in the ROM 35, while accessing the RAM 34 as well as the memories M41 and 42. From the sensor 63 for detecting the rotation of the cam, a pulse is transmitted to the counter 64 for starting feeding stop, and to the counter 65 for resetting the counter for starting feeding stop, for every one rotation of the cam. The counter 64 for starting feeding stop transmits a set signal to the flip-flop circuit 66, in accordance with a predetermined number of pulses, that is, a predetermined number of rotations of the ink ductor cam, which is set in advance with the input/output interface 37. With this set signal, the valve 67 for the feeding stop air cylinder is operated to extend the feeding stop air cylinder 68, so that the ductor roller 114 is stopped. On the other hand, the counter 65 for resetting the counter for starting feeding stop transmits reset signals respectively to the flip-flop circuit 66, the counter 64 for starting feeding stop, and the counter 65 for resetting the counter for starting feeding stop itself, in accordance with a predetermined number of pulses, that is, a predetermined number of rotations of the cam, which is set in advance with the input/output interface 37. With the reset signals, the valve 67 for the feeding stop air cylinder is operated to contract the feeding stop air cylinder 68, so that the ductor roller 114 is activated again.

In the ink feeding number control device 2, in the memory M41, a received number C1m of ink feeding stops is stored. In the memory M42, a set value C2m of the counter 65 for resetting the counter for starting feeding stop is stored.

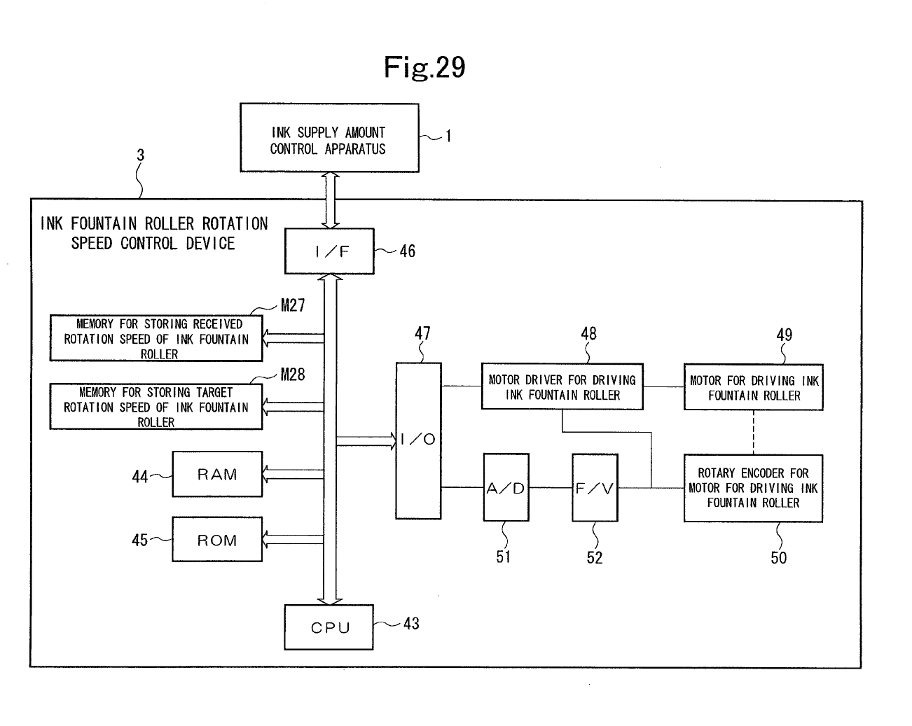

Next, an ink fountain roller rotation speed control device according to the third embodiment of the present invention will be described. FIG. 29 shows a hardware block diagram of the ink fountain roller rotation speed control device according to the third embodiment of the present invention. As shown in FIG. 29, the ink fountain roller rotation speed control device 3 includes a CPU 43, a RAM 44, a ROM 45, input/output interfaces (I/O, I/F) 46 and 47, a motor driver 48 for driving the ink fountain roller, a motor 49 for driving the ink fountain roller, a rotary encoder 50 for the motor for driving the ink fountain roller, an A/D converter 51, an F/V converter 52, and memories M27 and M28.

The CPU 43 obtains various kinds of information which are inputted thereto through the interfaces 46 and 47, and operates in accordance with a program stored in the ROM 45, while accessing the RAM 44 as well as the memories M27 and M28. The motor driver 48 for driving the ink fountain roller controls the motor 49 for driving the ink fountain roller. The rotary encoder 50 for the motor for driving the ink fountain roller generates one rotation pulse for every predetermined number of rotations (angle) of the motor 49 for driving the ink fountain roller, and then outputs the rotation pulse to the input/output interface 47.

In the ink fountain roller rotation speed control device 3, in the memory M27, a received rotation speed of the ink fountain roller is stored. In the memory M28, a target rotation speed of the ink fountain roller is stored.

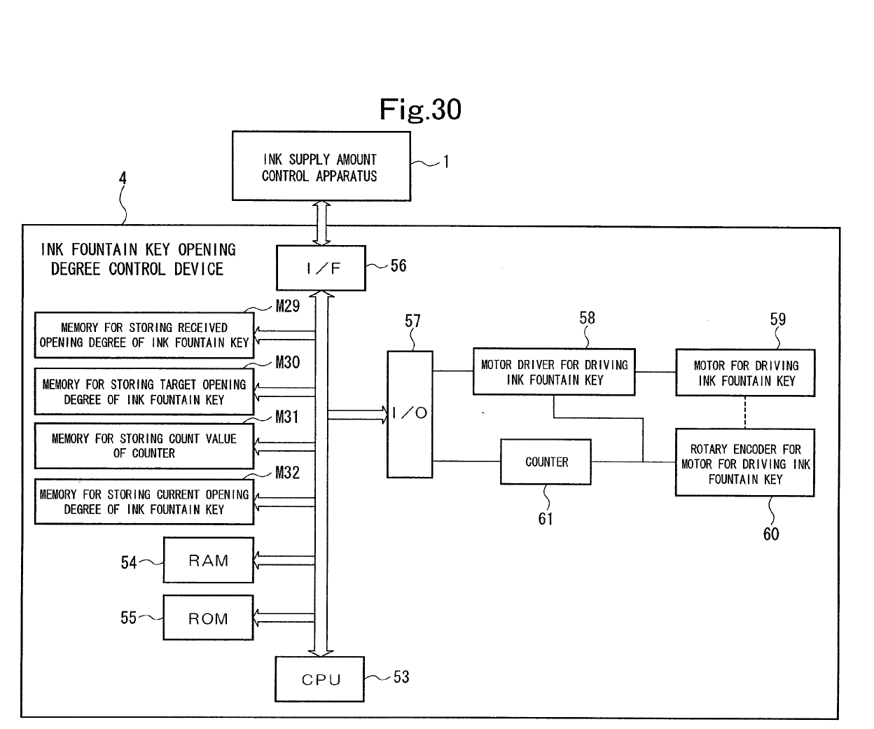

Next, the ink fountain key opening degree control device according to the third embodiment of the present invention will be described. FIG. 30 shows a hardware block diagram of the ink fountain key opening degree control device according to the third embodiment of the present invention. As shown in FIG. 30, the ink fountain key opening degree control device 4 includes a CPU 53, a RAM 54, a ROM 55, input/output interfaces (I/O, I/F) 56 and 57, a motor driver 58 for driving the ink fountain key, a motor 59 for driving the ink fountain key, a rotary encoder 60 for the motor for driving the ink fountain key, a counter 61, and memories M29 to M32.

The CPU 53 obtains various kinds of information which are inputted thereto through the interfaces 56 and 57, and operates in accordance with a program stored in the ROM 55, while accessing the RAM 54 as well as the memories M29 to M32.

In the ink fountain key opening degree control device 4, in the memory M29, a received opening degree of the ink fountain key 109 is stored. In the memory M30, a target opening degree of the ink fountain key 109 is stored. In the memory M31, a count value of the counter 61 is stored. In the memory M32, the current opening degree of the ink fountain key 109 is stored.

Note that, in FIG. 27B, the ink fountain key opening degree control devices 4-1-1 to 4-M-N are the ink fountain key opening degree control devices 4 provided for the respective ink fountain keys 109 (109-1 to 109-N) of the corresponding colors, which are shown in FIG. 48. With the ink fountain key opening degree control devices 4-1-1 to 4-M-N, the opening degrees of the ink fountain keys 109-1 to 109-N of each color are individually adjusted with respect to the corresponding ink fountain roller 108.

The ink fountain key opening degree control device 4 includes the motor driver 58 for driving the ink fountain key, the motor 59 for driving the ink fountain key, the rotary encoder 60 for the motor for driving the ink fountain key, and the counter 61. The ink fountain key opening degree control device 4 is connected to the CPU 10 of the ink supply amount control apparatus 1 through the interface 56. The rotary encoder 60 for the motor for driving the ink fountain key generates one rotation pulse for every predetermined number of rotations (angle) of the motor 59 for driving the ink fountain key, and then outputs the rotation pulse to the counter 61.

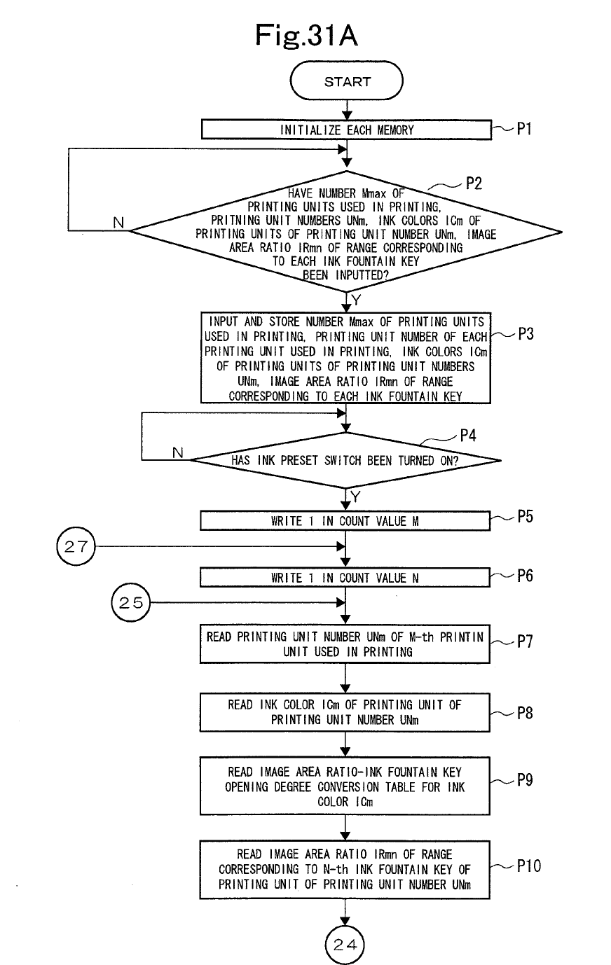

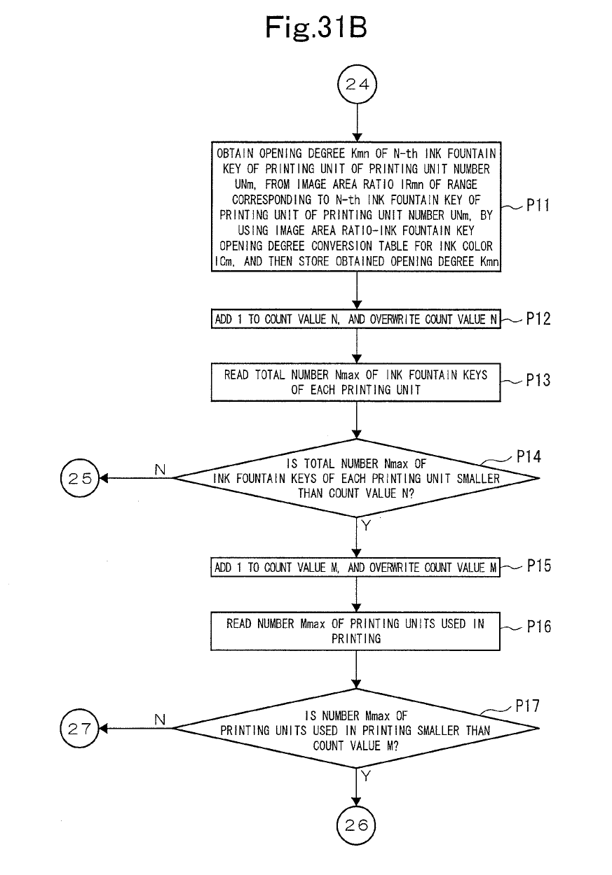

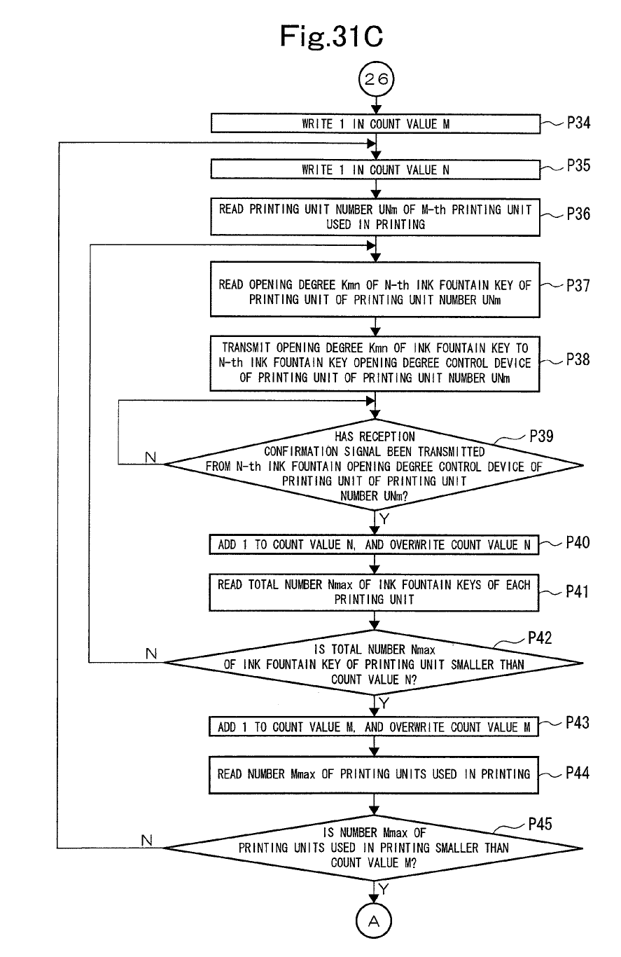

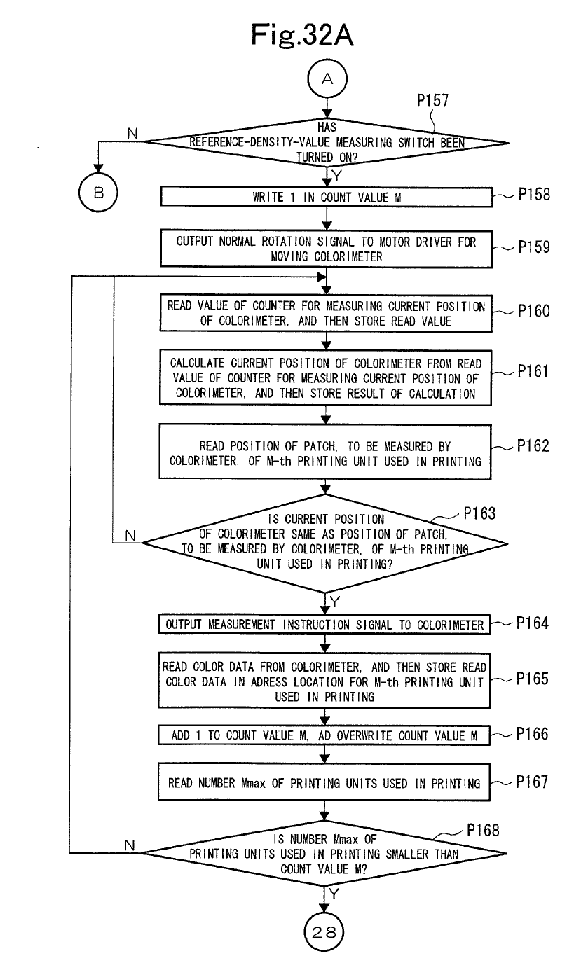

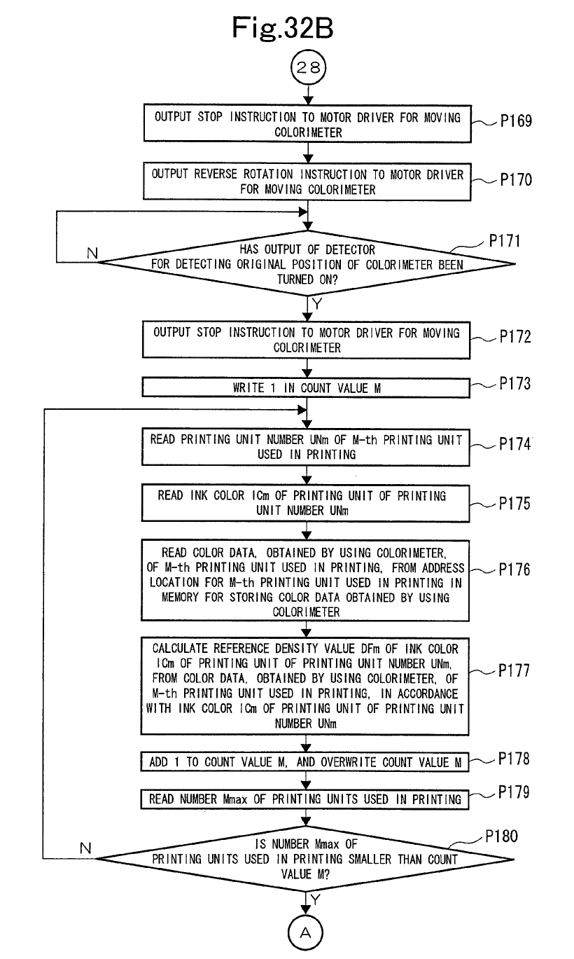

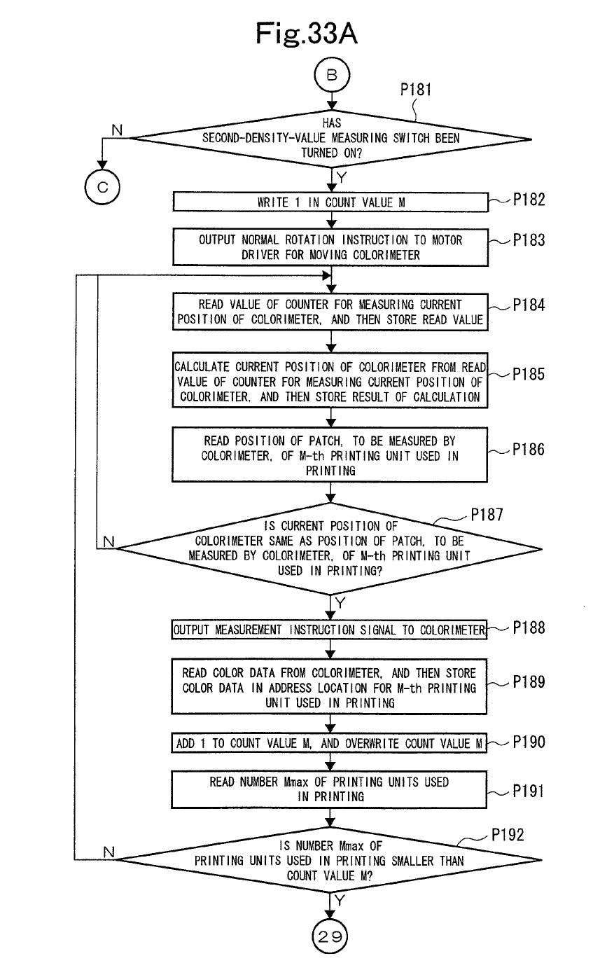

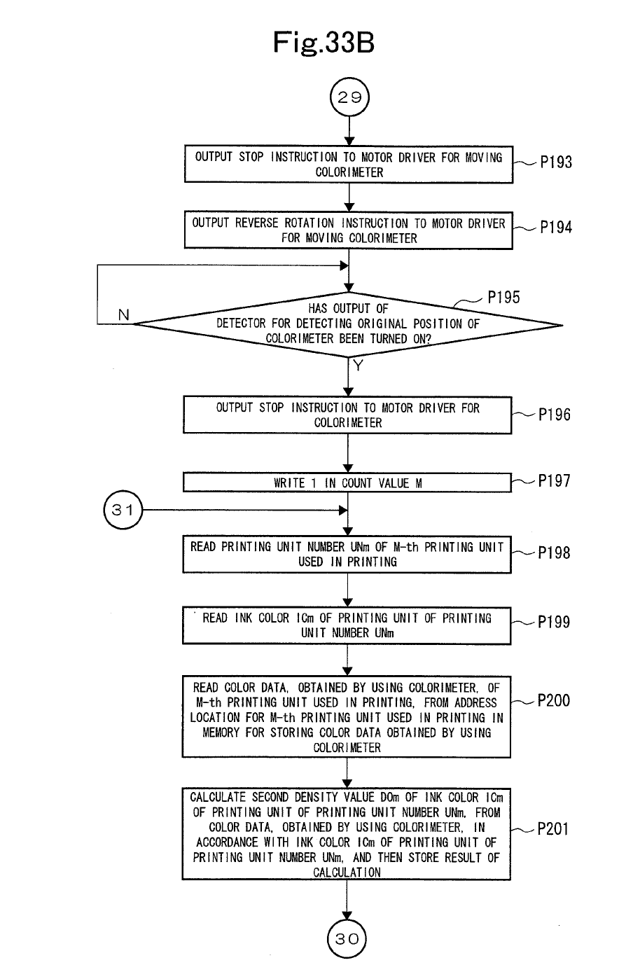

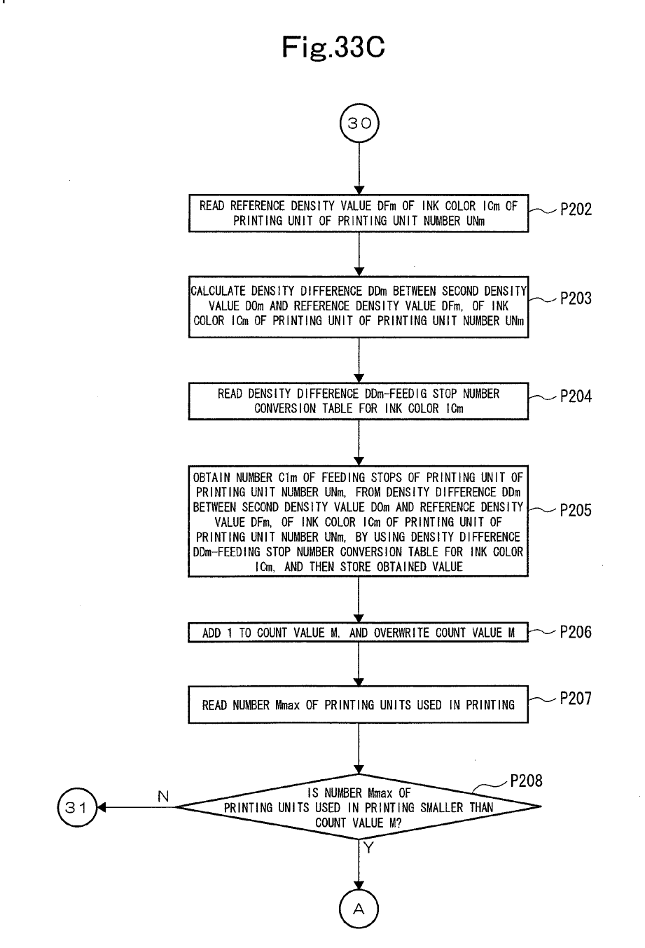

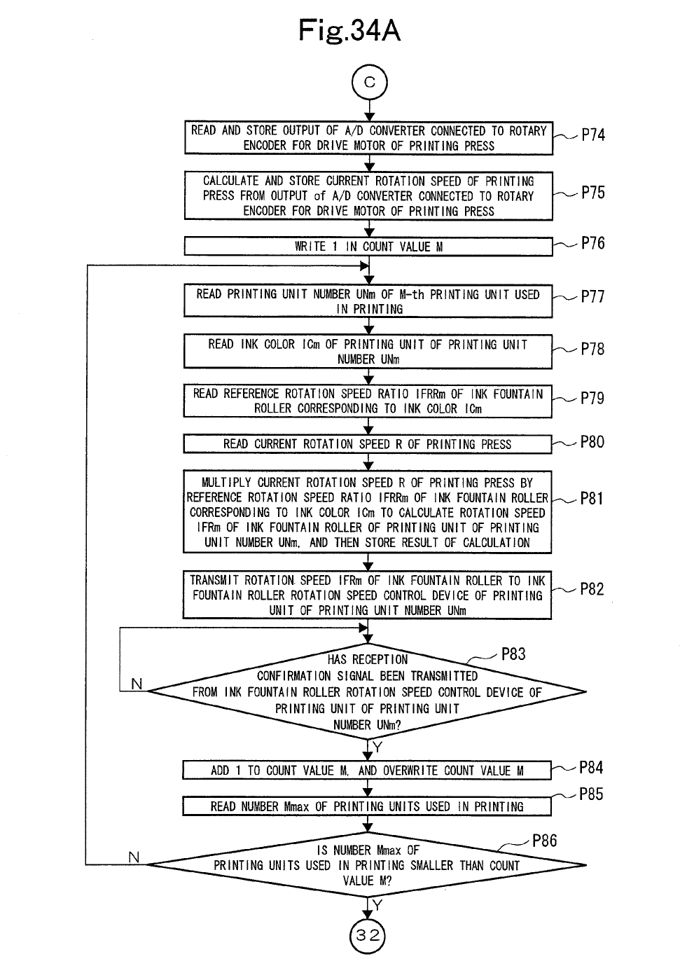

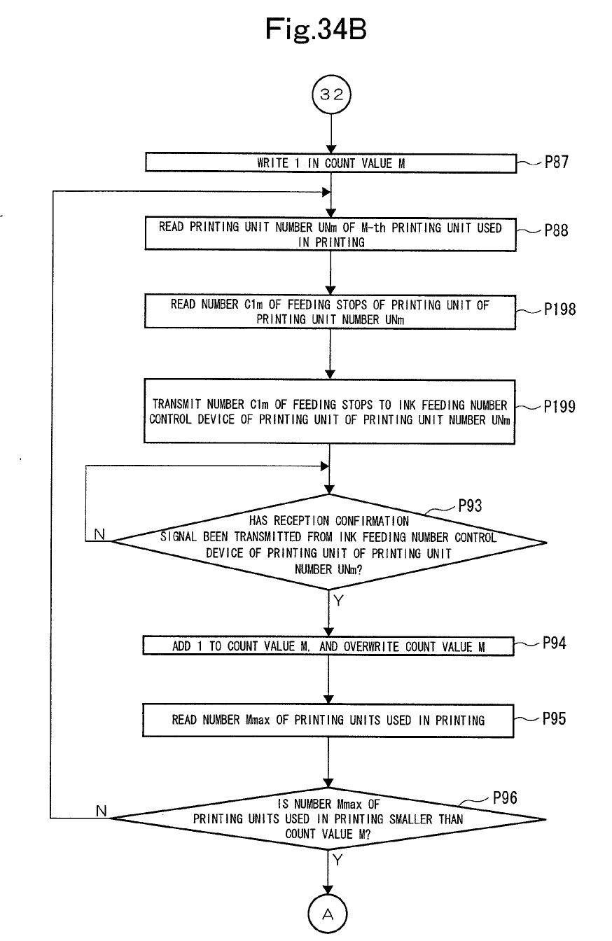

Next the operation of the ink supply amount control apparatus according to the third embodiment of the present invention will be described. Each of FIGS. 31A to 31C, 32A, 32B, 33A to 33C, and 34A and 34B shows an operational flowchart of the ink supply amount control apparatus according to the third embodiment of the present invention. Hereinafter, the content of the processing of each step will be described.

In Step P1, the CPU 10 initializes each memory. Upon completion of the processing of Step P1, the CPU 10 executes Step P2.

In Step P2, the CPU 10 determines whether or not the operator has inputted the number Mmax of printing units used in the printing, printing unit numbers UNm, ink colors ICm of the printing units of the printing unit numbers UNm, and an image area ratio IRmn of a range corresponding to each ink fountain key.

When the operator has inputted the number Mmax of printing units used in the printing, the printing unit numbers UNm, the ink colors ICm of the printing units of the printing unit numbers UNm, and the image area ratio IRmn of the range corresponding to each ink fountain key, the CPU 10 executes Step P3.

On the other hand, when the operator has not inputted the number Mmax of printing units used in the printing, the printing unit numbers UNm, the ink colors ICm of the printing units of printing unit numbers UNm, and the image area ratio IRmn of the range corresponding to each ink fountain key, the CPU 10 executes Step P2 again.

In Step P3, the CPU 10 inputs to store, the number Mmax of printing units used in the printing, the printing unit number UNm of each printing unit used in the printing, the ink colors ICm of the printing units of printing unit numbers UNm, and the image area ratio IRmn of the range corresponding to each ink fountain key, respectively in the memories M1, M2, M3, and M4. Upon completion of the processing of Step P3, the CPU 10 executes Step P4.

In Step P4, the CPU 10 determines whether or not the ink preset switch SW1 has been turned ON by the operator. When the ink preset switch SW1 has been turned ON, the CPU 10 executes Step P5. On the other hand, when the ink preset switch SW1 has not been turned ON, the CPU 10 executes Step P4 again.

In Step P5, the CPU 10 writes 1 in the count value M, that is, the CPU 10 stores 1 in the memory M5. Upon completion of the processing of Step P5, the CPU 10 executes Step P6.

In Step P6, the CPU 10 writes 1 in the count value N, that is, the CPU 10 stores 1 in the memory M6. Upon completion of the processing of Step P6, the CPU10 executes Step P7.

In Step P7, the CPU 10 reads, from the memory M2, the printing unit number UNm of the M-th printing unit used in the printing. Upon completion of the processing of Step P7, the CPU 10 executes Step P8.

In Step P8, the CPU reads, from the memory M3, the ink color ICm of the printing unit of the printing unit number UNm. Upon completion of the processing of Step P8, the CPU 10 executes Step P9.

In Step P9, the CPU 10 reads, from the memory M7, the image area ratio-ink fountain key opening degree conversion table for the ink color ICm. Upon completion of the processing of Step P9, the CPU 10 executes Step P10.

In Step P10, the CPU 10 reads, from the memory M4, the image area ratio IRmn of the range corresponding to the N-th ink fountain key of the printing unit of the printing unit number UNm. Upon completion of the processing of Step P10, the CPU 10 executes Step P11.

In Step P11, the CPU 10 obtains the opening degree Kmn of the N-th ink fountain key of the printing unit of the printing unit number UNm, from the image area ratio IRmn of the range corresponding to the N-th ink fountain key of the printing unit of the printing unit number UNm, by using the image area ratio-ink fountain key opening degree conversion table for the ink color ICm. Then, the CPU 10 stores the obtained opening degree Kmn in the memory M8. Upon completion of the processing of Step P11, the CPU 10 executes Step P12.

In Step P12, the CPU 10 adds 1 to the count value N stored in the memory M6, and then overwrites the count value N. Upon completion of the processing of Step P12, the CPU 10 executes Step P13.

In Step P13, the CPU 10 reads, from the memory M9, the total number Nmax of ink fountain keys of each printing unit. Upon completion of the processing of Step P13, the CPU 10 executes Step P14.

In Step P14, the CPU 10 determines whether or not the total number Nmax of ink fountain keys of each printing unit, which is stored in the memory M9, is smaller than the count value N, which is stored in the memory M6. When the total number Nmax of ink fountain keys of each printing unit is smaller than the count value N, the CPU 10 executes Step P15. On the other hand, when the total number Nmax of ink fountain keys of each printing unit is larger than, or is equal to, the count value N, the CPU 10 executes Step P7. With this loop, the CPU 10 obtains the opening degree K1n of each ink fountain key of the printing unit of the first color.

In Step P15, the CPU 10 adds 1 to the count value M stored in the memory M5, and then overwrites the count value M. Upon completion of the processing of Step P15, the CPU 10 executes Step P16.

In Step P16, the CPU 10 reads, from the memory M1, the number Mmax of printing units used in the printing. Upon completion of the processing of Step P16, the CPU 10 executes Step P17.

In Step P17, the CPU 10 determines whether or not the number Mmax of printing units used in the printing, which is stored in the memory M1, is smaller than the count value M, which is stored in the memory M5. When the number Mmax of printing units used in the printing is smaller than the count value M, the CPU 10 executes Step P34. On the other hand, when the number Mmax of printing units used in the printing is larger than, or is equal to, the count value M, the CPU 10 executes Step P6. With this loop, the CPU 10 obtains the opening degree Kmn of each ink fountain key of the printing unit of each of the first to M-th colors.

In Step P34, the CPU 10 writes 1 in the count value M, that is, the CPU 10 stores 1 in the memory M5. Upon completion of the processing of Step P34, the CPU 10 executes Step P35.

In Step P35, the CPU 10 writes 1 in the count value N, that is, the CPU 10 stores 1 in the memory M6. Upon completion of the processing of Step P35, the CPU 10 executes Step P36.

In Step P36, the CPU 10 reads, from the memory M2, the printing unit number UNm of the M-th printing unit used in the printing. Upon completion of the processing of Step P36, the CPU 10 executes Step P37.

In Step P37, the CPU 10 reads, from the memory M8, the opening degree Kmn of the N-th ink fountain key of the printing unit of the printing unit number UNm. Upon completion of the processing of Step P37, the CPU 10 executes Step P38.

In Step P38, the CPU 10 transmits the opening degree Kmn of the N-th ink fountain key to the N-th ink fountain key opening degree control device 4 of the printing unit of the printing unit number UNm. Upon completion of the processing of Step P38, the CPU 10 executes Step P39.

In Step P39, the CPU 10 determines whether or not a reception confirmation signal has been transmitted from the N-th ink fountain key opening degree control device 4 of the printing unit of the printing unit number UNm. When the reception confirmation signal has been transmitted from the N-th ink fountain key opening degree control device 4 of the printing unit of the printing unit number UNm, the CPU 10 executes Step P40. On the other hand, when the reception confirmation signal has not been transmitted from the N-th ink fountain key opening degree control device 4 of the printing unit of the printing unit number UNm, the CPU 10 executes Step P39 again.

In Step P40, the CPU 10 adds 1 to the count value N stored in the memory M6, and then overwrites the count value N. Upon completion of the processing of Step P40, the CPU 10 executes Step P41.

In Step P41, the CPU 10 reads, from the memory M9, the total number Nmax of ink fountain keys of each printing unit. Upon completion of the processing of Step P41, the CPU 10 executes Step P42.

In Step P42, the CPU 10 determines whether or not the total number Nmax of ink fountain keys of the printing unit, which is stored in the memory M9, is smaller than the count value N, which is stored in the memory M6. When the total number Nmax of ink fountain keys of the printing unit is smaller than the count value N, the CPU 10 executes Step P43. On the other hand, when the total number Nmax of ink fountain keys of the printing unit is larger than, or is equal to, the count value N, the CPU 10 executes Step P37. With this loop, the CPU 10 transmits the opening degree K1n of each ink fountain key to the corresponding ink fountain key opening degree control device 4-1-N of the printing unit of the first color.

In Step P43, the CPU 10 adds 1 to the count value M stored in the memory M5, and then overwrites the count value M. Upon completion of the processing of Step P43, the CPU 10 executes Step P44.

In Step P44, the CPU 10 reads, from the memory M1, the number Mmax of printing units used in the printing. Upon completion of the processing of Step P44, the CPU 10 executes Step P45.

In Step P45, the CPU 10 determines whether or not the number Mmax of printing units used in the printing, which is stored in the memory M1, is smaller than the count value M, which is stored in the memory M5. When the number Mmax of printing units used in the printing is smaller than the count value M, the CPU 10 executes Step P157. On the other hand, when the number Mmax of printing units used in the printing is larger than, or is equal to, the count value M, the CPU 10 executes Step P35. With this loop, the CPU 10 transmits the opening degree Kmn of each ink fountain key to the corresponding ink fountain key opening degree control device 4-M-N of the printing unit of each of the first to M-th colors.

In Step P157, the CPU 10 determines whether or not the reference-density-value measuring switch SW7 has been turned ON by the operator. When the reference-density-value measuring switch SW7 has been turned ON, the CPU 10 executes Step P158. On the other hand, when the reference-density-value measuring switch SW7 has not been turned ON, the CPU 10 executes Step P181.

In Step P158, the CPU 10 writes 1 in the count value M, that is, the CPU 10 stores 1 in the memory M5. Upon completion of the processing of Step P158, the CPU 10 executes Step P159.

In Step P159, the CPU 10 outputs a normal rotation instruction to the motor driver 25 for moving the calorimeter. Upon completion of the processing of Step P159, the CPU 10 executes Step P160.

In Step P160, the CPU 10 reads the value of the counter 26 for measuring the current position of the calorimeter 22, and then stores the read value in the memory M12. Upon completion of the processing of Step P160, the CPU 10 executes Step P161.

In Step P161, the CPU 10 calculates the current position of the calorimeter 22 from the read value of the counter 26 for measuring the current position of the calorimeter 22, and then stores the result of the calculation in the memory M13. Upon completion of the processing of Step P161, the CPU 10 executes Step P162.

In Step P162, the CPU 10 reads, from the memory M14, the position of the patch, which is to be measured by the colorimeter 22, of the M-th printing unit used in the printing. Upon completion of the processing of Step P162, the CPU 10 executes Step P163.

In Step P163, the CPU 10 determines whether or not the current position of the colorimeter 22 is the same as the position of the patch, which is to be measured by the calorimeter 22, of the M-th printing unit used in the printing. When the current position of the colorimeter 22 is the same as the position of the patch, which is to be measured by the calorimeter 22, of the M-th printing unit used in the printing, the CPU 10 executes Step P164. On the other hand, when the current position of the colorimeter 22 is different from the position of the patch, which is to be measured by the calorimeter 22, of the M-th printing unit used in the printing, the CPU 10 executes Step P160.

In Step P164, the CPU 10 outputs a measurement instruction signal to the colorimeter 22. Upon completion of the processing of Step P164, the CPU 10 executes Step P165.

In Step P165, the CPU 10 reads color data from the calorimeter 22, which data is a digital value obtained by the conversion of the A/D converter 29, and then stores the color data in an address location, for the M-th printing unit used in the printing, in the memory M15. Upon completion of the processing of Step P165, the CPU 10 executes Step P166.

In Step P166, the CPU 10 adds 1 to the count value M stored in the memory M5, and then overwrites the count value M. Upon completion of the processing of Step P166, the CPU 10 executes Step P167.

In Step P167, the CPU 10 reads, from the memory M1, the number Mmax of printing units used in the printing. Upon completion of the processing of Step P167, the CPU 10 executes Step P168.

In Step P168, the CPU 10 determines whether or not the number Mmax of printing units used in the printing, which is stored in the memory M1, is smaller than the count value M, which is stored in the memory M5. When the number Mmax of printing units used in the printing is smaller than the count value M, the CPU 10 executes Step P169. On the other hand, when the number Mmax of printing units used in the printing is larger than, or is equal to, the count value M, the CPU 10 executes Step P160. With this loop, the CPU 10 measures the color data of the patch printed by each printing unit, and then stores the measured color data in the memory M15. Note that, in this case, the position of the patch printed by each printing unit is supposed to be located in a manner that the patches are printed respectively by the first, the second, . . . , and the M-th printing units in this order from a position closest to the original position of the motor 23 for moving the calorimeter.

In Step P169, the CPU 10 outputs a stop instruction to the motor driver 25 for moving the calorimeter. Upon completion of the processing of Step P169, the CPU 10 executes Step P170.

In Step P170, the CPU outputs a reverse rotation instruction to the motor driver 25 for moving the calorimeter. Upon completion of the processing of Step P170, the CPU 10 executes Step P171.

In Step P171, the CPU 10 determines whether or not the output of the detector 27 for detecting the original position of the calorimeter has been turned ON. When the output of the detector 27 for detecting the original position of the calorimeter has been turned ON, the CPU 10 executes Step P172. On the other hand, when the output of the detector 27 for detecting the original position of the calorimeter has not been turned ON, the CPU 10 executes Step P171 again.

In Step P172, the CPU 10 outputs a stop instruction to the motor driver 25 for moving the calorimeter. Upon completion of the processing of Step P172, the CPU 10 executes Step P173.

In Step P173, the CPU 10 writes 1 in the count value M, that is, the CPU 10 stores 1 in the memory M5. Upon completion of the processing of Step P173, the CPU 10 executes Step P174.

In Step P174, the CPU 10 reads, from the memory M2, the printing unit number UNm of the M-th printing unit used in the printing. Upon completion of the processing of Step P174, the CPU 10 executes Step P175.

In Step P175, the CPU 10 reads, from the memory M3, the ink color ICm of the printing unit of the printing unit number UNm. Upon completion of the processing of Step P175, the CPU 10 executes Step P176.

In Step P176, the CPU 10 reads the color data, measured by the calorimeter 22, of the M-th printing unit used in the printing, from the address location, for the M-th printing unit used in the printing, in the memory M15 for storing the color data from the calorimeter 22. Upon completion of the processing of Step P176, the CPU 10 executes Step P177.

In Step P177, the CPU 10 calculates a reference density value DFm of the ink color ICm of the printing unit of the printing unit number UNm, from the color data, measured by the calorimeter 22, of the M-th printing unit used in the printing, in accordance with the ink color ICm of the printing unit of the printing unit number UNm. The CPU 10 then stores the result of the calculation in the memory M 43. Upon completion of the processing of Step P177, the CPU 10 executes Step P178.

In Step P178, the CPU 10 adds 1 to the count value M stored in the memory M5, and then overwrites the count value M. Upon completion of the processing of Step P178, the CPU 10 executes Step P179.

In Step P179, the CPU 10 reads the number Mmax of printing units used in the printing. Upon completion of the processing of Step P179, the CPU 10 executes Step P180.

In Step P180, the CPU 10 determines whether or not the number Mmax of printing units used in the printing, which is stored in the memory M1, is smaller than the count value M, which is stored in the memory M5. When the number Mmax of printing units used in the printing is smaller than the count value M, the CPU 10 executes Step P181 via Step P157. On the other hand, when the number Mmax of printing units used in the printing is larger than, or is equal to, the count value M, the CPU 10 executes Step P174. With this loop, the CPU 10 obtains the reference density value DFm of the patch of each color printed by the corresponding printing unit.

In Step P181, the CPU 10 determines whether or not the second-density-value measuring switch SW8 has been turned ON by the operator. When the second-density-value measuring switch SW8 has been turned ON, the CPU 10 executes Step P182. On the other hand, when the second-density-value measuring switch SW8 has not been turned ON, the CPU 10 executes Step P74.

In Step P182, the CPU 10 writes 1 in the count value M, that is, the CPU 10 stores 1 in the memory M5. Upon completion of the processing of Step P182, the CPU 10 executes Step P183.

In Step P183, the CPU 10 outputs a normal rotation instruction to the motor driver 25 for moving the calorimeter. Upon completion of the processing of Step P183, the CPU 10 executes Step P184.

In Step P184, the CPU 10 reads the value of the counter 26 for measuring the current position of the colorimeter 22, and then stores the read value in the memory M12. Upon completion of the processing of Step P184, the CPU 10 executes Step P185.

In Step P185, the CPU 10 calculates the current position of the calorimeter 22 from the read value of the counter 26 for measuring the current position of the calorimeter 22, and then stores the result of the calculation in the memory M13. Upon completion of the processing of Step P185, the CPU 10 executes Step P186.

In Step P186, the CPU 10 reads, from the memory M14, the position of the patch, which is to be measured by the calorimeter 22, of the M-th printing unit used in the printing. Upon completion of the processing of Step P186, the CPU 10 executes Step P187.

In Step P187, the CPU 10 determines whether or not the current position of the calorimeter 22 is the same as the position of the patch, which is to be measured by the calorimeter 22, of the M-th printing unit used in the printing. When the current position of the calorimeter 22 is the same as the position of the patch, which is to be measured by the calorimeter 22, of the M-th printing unit used in the printing, the CPU 10 executes Step P188. On the other hand, when the current position of the colorimeter 22 is different from the position of the patch, which is to be measured by the calorimeter 22, of the M-th printing unit used in the printing, the CPU 10 executes Step P184.

In Step P188, the CPU 10 outputs a measurement instruction signal to the colorimeter 22. Upon completion of the processing of Step P188, the CPU 10 executes Step P189.

In Step P189, the CPU 10 reads color data from the calorimeter, which data is a digital value obtained by the conversion of the A/D converter 29, and then stores the color data in an address location, for the M-th printing unit used in the printing, in the memory M15. Upon completion of the processing of Step P189, the CPU 10 executes Step P190.

In Step P190, the CPU 10 adds 1 to the count value M stored in the memory M5, and then overwrites the count value M. Upon completion of the processing of Step P190, the CPU 10 executes Step P191.

In Step P191, the CPU 10 reads, from the memory M1, the number Mmax of printing units used in the printing. Upon completion of the processing of Step P191, the CPU 10 executes Step P192.

In Step P192, the CPU 10 determines whether or not the number Mmax of printing units used in the printing, which is stored in the memory M1, is smaller than the count value M, which is stored in the memory M5. When the number Mmax of printing units used in the printing is smaller than the count value M, the CPU 10 executes Step P193. On the other hand, when the number Mmax of printing units used in the printing is larger than, or is equal to, the count value M, the CPU 10 executes Step P184. With this loop, the CPU 10 measures the color data of the patch printed by each printing unit, and then stores the measured color data in the memory M15. Note that, in this case, the position of the patch printed by each printing unit is supposed to be located in a manner that the patches are printed respectively by the first, the second, . . . , and the M-th printing units in this order from a position closest to the original position of the motor 23 for moving the calorimeter.

In Step P193, the CPU 10 outputs a stop instruction to the motor driver 25 for moving the colorimeter. Upon completion of the processing of Step P193, the CPU 10 executes Step P194.

In Step P194, the CPU 10 outputs a reverse rotation instruction to the motor driver 25 for moving the calorimeter. Upon completion of the processing of Step P194, the CPU 10 executes Step P195.

In Step P195, the CPU 10 determines whether or not the output of the detector 27 for detecting the original position of the calorimeter has been turned ON. When the output of the detector 27 for detecting the original position of the calorimeter has been turned ON, the CPU 10 executes Step P196. On the other hand, when the output of the detector 27 for detecting the original position of the colorimeter has not been turned ON, the CPU 10 executes Step P195 again.

In Step P196, the CPU 10 outputs a stop instruction to the motor driver 25 for moving the calorimeter. Upon completion of the processing of Step P196, the CPU 10 executes Step P197.

In Step P197, the CPU 10 writes 1 in the count value M, that is, the CPU 10 stores 1 in the memory M5. Upon completion of the processing of Step P197, the CPU 10 executes Step P198.

In Step P198, the CPU 10 reads, from the memory M2, the printing unit number UNm of the M-th printing unit used in the printing. Upon completion of the processing of Step P198, the CPU 10 executes Step P199.

In Step P199, the CPU 10 reads, from the memory M3, the ink color ICm of the printing unit of the printing unit number UNm. Upon completion of the processing of Step P199, the CPU 10 executes Step P200.

In Step P200, the CPU 10 reads the color data, measured by the calorimeter 22, of the M-th printing unit used in the printing, from the address location, for the M-th printing unit used in the printing, in the memory M15 for storing the color data from the calorimeter 22. Upon completion of the processing of Step P200, the CPU 10 executes Step P201.

In Step P201, the CPU 10 calculates a second density value DOm of the ink color ICm of the printing unit of the printing unit number UNm, from the color data, measured by the calorimeter 22, in accordance with the ink color ICm of the printing unit of the printing unit number UNm. The CPU 10 then stores the result of the calculation in the memory M44. Upon completion of the processing of Step P201, the CPU 10 executes Step P202.

In Step P202, the CPU 10 reads, from the memory M43, the reference density value DFm of the ink color ICm of the printing unit of the printing unit number UNm. Upon completion of the processing of Step P202, the CPU 10 executes Step P203.

In Step P203, the CPU 10 calculates a density difference DDm between the second density value DOm and the reference density value DFm, of the ink color ICm of the printing unit of the printing unit number UNm. The CPU 10 then stores the result of the calculation in the memory M45. Upon completion of the processing of Step P203, the CPU 10 executes Step P204.

In Step P204, the CPU 10 reads, from the memory M46, the density difference DDm-feeding stop number conversion table for the ink color ICm. Upon completion of the processing of Step P204, the CPU 10 executes Step P205.

In Step P205, the CPU 10 obtains the number C1m of feeding stops of the printing unit of printing unit number UNm, from the density difference DDm between the second density value DOm and the reference density value DFm, of the ink color ICm of the printing unit of the printing unit number UNm, by using the density difference DDm-feeding stop number conversion table for the ink color ICm. The CPU 10 then stores the obtained value in the memory M40.

In Step P206, the CPU 10 adds 1 to the count value M stored in the memory M5, and then overwrites the count value M. Upon completion of the processing of Step P206, the CPU 10 executes Step P207.

In Step P207, the CPU 10 reads, from the memory M1, the number Mmax of printing units used in the printing. Upon completion of the processing of Step P207, the CPU 10 executes Step P208.

In Step P208, the CPU 10 determines whether or not the number Mmax of printing units used in the printing, which is stored in the memory M1, is smaller than the count value M, which is stored in the memory M5. When the number Mmax of printing units used in the printing is smaller than the count value M, the CPU 10 executes Step P74 via Step P157 and Step P181. On the other hand, when the number Mmax of printing units used in the printing is larger than, or is equal to, the count value M, the CPU 10 executes Step P198. With this loop, the CPU 10 obtains the number C1m of feedings stops of each printing unit.

In Step P74, the CPU 10 reads an output of the A/D converter 30 connected to the rotary encoder 28 for the drive motor of the printing press, and then stores the value of the output in the memory M20. Upon completion of the processing of Step P74, the CPU 10 executes Step P75.

In Step P75, the CPU 10 calculates the current rotation speed R of the printing press from the output, which is stored in the memory M20, of the A/D converter 30 connected to the rotary encoder 28 for the drive motor of the printing press. The CPU 10 then stores the result of the calculation in the memory M21. Upon completion of the processing of Step P75, the CPU 10 executes Step P76.

In Step P76, the CPU 10 writes 1 in the count value M, that is, the CPU 10 stores 1 in the memory M5. Upon completion of the processing of Step P76, the CPU 10 executes Step P77.

In Step P77, the CPU 10 reads, from the memory M2, the printing unit number UNm of the M-th printing unit used in the printing. Upon completion of the processing of Step P77, the CPU 10 executes Step P78.

In Step P78, the CPU 10 reads, from the memory M3, the ink color ICm of the printing unit of the printing unit number UNm. Upon completion of the processing of Step P78, the CPU 10 executes Step P79.

In Step P79, the CPU 10 reads, from the memory M22, the reference rotation speed IFRRm of the ink fountain roller corresponding to the ink color ICm. Upon completion of the processing of Step P79, the CPU 10 executes Step P80.

In Step P80, the CPU 10 reads, from the memory M21, the current rotation speed R of the printing press. Upon completion of the processing of Step P80, the CPU 10 executes Step P81.

In Step P81, the CPU 10 multiplies the current rotation speed R of the printing press by the reference rotation speed ratio IFRRm of the ink fountain roller corresponding to the ink color ICm to calculate the rotation speed IFRm of the ink fountain roller of the printing unit of the printing unit number UNm. The CPU 10 then stores the result of the calculation in the memory M23. Upon completion of the processing of Step P81, the CPU 10 executes Step P82.

In Step P82, the CPU 10 transmits the rotation speed IFRm of the ink fountain roller to the ink fountain roller rotation speed control device 3 of the printing unit of the printing unit number UNm. Upon completion of the processing of Step P82, the CPU 10 executes Step P83.

In Step P83, the CPU 10 determines whether or not a reception confirmation signal has been transmitted from the ink fountain roller rotation speed control device 3 of the printing unit of the printing unit number UNm. When the reception confirmation signal has been transmitted from the ink fountain roller rotation speed control device 3 of the printing unit of the printing unit number UNm, the CPU 10 executes Step P84. On the other hand, when the reception confirmation signal has not been transmitted from the ink fountain roller rotation speed control device 3 of the printing unit of the printing unit number UNm, the CPU 10 executes Step P83 again.

In Step P84, the CPU 10 adds 1 to the count value M stored in the memory M5, and then overwrites the count value M. Upon completion of the processing of Step P84, the CPU 10 executes Step P85.

In Step P85, the CPU 10 reads, from the memory M1, the number Mmax of printing units used in the printing. Upon completion of the processing of Step P85, the CPU 10 executes Step P86.

In Step P86, the CPU 10 determines whether or not the number Mmax of printing units used in the printing at this time, which is stored in the memory M1, is smaller than the count value M, which is stored in the memory M5. When the number Mmax of printing units used in the printing at this time is smaller than the count value M, the CPU 10 executes Step P87. On the other hand, when the number Mmax of printing units used in the printing at this time is larger than, or is equal to, the count value M, the CPU 10 executes Step P77. With this loop, the CPU 10 transmits the rotation speed IFRm of the ink fountain roller of each color to the ink fountain roller rotation speed control device 3 of the printing unit of the color.

In Step P87, the CPU 10 writes 1 in the count value M, that is, the CPU 10 stores 1 in the memory M5. Upon completion of the processing of Step P87, the CPU 10 executes Step P88.

In Step P88, the CPU 10 reads, from the memory M2, the printing unit number UNm of the M-th printing unit used in the printing. Upon completion of the processing of Step P88, the CPU 10 executes Step P198.

In Step P198, the CPU 10 reads, from the memory M40, the number C1m of feeding stops of the printing unit of the printing unit number UNm. Upon completion of the processing of Step P198, the CPU 10 executes Step P199.

In Step P199, the CPU 10 transmits the number C1m of feeding stops to the ink feeding number control device 2 of the printing unit of the printing unit number UNm. Upon completion of the processing of Step P199, the CPU 10 executes Step P93.

In Step P93, the CPU 10 determines whether or not a reception confirmation signal has been transmitted from the ink feeding number control device 2 of the printing unit of the printing unit number UNm. When the reception confirmation signal has been transmitted from the ink feeding number control device 2 of the printing unit of the printing unit number UNm, the CPU 10 executes Step P94. On the other hand, when the reception confirmation signal has not been transmitted from the ink feeding number control device 2 of the printing unit of the printing unit number UNm, the CPU 10 executes Step P93 again.

In Step P94, the CPU 10 adds 1 to the count value M stored in the memory M5, and then overwrites the count value M. Upon completion of the processing of Step P94, the CPU 10 executes Step P95.

In Step P95, the CPU 10 reads, from the memory M1, the number Mmax of printing units used in the printing. Upon completion of the processing of Step P95, the CPU 10 executes Step P96.

In Step P96, the CPU 10 determines whether or not the number Mmax of printing units used in the printing at this time, which is stored in the memory M1, is smaller than the count value M, which is stored in the memory M5. When the number Mmax of printing units used in the printing at this time is smaller than the count value M, the CPU 10 executes Step P123. On the other hand, when the number Mmax of printing units used in the printing at this time is larger than, or is equal to, the count value M, the CPU 10 executes Step P88. With this loop, the CPU 10 transmits the number C1m of feeding stops to the ink feeding number control device 2 of the printing unit of each color.

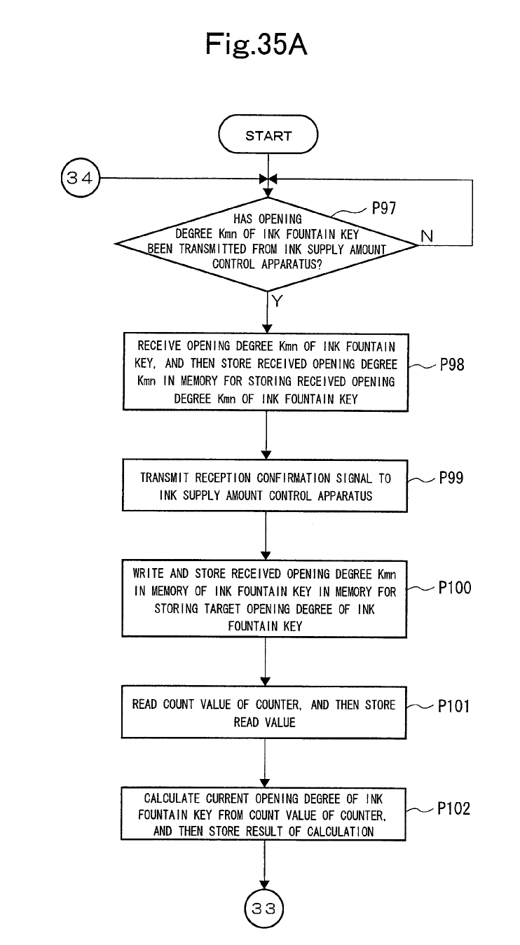

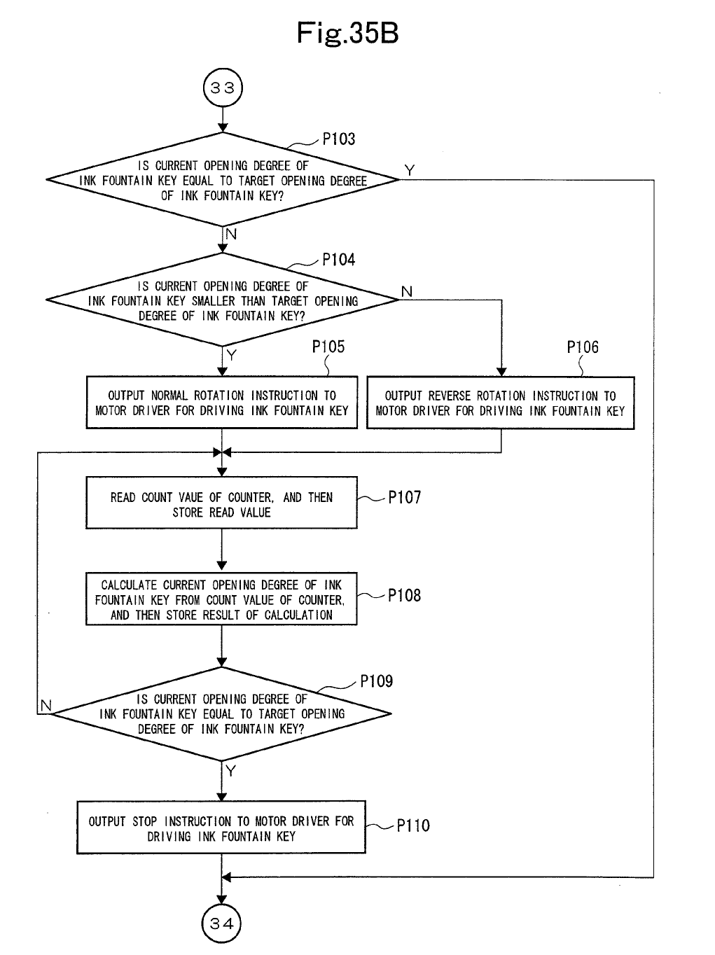

Next, descriptions will be given of the operation of the ink fountain key opening degree control device 4, which controls the opening degree of each ink fountain key of each color, according to the third embodiment of the present invention. Each of FIGS. 35A and 35B shows an operational flowchart of the ink fountain key opening degree control device 4, which controls the opening degree of each ink fountain key of each color, according to the third embodiment of the present invention. Hereinafter, the content of the processing of each step will be described.

In Step P97, the CPU 53 determines whether or not the opening degree Kmn of the corresponding ink fountain key has been transmitted from the ink supply amount control apparatus 1. When the opening degree Kmn of the ink fountain key has been transmitted from the ink supply amount control apparatus 1, the CPU 53 executes Step P98. On the other hand, when the opening degree Kmn of the ink fountain key has not been transmitted from the ink supply amount control apparatus 1, the CPU 53 executes Step P97 again.

In Step P98, the CPU 53 receives the opening degree Kmn of the ink fountain key, and then stores the received opening degree Kmn of the ink fountain key in the memory M29. Upon completion of the processing of Step P98, the CPU 53 executes Step P99.

In Step P99, the CPU 53 transmits a reception confirmation signal to the ink supply amount control apparatus 1. Upon completion of the processing of Step P99, the CPU 53 executes Step P100.

In Step P100, the CPU 53 writes and stores the received opening degree Kmn of the ink fountain key in the memory M30 for storing the target opening degree of the ink fountain key. Upon completion of the processing of Step P100, the CPU 53 executes Step P101.

In Step P101, the CPU 53 reads the count value of the counter 61, and then stores the read value in the memory M31. Upon completion of the processing of Step P101, the CPU 53 executes Step P102.

In Step P102, the CPU 53 calculates the current opening degree of the ink fountain key from the count value of the counter 61, and then stores the result of the calculation in the memory M32. Upon completion of the processing of Step P102, the CPU 53 executes Step P103.

In Step P103, the CPU 53 determine whether or not the current opening degree of the ink fountain key is equal to the target opening degree of the ink fountain key. When the current opening degree of the ink fountain key is equal to the target opening degree of the ink fountain key, the CPU 53 executes Step P97. On the other hand, when the current opening degree of the ink fountain key is not equal to the target opening degree of the ink fountain key, the CPU 53 executes Step P104.

In Step P104, the CPU 53 determines whether or not the current opening degree of the ink fountain key is smaller than the target opening degree of the ink fountain key. When the current opening degree of the ink fountain key is smaller than the target opening degree of the ink fountain key, the CPU 53 executes Step P105. On the other hand, when the current opening degree of the ink fountain key is larger than the target opening degree of the ink fountain key, the CPU 53 executes Step P106.

In Step P105, the CPU 53 outputs a normal rotation instruction to the motor driver 58 for driving the ink fountain key. Upon completion of the processing of Step P105, the CPU 53 executes Step P107.

In Step P106, the CPU 53 outputs a reverse rotation instruction to the motor driver 58 for driving the ink fountain key. Upon completion of the processing of Step P105, the CPU 53 executes Step P107.

In Step P107, the CPU 53 reads the count value of the counter 61, and then stores the read value in the memory M31. Upon completion of the processing of Step P107, the CPU 53 executes Step P108.

In Step P108, the CPU 53 calculates the current opening degree of the ink fountain key from the count value stored in the memory M31, and then stores the result of the calculation in the memory M32. Upon completion of the processing of Step P108, the CPU 53 executes Step P109.

In Step P109, the CPU 53 determines whether or not the current opening degree of the ink fountain key, which is stored in the memory M32, is equal to the target opening degree of the ink fountain key, which is stored in the memory M30. When the current opening degree of the ink fountain key is equal to the target opening degree of the ink fountain key the CPU 53 executes Step P110. On the other hand, when the current opening degree of the ink fountain key is not equal to the target opening degree of the ink fountain key, the CPU 53 executes Step P107.

In Step P110, the CPU 53 outputs a stop instruction to the motor driver 58 for driving the ink fountain key. Upon completion of the processing of Step P110, the CPU 53 executes Step P97.

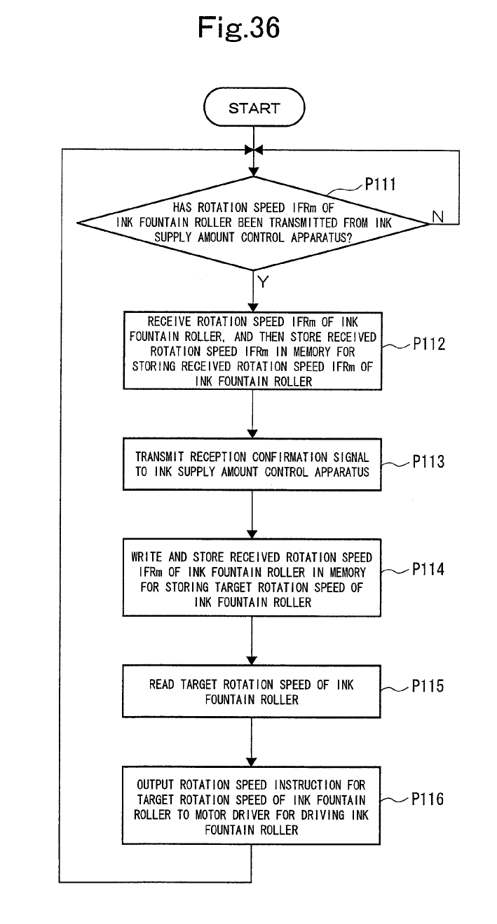

Next, descriptions will be given of the operation of the ink fountain roller rotation speed control device 3, which controls the rotation amount of each ink fountain roller, according to the third embodiment of the present invention. FIG. 36 shows an operational flowchart of the ink fountain roller rotation speed control device 3, which controls the rotation amount of each ink fountain roller, according to the third embodiment of the present invention. Hereinafter, the content of the processing of each step will be described.

In Step P11, the CPU 43 determines whether or not the rotation speed IFRm of the ink fountain roller has been transmitted from the ink supply amount control apparatus 1. When the rotation speed IFRm of the ink fountain roller has been transmitted from the ink supply amount control apparatus 1, the CPU 43 executes Step P112. On the other hand, when the rotation speed IFRm of the ink fountain roller has not been transmitted from the ink supply amount control apparatus 1, the CPU 43 executes Step P111 again.

In Step P112, the CPU 43 receives the rotation speed IFRm of the ink fountain roller, and then stores the received rotation speed IFRm of the ink fountain roller in the memory M27. Upon completion of the processing of Step P112, the CPU 43 executes Step P113.

In Step P113, the CPU 43 transmits a reception confirmation signal to the ink supply amount control apparatus 1. Upon completion of the processing of Step P113, the CPU 43 executes Step P114.

In Step P114, the CPU 43 writes and stores the received rotation speed IFRm of the ink fountain roller in the memory M28 for storing the target rotation speed of the ink fountain roller. Upon completion of the processing of Step P114, the CPU 43 executes Step P115.

In Step P115, the CPU 43 reads, from the memory M28, the target rotation speed of the ink fountain roller. Upon completion of the processing of Step P115, the CPU 43 executes Step P116.

In Step P116, the CPU 43 outputs a rotation speed instruction, for causing the ink fountain roller to rotate at the target rotation speed, to the motor driver 48 for driving the ink fountain roller. Upon completion of the processing of Step P116, the CPU 43 executes Step P111.

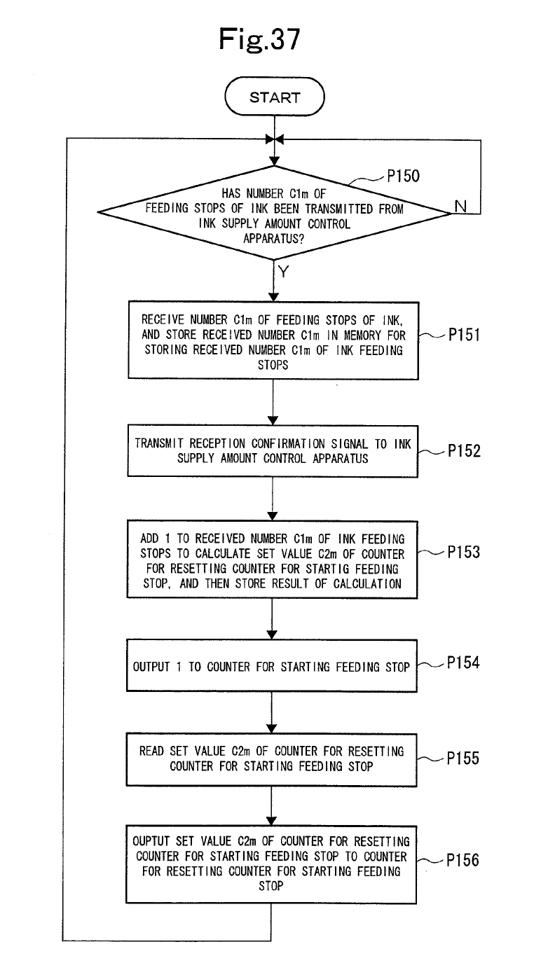

Next, descriptions will be given of the operation of the ink feeding number control device 2, which controls the number of feedings of each ink, according to the third embodiment of the present invention. FIG. 37 shows an operational flowchart of the ink feeding number control device 2, which controls the number of feedings of each ink, according to the third embodiment of the present invention. Hereinafter, the content of the processing of each step will be described.

In Step P150, the CPU 33 determines whether or not the number C1m of feeding stops has been transmitted from the ink supply amount control apparatus 1. When the number C1m of feeding stops has been transmitted from the ink supply amount control apparatus 1, the CPU 33 executes Step P151. On the other hand, when the number C1m of feeding stops has not been transmitted from the ink supply amount control apparatus 1, the CPU 33 executes Step P150 again.

In Step P151, the CPU 33 receives the number C1m of feeding stops, and then stores the received number C1m of feeding stops in the memory M41. Upon completion of the processing of Step P151, the CPU 33 executes Step P152.

In Step P152, the CPU 33 transmits a reception confirmation signal to the ink supply amount control apparatus 1. Upon completion of the processing of Step P152, the CPU 33 executes Step P153.

In Step P153, the CPU 33 adds 1 to the received number C1m of feeding stops to calculate a set value C2m of the counter 65 for resetting the counter for starting feeding stop. The CPU 33 then stores the result of the calculation in the memory M42. Upon completion of the processing of Step P153, the CPU 33 executes Step P154.

In Step P154, the CPU 33 outputs 1 to the counter 64 for starting feeding stop. Upon completion of the processing of Step P154, the CPU 33 executes Step P155.

In Step P155, the CPU 33 reads, from the memory M42, the set value C2m of the counter 65 for resetting the counter for starting feeding stop. Upon completion of the processing of Step P155, the CPU 33 executes Step P156.

In Step P156, the CPU 33 outputs the set value C2m of the counter 65 for resetting the counter for starting feeding stop to the counter 65 for resetting the counter for starting feeding stop. Upon completion of the processing of Step P156, the CPU 33 executes Step P150. Accordingly, the counter 64 for starting feeding stop and the counter 65 for resetting the counter for starting feeding stop are set. By this setting, the feeding operation of the ductor roller 114 is stopped and restarted in the following manner. Specifically, the count of the counter 64 for starting feeding stop is incremented upon reception of a first pulse transmitted from the sensor 63 for detecting the rotation of the ink ductor cam in accordance with the rotation of the cam 77, which swings the ductor roller 114 with the rotation of the printing press. The counter 64 then outputs a signal to a set terminal of the flip-flop circuit 66 to set the flip-flop circuit 66. The flip-flop circuit 66 thus outputs a signal to turn ON the valve 67 for the feeding stop air cylinder. Consequently, the feeding stop air cylinder 68 is activated, so that the feeding operation of the ductor roller 114 is stopped. After that, the count of the counter 65 for resetting the counter for starting feeding stop is incremented upon reception of a C2m-th, that is, (C1m+1)-th pulse transmitted from the sensor 63 for detecting the rotation of the ink ductor cam in accordance with the subsequent rotation of the printing press, where the C2m is the set value of the counter 65 for resetting the counter for starting feeding stop, and the C1m is the number of feeding stops. The counter 65 for resetting the counter for starting feeding stop then outputs a signal to a reset terminal of the flip-flop circuit 66 to reset the flip-flop circuit 66. With this signal, the flip-flop circuit 66 thus stops the output to the valve 67 for the feeding stop air cylinder, turning OFF the valve 67 for the feeding stop air cylinder. Consequently, the operation of the feeding stop air cylinder 68 is stopped, so that the feeding operation of the ductor roller 114 is restarted. Accordingly, the ductor roller 114 performs the feeding operation once after stopping the feeding operation for C1m times, where C1m is the number of feeding stops, and thereafter repeats this operation.

### Fourth Embodiment

Firstly, descriptions will be given of the device configuration of an ink feed control system according to a fourth embodiment of the present invention. FIG. 1 shows a side view showing principal parts of an inking device of a printing press according to the fourth embodiment of the present invention. In FIG. 1, the same reference numerals denote components that are the same as, or similar to, those described in the above-mentioned conventional technique shown in FIG. 48, and detailed descriptions of the same components will be omitted. An ink fountain roller 108 is provided as a roller on the upstream side in the ink transfer direction, while a distribution roller 113 is provided as a roller on the downstream side in the ink transfer direction. A ductor roller 114, and a ductor shaft 72 which serves as a swing fulcrum for swinging the ductor roller 114, are pivotally supported by the left and right frames (not illustrated) so as to rotate, between the ink fountain roller 108 and the distribution roller 113. One of the shaft ends of the ductor shaft 72 protrudes from the frame, and a cam lever 73 is provided to this protruding portion of the ductor shaft 72. The ink fountain roller 108 is driven by a motor 49 for driving the ink fountain roller. The motor 49 for driving the ink fountain roller is controlled by a motor driver 48 for driving the ink fountain roller.

A camshaft 76 is implanted into the frames at a position obliquely below the ductor shaft 72. A cam 77 is pivotally supported by the camshaft 76 so as to be rotatable. The cam 77 has a cam surface composed of a large-diameter portion 77a and a small-diameter portion 77b. A cam follower 78 provided at one end portion of the cam lever 73 faces, and is in contact with, the cam surface. The cam 77 is driven by a motor 39 for driving the ink feed mechanism. The motor 39 for driving the ink feed mechanism is controlled by a motor driver 38 for driving the ink feed mechanism. A pair of left and right swing levers 81 are pivotally mounted on the ductor shaft 72 inside the frames, while the ductor roller 114 is pivotally supported, at the two end shafts 114a, by the swing levers 81 so as to be rotatable. In the inking device of the printing press according to the first embodiment of the present invention, the ink feed mechanism, which includes the cam 77, the cam lever 73 and the like, constitutes ink ductor roller swing means.

The upper end portion of the swing lever 81 extends upward, and a spring shaft 83 is axially mounted on the upper end portion, while the spring shaft 83 is supported, at one end thereof, by a spring bearing 82, which projects from the frames. A compression coil spring 84 is mounted on the spring shaft 83. The compression coil spring 84 applies a rotational force to the ductor roller 114 so as to rotate the ductor roller 114 in the counterclockwise direction in FIG. 1, that is, so as to bring the ductor roller 114 into contact with the ink fountain roller 108. On the other hand, the rotation of a drive motor is transmitted to the distribution roller 113, so that the distribution roller 113 reciprocates once in the axial direction as the plate cylinder 101 (see FIG. 48) rotates twice.

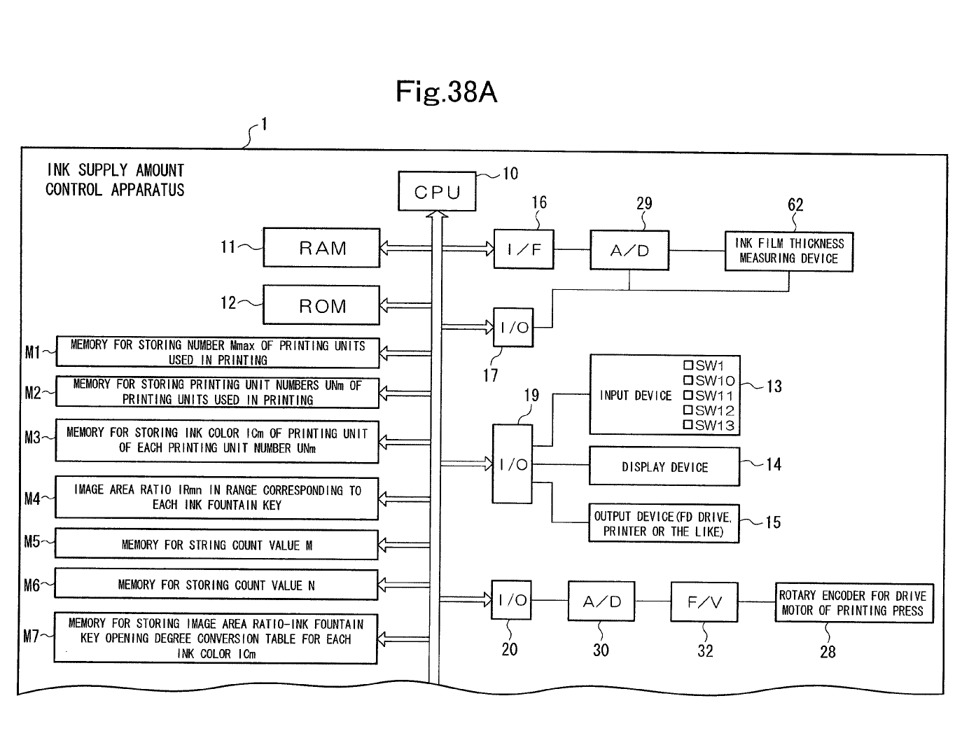

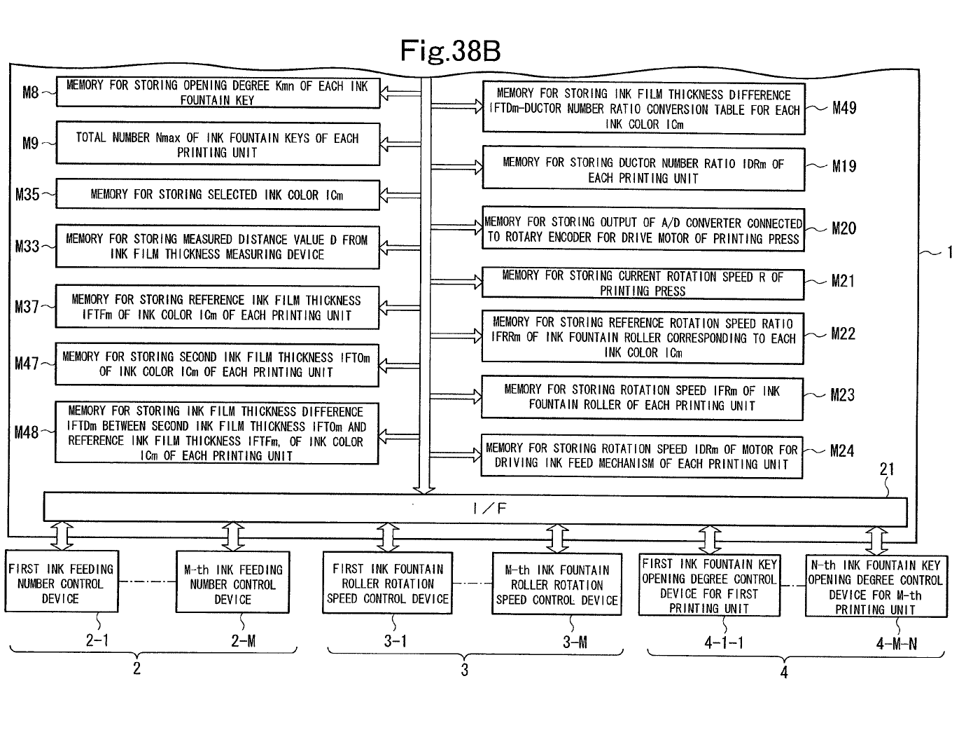

Next, an ink supply amount control apparatus according to the fourth embodiment of the present invention will be described. FIGS. 38A and 38B show hardware block diagrams of the ink supply amount control apparatus according to the fourth embodiment of the present invention. As shown in FIGS. 38A and 38B, the ink supply amount control apparatus 1 includes a CPU 10, a RAM 11, a ROM 12, an input device 13, a display device 14, an output device 15, input/output interfaces (I/O, I/F) 16, 17, 19, 20 and 21, a rotary encoder 28 for the drive motor of the printing press, A/D converters 29 and 30, an F/V converter 32, an ink film thickness measuring device 62, and memories M1 to M9, M19 to M24, M33, M35, M37 and M47 to M49.

The CPU 10 obtains various kinds of information which are inputted thereto through the interfaces 16, 17, 19, and 21, and operates in accordance with a program stored in the ROM 12, while accessing the RAM 11 as well as the memories M1 to M9, M19 to M24, M33, M35, M37, and M47 to M49. The input device 13 is provided with an ink preset switch SW1, a reference-ink-film-thickness measuring switch SW10, a switch SW11 for selecting ink color ICm for measuring the ink film thickness (hereinafter, referred to as an ink-color-ICm-for-measuring-ink-film-thickness selecting switch SW11), a second-ink-film-thickness measuring switch SW12, a feed-control starting switch SW13 and the like. The rotary encoder 28 for the drive motor of the printing press generates a rotation pulse for every predetermined number of rotations (angle) of the drive motor, and then outputs the rotation pulse to the input/output interface 20. Note that, the ink film thickness measuring device 62 according to the fourth embodiment of the present invention is the same as that of the second embodiment, and hence descriptions thereof will be omitted here.

In the ink supply amount control apparatus 1, in the memory M1, the number Mmax of printing units used in the printing is stored. In the memory M2, the printing unit number UNm of each printing unit used in the printing is stored. In the memory M3, the ink color ICm of the printing unit of each printing unit number UNm is stored.

In the memory M4, the image area ratio IRmn of a range corresponding to each ink fountain key is stored. In the memory M5, a count value M is stored. In the memory M6, a count value N is stored.

In the memory M7, an image area ratio-ink fountain key opening degree conversion table for each ink color is stored. In the memory M8, the opening degree Kmn of each ink fountain key is stored. In the memory M9, the total number Nmax of ink fountain keys of each printing unit is stored.

In the memory M19, a ductor number ratio IDNRm of each printing unit is stored. In the memory M20, an output of the A/D converter connected to the rotary encoder 28 for the drive motor of the printing unit is stored. In the memory M21, the current rotation speed R of the printing press is stored.

In the memory M22, the reference rotation speed ratio IFRRm of the ink fountain roller corresponding to each ink color ICm is stored. In the memory M23, the rotation speed IFRm of the ink fountain roller of each printing unit is stored. In the memory M24, the rotation speed IDRm of the motor for driving the ink feed mechanism of each printing unit is stored.

In the memory M33, the measured distance value D from the ink film thickness measuring device 62 is stored. In the memory M35, a selected ink color ICm is stored. In the memory M37, a reference ink film thickness IFTFm of the ink color ICm of each printing unit is stored.

In the memory M47, a second ink film thickness IFTOm of the ink color ICm of each printing unit is stored. In the memory M48, an ink film thickness difference IFTDm between the second ink film thickness IFTOm of the ink color ICm of each printing unit and the reference ink film thickness IFTFm is stored. In the memory M49, a conversion table between an ink film thickness difference IFTDm of each ink color ICm and a ductor number ratio (hereinafter, an ink film thickness difference IFTDm-ductor number ratio conversion table for each ink color ICm) is stored.

An ink feeding number control device 2, an ink fountain roller rotation speed control device 3, and an ink fountain key opening degree control device 4 are connected to the ink supply amount control apparatus 1 through the interface 21. The ink feeding number control device 2 controls the number of feedings of each ink. The ink fountain roller rotation speed control device 3 controls the rotation amount of each ink fountain roller. The ink fountain key opening degree control device 4 controls the opening degree of each of the ink fountain keys 109-1 to 109-N of each color.

The ink feeding number control device 2 includes first to M-th ink feeding number control devices 2-1 to 2-M. The ink fountain roller rotation speed control device 3 includes first to M-th ink fountain roller rotation speed control devices 3-1 to 3-M. The ink fountain key opening degree control device 4 includes a first ink fountain key opening degree control device 4-1-1 for first printing unit, to an N-th ink fountain key opening degree control device 4-M-N for M-th printing unit.

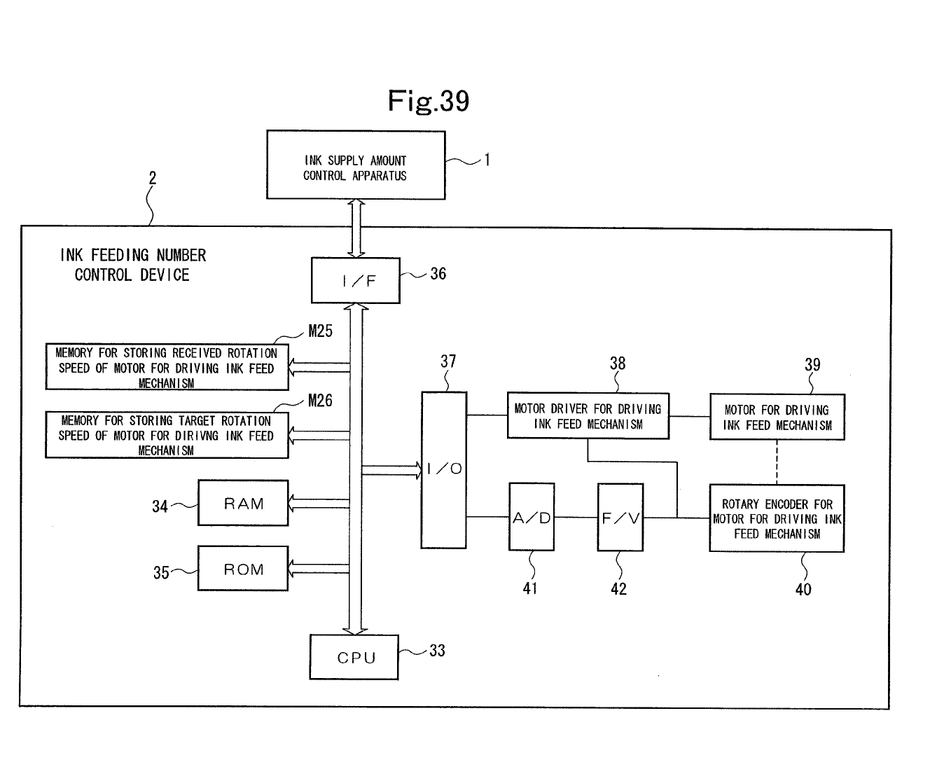

Next, the ink feeding number control device (the ink ductor roller swing means) according to the fourth embodiment of the present invention will be described. FIG. 39 shows a hardware block diagram of the ink feeding number control device according to the fourth embodiment of the present invention. As shown in FIG. 39, the ink feeding number control device 2 includes a CPU 33, a RAM 34, a ROM 35, input/output interfaces (I/O, I/F) 36 and 37, a motor driver 38 for driving the ink feed mechanism 38, a motor 39 for driving the ink feed mechanism, a rotary encoder 40 for the motor for driving the ink feed mechanism, an A/D converter 41, an F/V converter 42, and memories M25 and M26.

The CPU 33 obtains various kinds of information which are inputted thereto through the interfaces 36 and 37, and operates in accordance with a program stored in the ROM 35, while accessing the RAM 34 as well as the memories M25 and M26. The motor driver 38 for driving the ink feed mechanism controls the motor 39 for driving the ink feed mechanism. The rotary encoder 40 for the motor for the ink feed mechanism generates one rotation pulse for every predetermined number of rotations (angle) of the motor 39 for driving the ink feed mechanism, and then outputs the rotation pulse to the input/output interface 37.

In the ink feeding number control device 2, in the memory M25, a received rotation speed of the motor for driving the ink feed mechanism is stored. In the memory M26, a target rotation speed IDRm of the motor for driving the ink feed mechanism is stored.

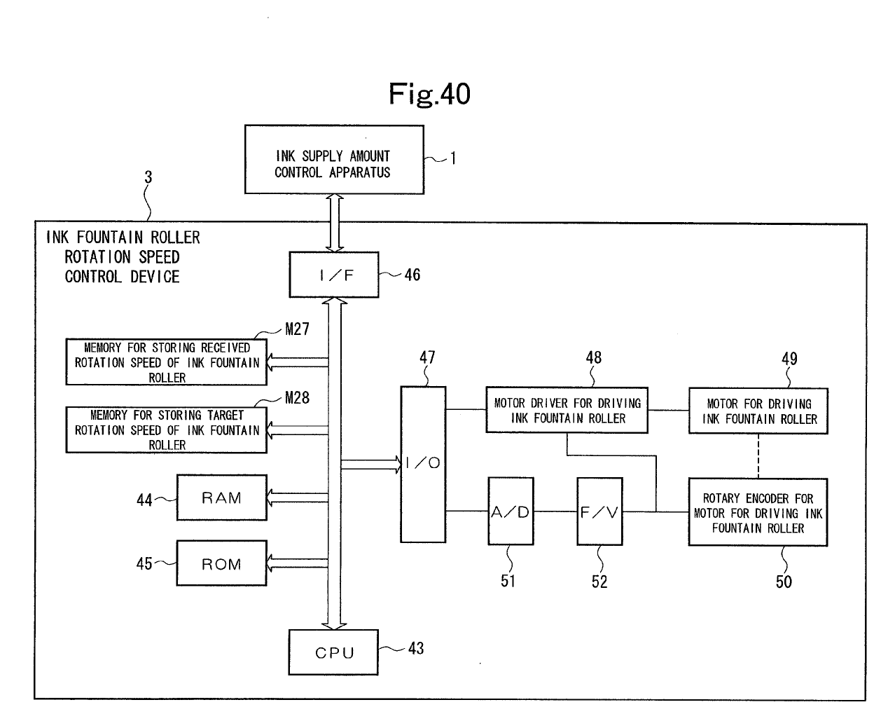

Next, the ink fountain roller rotation speed control device according to the fourth embodiment of the present invention will be described. FIG. 40 shows a hardware block diagram of the ink fountain roller rotation speed control device according to the fourth embodiment of the present invention. As shown in FIG. 40, the ink fountain roller rotation speed control device 3 includes a CPU 43, a RAM 44, a ROM 45, input/output interfaces (I/O, I/F) 46 and 47, a motor driver 48 for driving the ink fountain roller, a motor 49 for driving the ink fountain roller, a rotary encoder 50 for the motor for driving the ink fountain roller, an A/D converter 51, an F/V converter 52, and memories M27 and M28.

The CPU 43 obtains various kinds of information which are inputted thereto through the interfaces 46 and 47, and operates in accordance with a program stored in the ROM 45, while accessing the RAM 44 as well as the memories M27 and M28. The motor driver 48 for driving the ink fountain roller controls the motor 49 for driving the ink fountain roller. The rotary encoder 50 for the motor for driving the ink fountain roller generates one rotation pulse for every predetermined number of rotations (angle) of the motor 49 for driving the ink fountain roller, and then outputs the rotation pulse to the input/output interface 47.

In the ink fountain roller rotation speed control device 3, in the memory M27, a received rotation speed of the ink fountain roller is stored. In the memory M28, a target rotation speed of the ink fountain roller is stored.

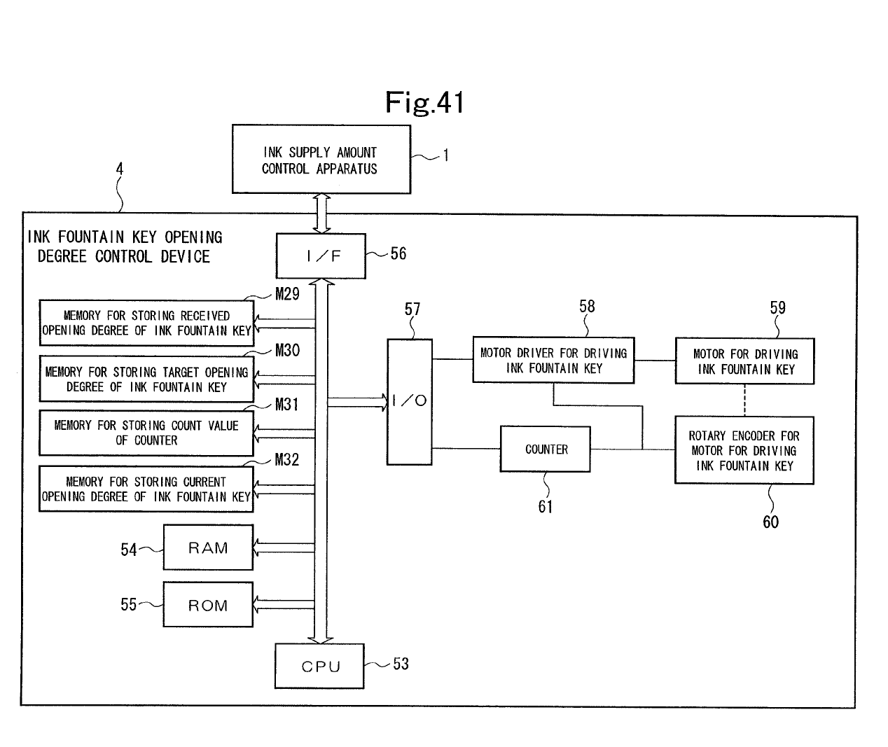

Next, the ink fountain key opening degree control device according to the fourth embodiment of the present invention will be described. FIG. 41 shows a hardware block diagram of the ink fountain key opening degree control device according to the fourth embodiment of the present invention. As shown in FIG. 41, the ink fountain key opening degree control device 4 includes a CPU 53, a RAM 54, a ROM 55, input/output interfaces (I/O, I/F) 56 and 57, a motor driver 58 for driving the ink fountain key 58, a motor 59 for driving the ink fountain key, a rotary encoder 60 for the motor for driving the ink fountain key, a counter 61, and memories M29 to M32.

The CPU 53 obtains various kinds of information which are inputted thereto through the interfaces 56 and 57, and operates in accordance with a program stored in the ROM 55, while accessing the RAM 54 as well as the memories M29 to M32.

In the ink fountain key opening degree control device 4, in the memory M29, a received opening degree of the ink fountain key is stored. In the memory M30, a target opening degree of the ink fountain key is stored. In the memory M31, a count value of the counter 61 is stored. In the memory M32, the current opening degree of the ink fountain key is stored.

Note that, in FIG. 38B, the ink fountain key opening degree control devices 4-1-1 to 4-M-N are the ink fountain key opening degree control devices 4 provided for the respective ink fountain keys 109 (109-1 to 109-N) of the corresponding colors, which are shown in FIG. 48. With the ink fountain key opening degree control devices 4-1-1 to 4-M-N, the opening degrees of the ink fountain keys 109-1 to 109-N of each color are individually adjusted with respect to the corresponding ink fountain roller 108.

The ink fountain key opening degree control device 4 includes the motor driver 58 for driving the ink fountain key, the motor 59 for driving the ink fountain key, the rotary encoder 60 for the motor for driving the ink fountain key, and the counter 61. The ink fountain key opening degree control device 4 is connected to the CPU 10 of the ink supply amount control apparatus 1 through the interface 56. The rotary encoder 60 for the motor for driving the ink fountain key generates one rotation pulse for every predetermined number of rotations (angle) of the motor 59 for driving the ink fountain key, and then outputs the rotation pulse to the counter 61.

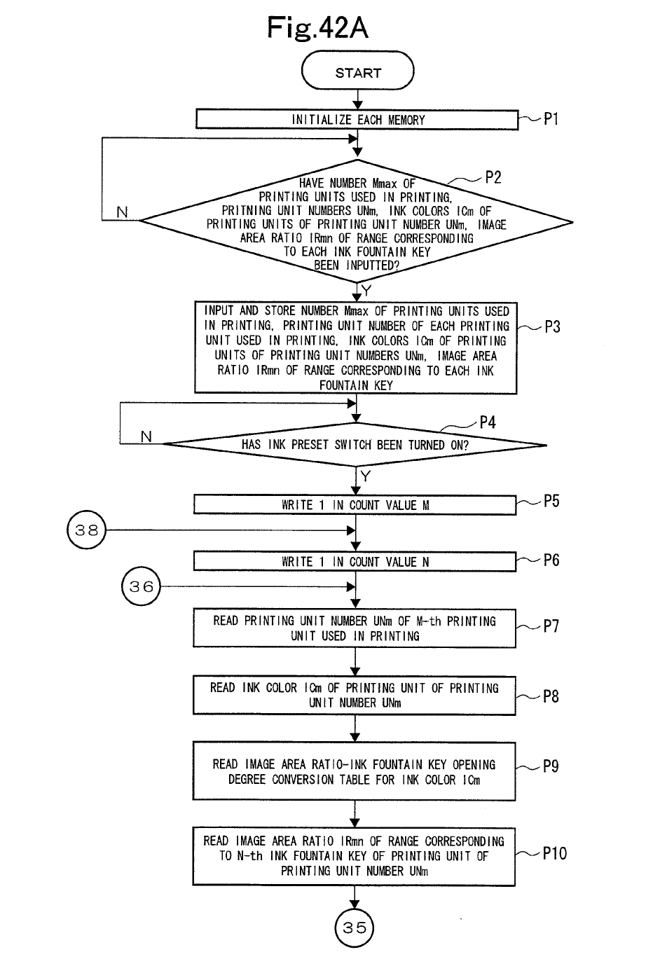

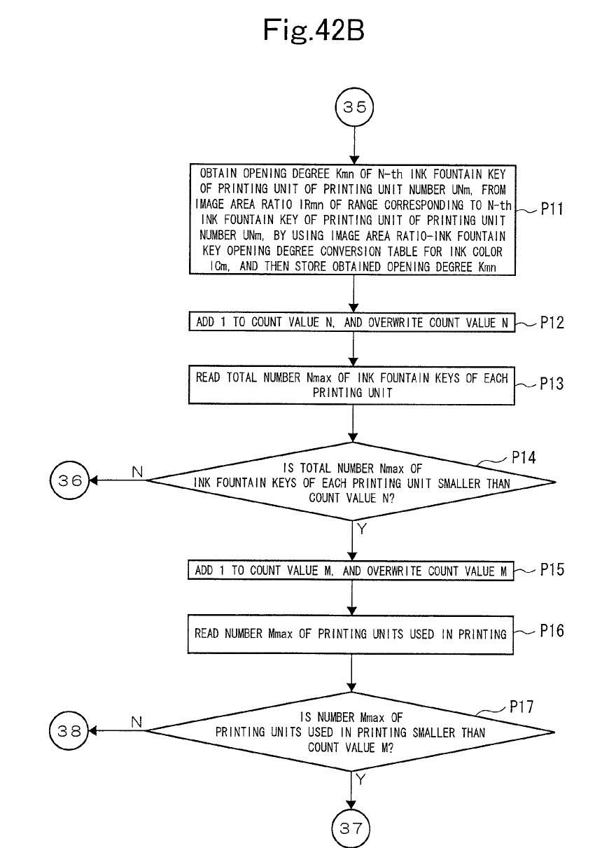

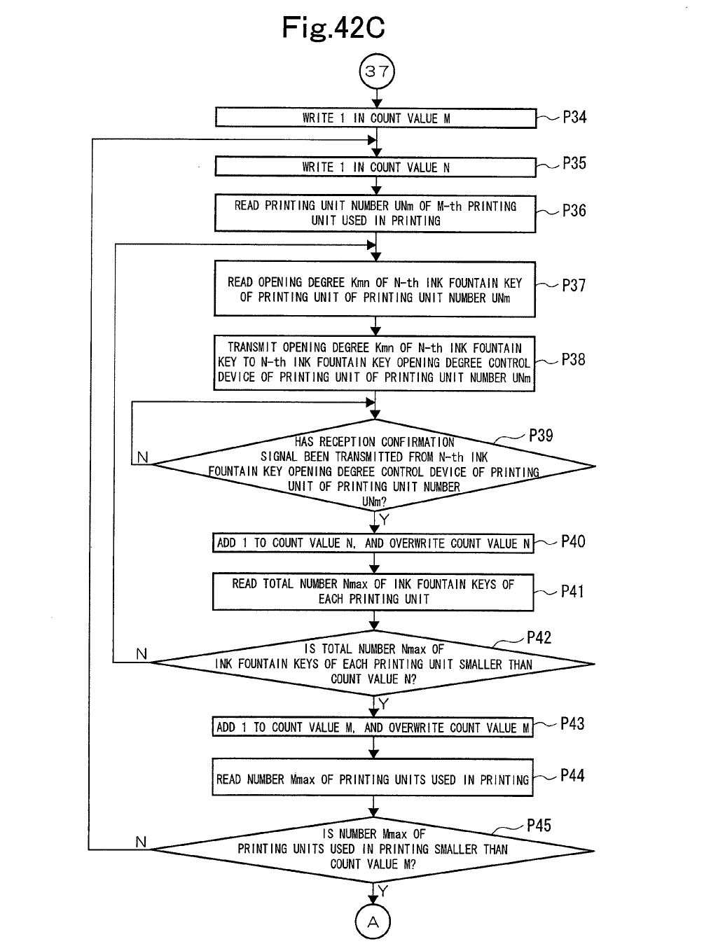

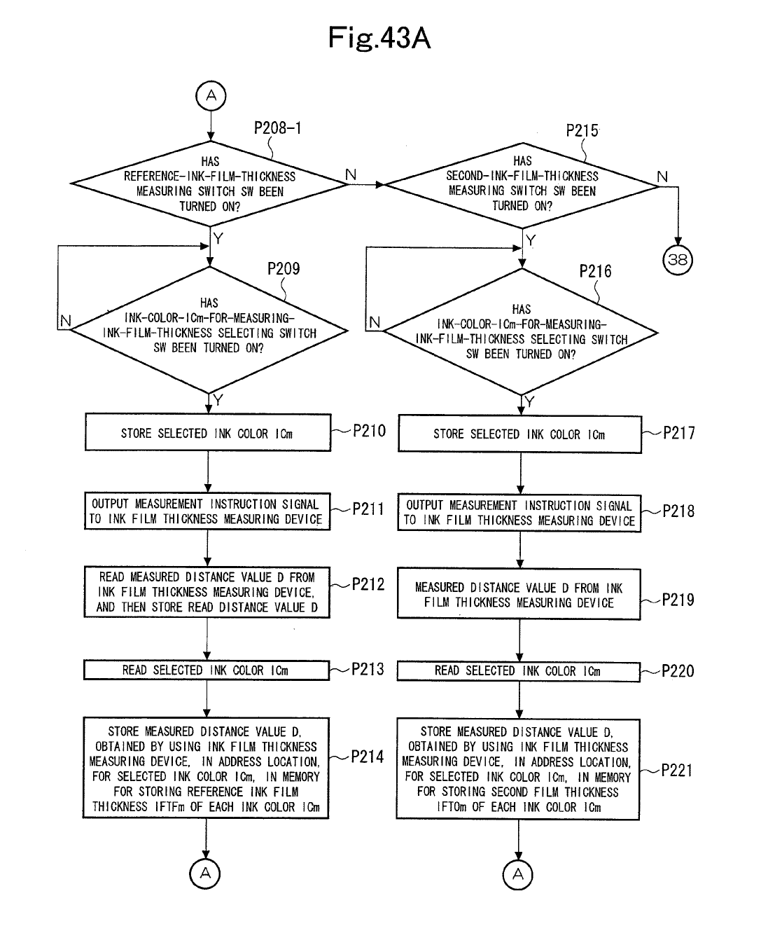

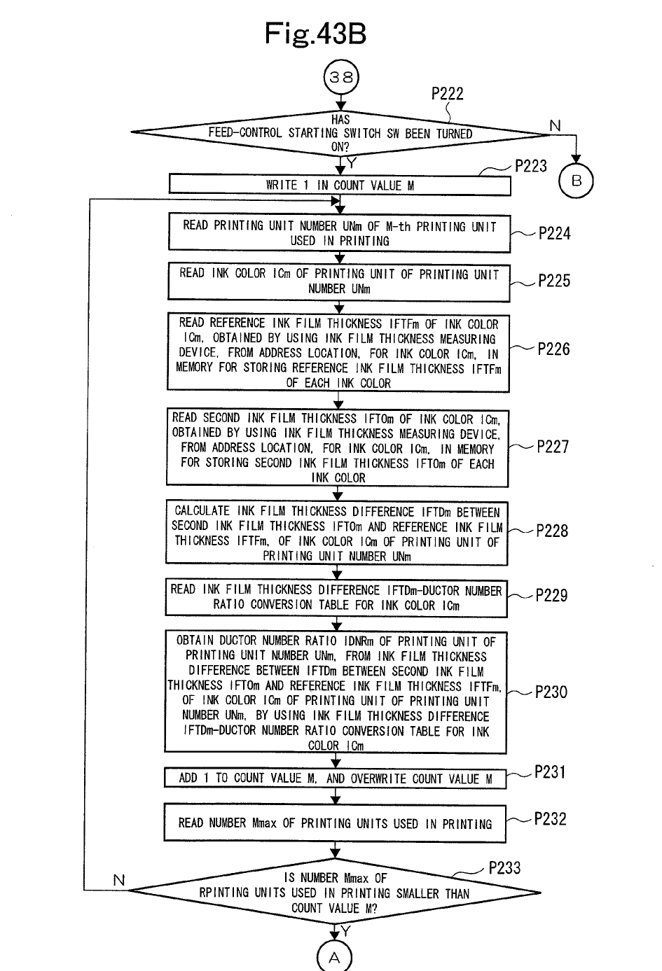

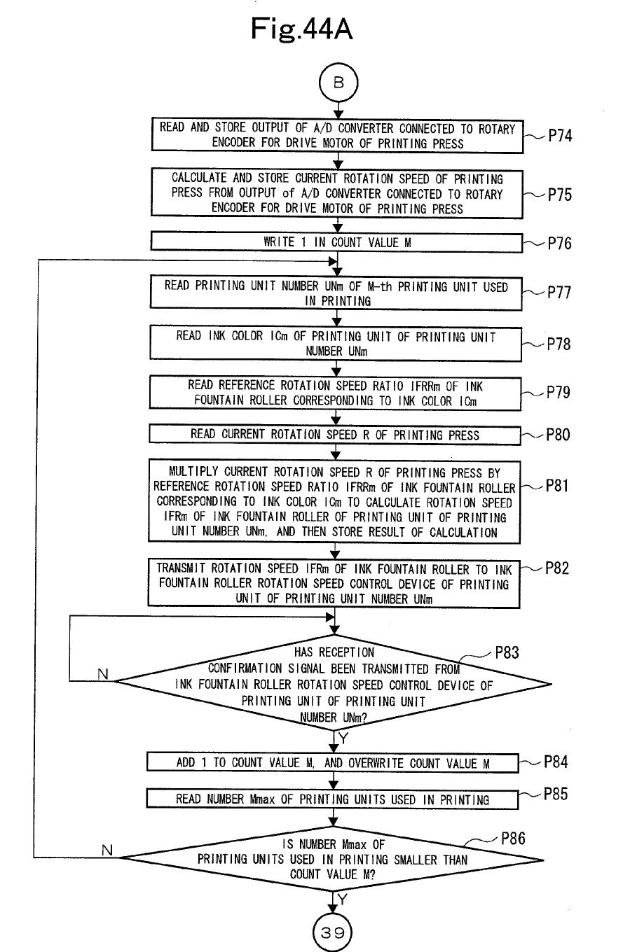

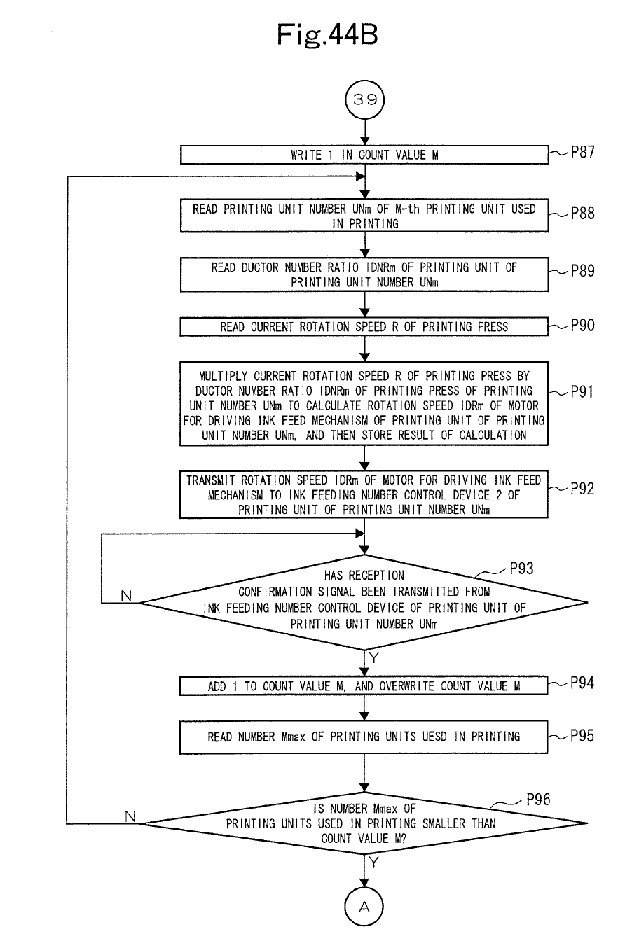

Next, the operation of the ink supply amount control apparatus according to the fourth embodiment of the present invention will be described. Each of FIGS. 42A to 42C, 43A, 43B, 44A and 44B shows an operational flowchart of the ink supply amount control apparatus according to the fourth embodiment of the present invention. Hereinafter, the content of the processing of each step will be described.

In Step P1, the CPU 10 initializes each memory. Upon completion of the processing of Step P1, the CPU 10 executes Step P2.

In Step P2, the CPU 10 determines whether or not the operator has inputted the number Mmax of printing units used in the printing, printing unit numbers UNm, ink colors ICm of the printing units of the printing unit numbers UNm, and an image area ratio IRmn of a range corresponding to each ink fountain key.

When the operator has inputted the number Mmax of printing units used in the printing, the printing unit numbers UNm, the ink colors ICm of the printing units of the printing unit numbers UNm, and the image area ratio IRmn of the range corresponding to each ink fountain key, the CPU 10 executes Step P3.

On the other hand, when the operator has not inputted the number Mmax of printing units used in the printing, the printing unit numbers UNm, the ink colors ICm of the printing units of printing unit numbers UNm, and the image area ratio IRmn of the range corresponding to each ink fountain key, the CPU 10 executes Step P2 again.

In Step P3, the CPU 10 inputs to store, the number Mmax of printing units used in the printing, the printing unit number UNm of each printing unit used in the printing, the ink colors ICm of the printing units of printing unit numbers UNm, and the image area ratio IRmn of the range corresponding to each ink fountain key, respectively in the memories M1, M2, M3, and M4. Upon completion of the processing of Step P3, the CPU 10 executes Step P4.

In Step P4, the CPU 10 determines whether or not the ink preset switch SW1 has been turned ON by the operator. When the ink preset switch SW1 has been turned ON, the CPU 10 executes Step P5. On the other hand, when the ink preset switch SW1 has not been turned ON, the CPU 10 executes Step P4 again.

In Step P5, the CPU 10 writes 1 in the count value M, that is, the CPU 10 stores 1 in the memory M5. Upon completion of the processing of Step P5, the CPU 10 executes Step P6.

In Step P6, the CPU 10 writes 1 in the count value N, that is, the CPU 10 stores 1 in the memory M6. Upon completion of the processing of Step P6, the CPU 10 executes Step P7.

In Step P7, the CPU 10 reads, from the memory M2, the printing unit number UNm of the M-th printing unit used in the printing. Upon completion of the processing of Step P7, the CPU 10 executes Step P8.

In Step P8, the CPU reads, from the memory M3, the ink color ICm of the printing unit of the printing unit number UNm. Upon completion of the processing of Step P8, the CPU 10 executes Step P9.

In Step P9, the CPU 10 reads, from the memory M7, the image area ratio-ink fountain key opening degree conversion table for the ink color ICm. Upon completion of the processing of Step P9, the CPU 10 executes Step P10.

In Step P10, the CPU 10 reads, from the memory M4, the image area ratio IRmn of the range corresponding to the N-th ink fountain key of the printing unit of the printing unit number UNm. Upon completion of the processing of Step P10, the CPU 10 executes Step P11.

In Step P11, the CPU 10 obtains the opening degree Kmn of the N-th ink fountain key of the printing unit of the printing unit number UNm, from the image area ratio IRmn of the range corresponding to the N-th ink fountain key of the printing unit of the printing unit number UNm, by using the image area ratio-ink fountain key opening degree conversion table for the ink color ICm. Then, the CPU 10 stores the obtained opening degree Kmn in the memory M8. Upon completion of the processing of Step P11, the CPU 10 executes Step P12.

In Step P12, the CPU 10 adds 1 to the count value N stored in the memory M6, and then overwrites the count value N. Upon completion of the processing of Step P12, the CPU 10 executes Step P13.

In Step P13, the CPU 10 reads, from the memory M9, the total number Nmax of ink fountain keys of each printing unit. Upon completion of the processing of Step P13, the CPU 10 executes Step P14.

In Step P14, the CPU 10 determines whether or not the total number Nmax of ink fountain keys of each printing unit, which is stored in the memory M9, is smaller than the count value N, which is stored in the memory M6. When the total number Nmax of ink fountain keys of each printing unit, is smaller than the count value N, the CPU 10 executes Step P15. On the other hand, when the total number Nmax of ink fountain keys of each printing unit is larger than, or is equal to, the count value N, the CPU 10 executes Step P7. With this loop, the CPU 10 obtains the opening degree Kin of each ink fountain key of the printing unit of the first color.

In Step P15, the CPU 10 adds 1 to the count value M stored in the memory M5, and then overwrites the count value M. Upon completion of the processing of Step P15, the CPU 10 executes Step P16.

In Step P16, the CPU 10 reads, from the memory M1, the number Mmax of printing units used in the printing. Upon completion of the processing of Step P16, the CPU 10 executes Step P17.

In Step P17, the CPU 10 determines whether or not the number Mmax of printing units used in the printing, which is stored in the memory M1, is smaller than the count value M, which is stored in the memory M5. When the number Mmax of printing units used in the printing is smaller than the count value M, the CPU 10 executes Step P18. On the other hand, when the number Mmax of printing units used in the printing is larger than, or is equal to, the count value M, the CPU 10 executes Step P6. With this loop, the CPU 10 obtains the opening degree Kmn of each ink fountain key of the printing unit of each of the first to M-th colors.

In Step P34, the CPU 10 writes 1 in the count value M, that is, the CPU 10 stores 1 in the memory M5. Upon completion of the processing of Step P34, the CPU 10 executes Step P35.

In Step P35, the CPU 10 writes 1 in the count value N, that is, the CPU 10 stores 1 in the memory M6. Upon completion of the processing of Step P35, the CPU 10 executes Step P36.

In Step P36, the CPU 10 reads, from the memory M2, the printing unit number UNm of the M-th printing unit used in the printing. Upon completion of the processing of Step P36, the CPU 10 executes Step P37.

In Step P37, the CPU 10 reads, from the memory M8, the opening degree Kmn of the N-th ink fountain key of the printing unit of the printing unit number UNm. Upon completion of the processing of Step P37, the CPU 10 executes Step P38.

In Step P38, the CPU 10 transmits the opening degree Kmn of the N-th ink fountain key to the N-th ink fountain key opening degree control device 4 of the printing unit of the printing unit number UNm. Upon completion of the processing of Step P38, the CPU 10 executes Step P39.

In Step P39, the CPU 10 determines whether or not a reception confirmation signal has been transmitted from the N-th ink fountain key opening degree control device 4 of the printing unit of the printing unit number UNm. When the reception confirmation signal has been transmitted from the N-th ink fountain key opening degree control device 4 of the printing unit of the printing unit number UNm, the CPU 10 executes Step P40. On the other hand, when the reception confirmation signal has not been transmitted from the N-th ink fountain key opening degree control device 4 of the printing unit of the printing unit number UNm, the CPU 10 executes Step P39 again.

In Step P40, the CPU 10 adds 1 to the count value N stored in the memory M6, and then overwrites the count value N. Upon completion of the processing of Step P40, the CPU 10 executes Step P41.

In Step P41, the CPU 10 reads, from the memory M9, the total number Nmax of ink fountain keys of each printing unit. Upon completion of the processing of Step P41, the CPU 10 executes Step P42.

In Step P42, the CPU 10 determines whether or not the total number Nmax of ink fountain keys of the printing unit, which is stored in the memory M9, is smaller than the count value N, which is stored in the memory M6. When the total number Nmax of ink fountain keys of the printing unit is smaller than the count value N, the CPU 10 executes Step P43. On the other hand, when the total number Nmax of ink fountain keys of the printing unit is larger than, or is equal to, the count value N, the CPU 10 executes Step P37. With this loop, the CPU 10 transmits the opening degree Kin of each ink fountain key to the corresponding ink fountain key opening degree control device 4-1-N of the printing unit of the first color.

In Step P43, the CPU 10 adds 1 to the count value M stored in the memory M5, and then overwrites the count value M. Upon completion of the processing of Step P43, the CPU 10 executes Step P44.

In Step P44, the CPU 10 reads, from the memory M1, the number Mmax of printing units used in the printing. Upon completion of the processing of Step P44, the CPU 10 executes Step P45.

In Step P45, the CPU 10 determines whether or not the number Mmax of printing units used in the printing, which is stored in the memory M1, is smaller than the count value M, which is stored in the memory M5. When the number Mmax of printing units used in the printing is smaller than the count value M, the CPU 10 executes Step P46. On the other hand, when the number Mmax of printing units used in the printing is larger than, or is equal to, the count value M, the CPU 10 executes Step P35. With this loop, the CPU 10 transmits the opening degree Kmn of each ink fountain key to the corresponding ink fountain key opening degree control device 4-M-N of the printing unit of each of the first to M-th colors.

In Step P208-1, the CPU 10 determines whether or not the reference-ink-film-thickness measuring switch SW10 has been turned ON by the operator. When the reference-ink-film-thickness measuring switch SW10 has been turned ON, the CPU 10 executes Step P209. On the other hand, when the reference-ink-film-thickness measuring switch SW10 has not been turned ON, the CPU 10 executes Step P215.

In Step P209, the CPU 10 determines whether or not the ink-color-ICm-for-measuring-ink-film-thickness selecting switch SW11 has been turned ON by the operator. When the ink-color-ICm-for-measuring-ink-film-thickness selecting switch SW11 has been turned ON, the CPU 10 executes Step P210. On the other hand, when the ink-color-ICm-for-measuring-ink-film-thickness selecting switch SW11 has not been turned ON, the CPU 10 executes Step P209 again.

In Step P210, the CPU 10 stores the selected ink color ICm in the memory M35. Upon completion of the processing of Step P210, the CPU 10 executes Step P211.

In Step P211, the CPU 10 outputs a measurement instruction signal to the ink film thickness measuring device 62. Upon completion of the processing of Step P211, the CPU 10 executes Step P212.

In Step P212, the CPU 10 reads the measured distance value D from the ink film thickness measuring device 62, which value is a digital value obtained by the conversion of the A/D converter 29. The CPU 10 then stores the read value in the memory M33. Upon completion of the processing of Step P212, the CPU 10 executes Step P213.

In Step P213, the CPU 10 reads, from the memory M35, the selected ink color ICm. Upon completion of the processing of Step P213, the CPU 10 executes Step P214.

In Step P214, the CPU 10 stores the measured distance value D from the ink film thickness measuring device 62, in an address location, for the selected ink color ICm, in the memory M37 for storing the reference ink film thickness IFTFm of each ink color ICm. Upon completion of the processing of Step P214, the CPU 10 executes Step P215 via Step P208-1. It should be noted that the operator operates the electric slide cylinder 69 and the electric slide cylinder 70 for each time of measurement so as to move the distance measurement device 71 of the ink film thickness measuring device 62 to a position of an image or a mark of an ink color ICm to be measured.

In Step P215, the CPU 10 determines whether or not the second-ink-film-thickness measuring switch SW12 has been turned ON by the operator. When the second-ink-film-thickness measuring switch SW12 has been turned ON, the CPU 10 executes Step P216. On the other hand, when the second-ink-film-thickness measuring switch SW12 has not been turned ON, the CPU 10 executes Step P222.

In Step P216, the CPU 10 determines whether or not the ink-color-ICm-for-measuring-ink-film-thickness selecting switch SW11 has been turned ON by the operator. When the ink-color-ICm-for-measuring-ink-film-thickness selecting switch SW11 has been turned ON, the CPU 10 executes Step P217. On the other hand, when the ink-color-ICm-for-measuring-ink-film-thickness selecting switch SW11 has not been turned ON, the CPU 10 executes Step P216 again.

In Step P217, the CPU 10 stores the selected ink color ICm in the memory M35. Upon completion of the processing of Step P217, the CPU 10 executes Step P218.

In Step P218, the CPU 10 outputs a measurement instruction signal to the ink film thickness measuring device 62. Upon completion of the processing of Step P218, the CPU 10 executes Step P219.

In Step P219, the CPU 10 reads the measured distance value D from the ink film thickness measuring device 62, which value is a digital value obtained by the conversion of the A/D converter 29. The CPU 10 then stores the read value in the memory M33. Upon completion of the processing of Step P219, the CPU 10 executes Step P220.

In Step P220, the CPU 10 reads, from the memory M35, the selected ink color ICm. Upon completion of the processing of Step P220, the CPU 10 executes Step P221.

In Step P221, the CPU 10 stores the measured distance value D from the ink film thickness measuring device 62, in an address location, for the selected ink color ICm, in the memory M47 for storing the second film thickness IFTOm of each ink color ICm. Upon completion of the processing of Step P221, the CPU 10 executes Step P222 via Step P208-1 and Step P215. It should be noted that the operator operates the electric slide cylinder 69 and the electric slide cylinder 70 for each time of measurement so as to move the distance measuring device 71 of the ink film thickness measuring device 62 to a position of an image or a mark of an ink color ICm to be measured.

In Step P222, the CPU 10 determines whether or not the feed-control starting switch SW13 has been turned ON by the operator. When the feed-control starting switch SW13 has been turned ON, the CPU 10 executes Step P223. On the other hand, when the feed-control starting switch SW13 has not been turned ON, the CPU 10 executes Step P74.

In Step P223, the CPU 10 writes 1 in the count value M, that is, the CPU 10 stores 1 in the memory M5. Upon completion of the processing of Step P223, the CPU 10 executes Step P224.

In Step P224, the CPU reads, from the memory M2, the printing unit number UNm of the M-th printing unit used in the printing. Upon completion of the processing of Step P224, the CPU 10 executes Step P225.

In Step P225, the CPU 10 reads, from the memory M3, the ink color ICm of the printing unit of the printing unit number UNm. Upon completion of the processing of Step P225, the CPU 10 executes Step P226.

In Step P226, the CPU 10 reads the reference ink film thickness IFTFm of the ink color ICm, obtained by using the ink film thickness measuring device 62, from the address location, for the ink color ICm, in the memory M37 for storing the reference ink film thickness IFTFm of each ink color. Upon completion of the procession of Step P226, the CPU 10 executes Step P227.

In Step P227, the CPU 10 reads the second ink film thickness IFTOm of the ink color ICm, obtained by using the ink film thickness measuring device 62, from the address location, for the ink color ICm, in the memory M47 for storing the second ink film thickness IFTOm of each ink color. Upon completion of the processing of Step P227, the CPU 10 executes Step P228.

In Step P228, the CPU 10 calculates the ink film thickness difference IFTDm between the second ink film thickness IFTOm and the reference ink film thickness IFTFm, of the ink color ICm of the printing unit of the printing unit number UNm. The CPU 10 then stores the result of the calculation in the memory M48. Upon completion of the processing of Step P228, the CPU 10 executes Step P229.

In Step P229, the CPU 10 reads, from the memory M49, the ink film thickness difference IFTDm-ductor number ratio conversion table for the ink color ICm. Upon completion of the processing of Step P229, the CPU 10 executes Step P230.

In Step P230, the CPU 10 obtains a ductor number ratio IDNRm of the printing unit of the printing unit number UNm, from the ink film thickness difference IFTDm between the second ink film thickness IFTOm and the reference ink film thickness IFTFm, of the ink color ICm of the printing unit of the printing unit number UNm, by using the ink film thickness difference IFTDm-ductor number ratio conversion table for the ink color ICm. The CPU 10 then stores the obtained value in the memory M19. Upon completion of the processing of Step P230, the CPU 10 executes Step P231.

In Step P231, the CPU 10 adds 1 to the count value M stored in the memory M5, and then overwrites the count value M. Upon completion of the processing of Step P231, the CPU 10 executes Step P232.

In Step P232, the CPU 10 reads, from the memory M1, the number Mmax of printing units used in the printing. Upon completion of the processing of Step P232, the CPU 10 executes Step P233.

In Step P233, the CPU 10 determines whether or not the number Mmax of printing units used in the printing, which is stored in the memory M1, is smaller than the count value M, which is stored in the memory M5. When the number Mmax of printing units used in the printing is smaller than the count value M, the CPU 10 executes Step P74 via Step P208-1, Step P215 and Step P222. On the other hand, when the number Mmax of printing units used in the printing is larger than, or is equal to, the count value M, the CPU 10 executes Step P224.

In Step P74, the CPU 10 reads an output of the A/D converter 30 connected to the rotary encoder 28 for the drive motor of the printing press, and then stores the value of the output in the memory M20. Upon completion of the processing of Step P74, the CPU 10 executes Step P75.

In Step P75, the CPU 10 calculates the current rotation speed R of the printing press from the output, which is stored in the memory M20, of the A/D converter 30 connected to the rotary encoder 28 for the drive motor of the printing press. The CPU 10 then stores the result of the calculation in the memory M21. Upon completion of the processing of Step P75, the CPU 10 executes Step P76.

In Step P76, the CPU 10 writes 1 in the count value M, that is, the CPU 10 stores 1 in the memory M5. Upon completion of the processing of Step P76, the CPU 10 executes Step P77.

In Step P77, the CPU 10 reads, from the memory M2, the printing unit number UNm of the M-th printing unit used in the printing. Upon completion of the processing of Step P77, the CPU 10 executes Step P78.

In Step P78, the CPU 10 reads, from the memory M3, the ink color ICm of the printing unit of the printing unit number UNm. Upon completion of the processing of Step P78, the CPU 10 executes Step P79.

In Step P79, the CPU 10 reads, from the memory M22, the reference rotation speed ratio IFRRm of the ink fountain roller corresponding to the ink color ICm. Upon completion of the processing of Step P79, the CPU 10 executes Step P80.

In Step P80, the CPU 10 reads, from the memory M21, the current rotation speed R of the printing press. Upon completion of the processing of Step P80, the CPU 10 executes Step P81.

In Step P81, the CPU 10 multiplies the current rotation speed R of the printing press by the reference rotation speed ratio IFRRm of the ink fountain roller corresponding to the ink color ICm to calculate the rotation speed IFRm of the ink fountain roller of the printing unit of the printing unit number UNm. The CPU 10 then stores the result of the calculation in the memory M23. Upon completion of the processing of Step P81, the CPU 10 executes Step P82.

In Step P82, the CPU 10 transmits the rotation speed IFRm of the ink fountain roller to the ink fountain roller rotation speed control device 3 of the printing unit of the printing unit number UNm. Upon completion of the processing of Step P82, the CPU 10 executes Step P83.

In Step P83, the CPU 10 determines whether or not a reception confirmation signal has been transmitted from the ink fountain roller rotation speed control device 3 of the printing unit of the printing unit number UNm. When the reception confirmation signal has been transmitted from the ink fountain roller rotation speed control device 3 of the printing unit of the printing unit number UNm, the CPU 10 executes Step P84. On the other hand, when the reception confirmation signal has not been transmitted from the ink fountain roller rotation speed control device 3 of the printing unit of the printing unit number UNm, the CPU 10 executes Step P83 again.

In Step P84, the CPU 10 adds 1 to the count value M stored in the memory 5, and then overwrites the count value M. Upon completion of the processing of Step P84, the CPU 10 executes Step P85.

In Step P85, the CPU 10 reads, from the memory M1, the number Mmax of printing units used in the printing. Upon completion of the processing of Step P85, the CPU 10 executes Step P86.

In Step P86, the CPU 10 determines whether or not the number Mmax of printing units used in the printing at this time, which is stored in the memory M1, is smaller than the count value M, which is stored in the memory M5. When the number Mmax of printing units used in the printing at this time is smaller than the count value M, the CPU 10 executes Step P87. On the other hand, when the number Mmax of printing units used in the printing at this time is larger than, or is equal to, the count value M, the CPU 10 executes Step P77. With this loop, the CPU 10 transmits the rotation speed IFRm of the ink fountain key roller of each color to the ink fountain roller rotation speed control device 3 of the printing unit of the color.

In Step P87, the CPU 10 writes 1 in the count value M, that is, the CPU 10 stores 1 in the memory M5. Upon completion of the processing of Step P87, the CPU 10 executes Step P88.

In Step P88, the CPU 10 reads, from the memory M2, the printing unit number UNm of the M-th printing unit used in the printing. Upon completion of the processing of Step P88, the CPU 10 executes Step P89.

In Step P89, the CPU 10 reads, from the memory M19, the ductor number ratio IDNRm of the printing unit of the printing unit number UNm. Upon completion of the processing of Step P89, the CPU 10 executes Step P90.

In Step P90, the CPU 10 reads, from the memory M21, the current rotation speed R of the printing press. Upon completion of the processing of Step P90, the CPU 10 executes Step P91.

In Step P91, the CPU 10 multiplies the current rotation speed R of the printing press by the ductor number ratio IDNRm of the printing unit of the printing unit number UNm to calculate the rotation speed IDRm of the motor for driving the ink feed mechanism of the printing unit of the printing unit number UNm. The CPU 10 then stores the result of the calculation in the memory M24. Upon completion of the processing of Step P91, the CPU 10 executes Step P92.

In Step P92, the CPU 10 transmits the rotation speed IDRm of the motor for driving the ink feed mechanism to the ink feeding number control device 2 of the printing unit of the printing unit number UNm. Upon completion of the processing of Step P92, the CPU 10 executes Step P93.

In Step P93, th CPU 10 determines whether or not a reception confirmation signal has been transmitted from the ink feeding number control device 2 of the printing unit of the printing unit number UNm. When the reception confirmation signal has been transmitted from the ink feeding number control device 2 of the printing unit of the printing unit number UNm, the CPU 10 executes Step P94. On the other hand, when the reception confirmation signal has not been transmitted from the ink feeding number control device 2 of the printing unit of the printing unit number UNm, the CPU 10 executes Step P93 again.

In Step P94, the CPU 10 adds 1 to the count value M stored in the memory M5, and then overwrites the count value M. Upon completion of the processing of Step P94, the CPU 10 executes Step P95.

In Step P95, the CPU 10 reads, from the memory M1, the number Mmax of printing units used in the printing. Upon completion of the processing of Step P95, the CPU 10 executes Step P96.

In Step P96, the CPU 10 determines whether or not the number Mmax of printing units used in the printing at this time, which is stored in the memory M1, is smaller than the count value M, which is stored in the memory M5. When the number Mmax of printing units used in the printing at this time is smaller than the count value M, the CPU 10 executes Step P208-1. On the other hand, the number Mmax of printing units used in the printing at this time is larger than, or is equal to, the count value M, the CPU 10 executes Step P88. With this loop, the CPU 10 transmits the rotation speed IDRm of the motor for driving the ink feed mechanism of each color to the ink feeding number control device 2 of the printing unit of the color.

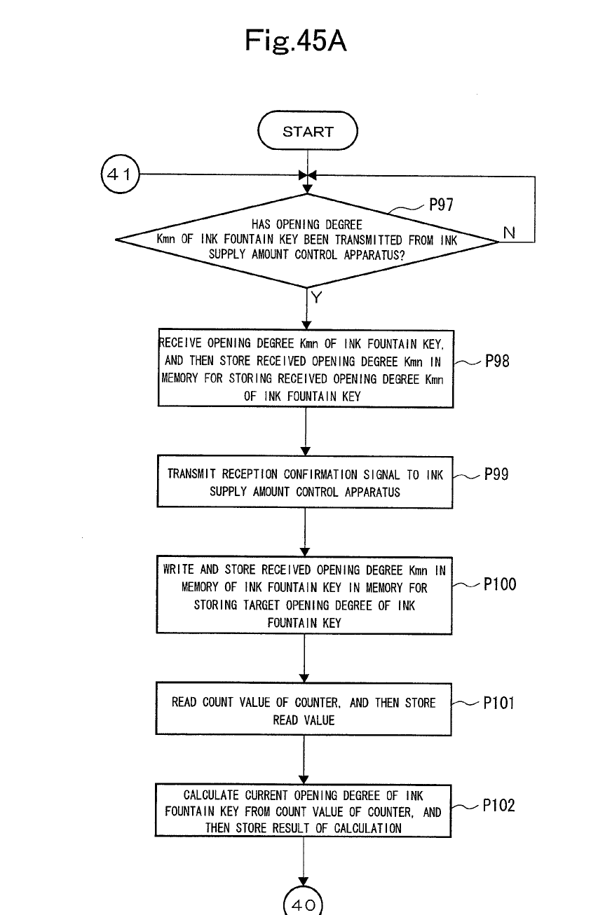

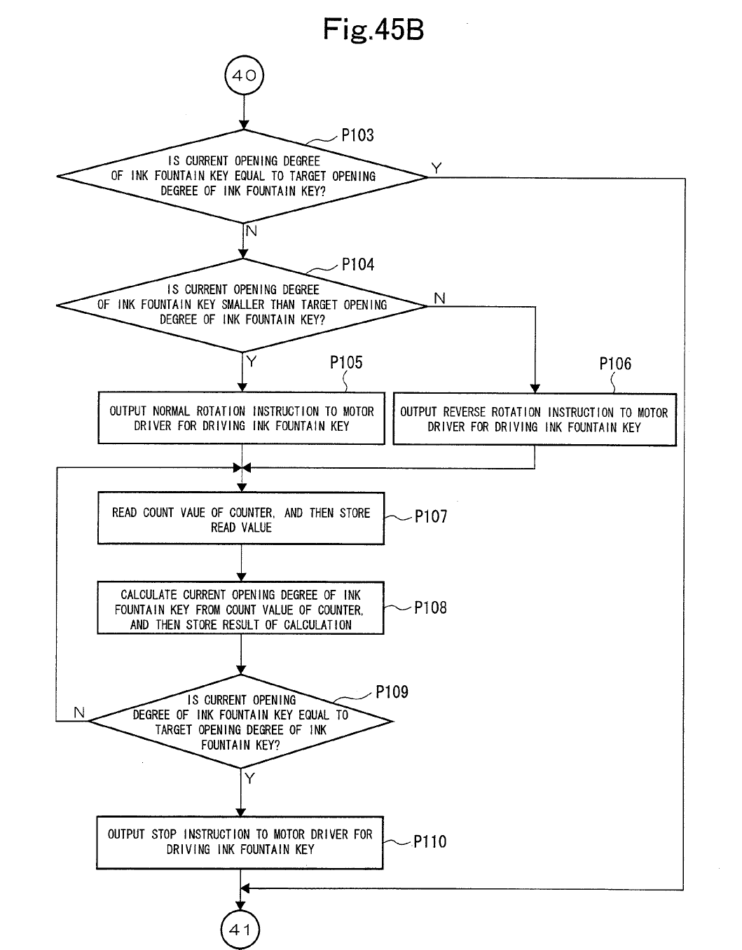

Next, descriptions will be given of the operation of the ink fountain key opening degree control device 4, which controls the opening degree of each of the ink fountain keys 109-1 to 109-N of each color, according to the fourth embodiment of the present invention. Each of FIGS. 45A and 45B shows an operational flowchart of the ink fountain key opening degree control device 4, which controls the opening degree of each of the ink fountain keys 109-1 to 109-N of each color, according to the fourth embodiment of the present invention. Hereinafter, the content of the processing of each step will be described.

In Step P97, the CPU 53 determines whether or not the opening degree Kmn of the corresponding ink fountain key has been transmitted from the ink supply amount control apparatus 1. When the opening degree Kmn of the ink fountain key has been transmitted from the ink supply amount control apparatus 1, the CPU 53 executes Step P98. On the other hand, when the opening degree Kmn of the ink fountain key has not been transmitted from the ink supply amount control apparatus 1, the CPU 53 executes Step P97 again.

In Step P98, the CPU 53 receives the opening degree Kmn of the ink fountain key, and then stores the received opening degree Kmn of the ink fountain key in the memory M29. Upon completion of the processing of Step P98, the CPU 53 executes Step P99.

In Step P99, the CPU 53 transmits a reception confirmation signal to the ink supply amount control apparatus 1. Upon completion of the processing of Step P99, the CPU 53 executes Step P100.

In Step P100, the CPU 53 writes and stores the received opening degree Kmn of the ink fountain key in the memory M30 for storing the target opening degree of the ink fountain key. Upon completion of the processing of Step P100, the CPU 53 executes Step P101.

In Step P101, the CPU 53 reads the count value of the counter 61, and then stores the read value in the memory M31. Upon completion of the processing of Step P101, the CPU 53 executes Step P102.

In Step P102, the CPU 53 calculates the current opening degree of the ink fountain key from the count value of the counter 61, and then stores the result of the calculation in the memory M32. Upon completion of the processing of Step P102, the CPU 53 executes Step P103.

In Step P103, the CPU 53 determines whether or not the current opening degree of the ink fountain key is equal to the target opening degree of the ink fountain key. When the current opening degree of the ink fountain key is equal to the target opening degree of the ink fountain key, the CPU 53 executes Step P97. On the other hand, when the current opening degree of the ink fountain key is not equal to the target opening degree of the ink fountain key, the CPU 53 executes Step P104.

In Step P104, the CPU 53 determines whether or not the current opening degree of the ink fountain key is smaller than the target opening degree of the ink fountain key. When the current opening degree of the ink fountain key is smaller than the target opening degree of the ink fountain key, the CPU 53 executes Step P105. On the other hand, when the current opening degree of the ink fountain key is larger than the target opening degree of the ink fountain key, the CPU 53 executes Step P106.

In Step P106, the CPU 53 outputs a normal rotation instruction to the motor driver 58 for driving the ink fountain key. Upon completion of the processing of Step P106, the CPU 53 executes Step P107.

In Step P105, the CPU 53 outputs a reverse rotation instruction to the motor driver 58 for driving the ink fountain key. Upon completion of the processing of Step P105, the CPU 53 executes Step P107.

In Step P107, the CPU 53 reads the count value of the counter 61, and then stores the read value in the memory M31. Upon completion of the processing of Step P107, the CPU 53 executes Step P108.

In Step P108, the CPU 53 calculates the current opening degree of the ink fountain key from the count value stored in the memory M31, and then stores the result of the calculation in the memory M32. Upon completion of the processing of Step P108, the CPU 53 executes Step P109.

In Step P109, the CPU 53 determines whether or not the current opening degree of the ink fountain key, which is stored in the memory M32, is equal to the target opening degree of the ink fountain key, which is stored in the memory M30. When the current opening degree of the ink fountain key is equal to the target opening degree of the ink fountain key, the CPU 53 executes Step P110. On the other hand, when the current opening degree of the ink fountain key is not equal to the target opening degree of the ink fountain key, the CPU 53 executes Step P107.

In Step P110, the CPU 53 outputs a stop instruction to the motor driver 58 for driving the ink fountain key. Upon completion of the processing of Step P110, the CPU 53 executes Step P97.

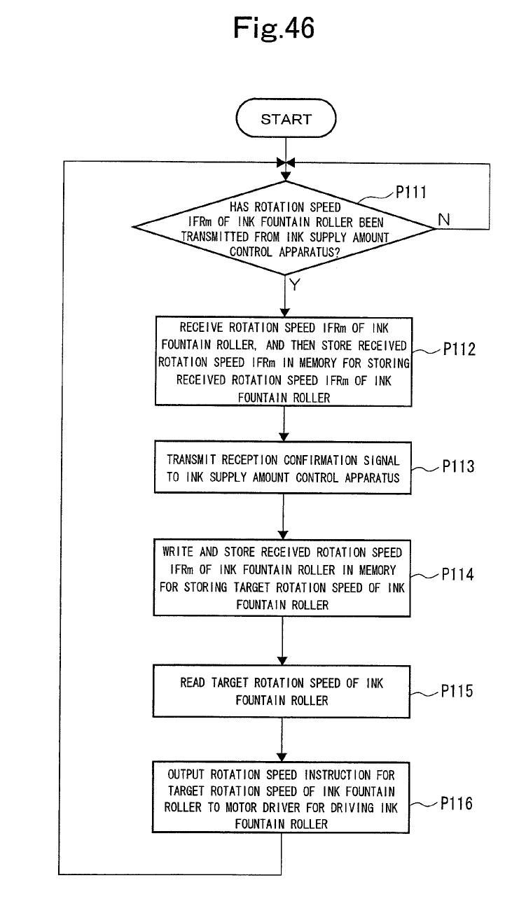

Next, descriptions will be given of the operation of the ink fountain roller rotation speed control device 3, which controls the rotation amount of each ink fountain roller, according to the fourth embodiment of the present invention. FIG. 46 shows an operational flowchart of the ink fountain roller rotation speed control device 3, which controls the rotation amount of each ink fountain roller, according to the fourth embodiment of the present invention. Hereinafter, the content of the processing of each step will be described.

In Step P111, the CPU 43 determines whether or not the rotation speed IFRm of the ink fountain roller has been transmitted from the ink supply amount control apparatus 1. When the rotation speed IFRm of the ink fountain roller has been transmitted from the ink supply amount control apparatus 1, the CPU 43 executes Step P112. On the other hand, when the rotation speed IFRm of the ink fountain roller has not been transmitted from the ink supply amount control apparatus 1, the CPU 43 executes Step P111 again.

In Step P112, the CPU 43 receives the rotation speed IFRm of the ink fountain roller, and then stores the received rotation speed IFRm of the ink fountain roller in the memory M27. Upon completion of the processing of Step P112, the CPU 43 executes Step P113.

In Step P113, the CPU 43 transmits a reception confirmation signal to the ink supply amount control apparatus 1. Upon completion of the processing of Step P113, the CPU 43 executes Step P114.

In Step P114, the CPU 43 writes and stores the received rotation speed IFRm of the ink fountain roller in the memory M28 for storing the target rotation speed of the ink fountain roller. Upon completion of the processing of Step P114, the CPU 43 executes Step P115.

In Step P115, the CPU 43 reads, from the memory M28, the target rotation speed of the ink fountain roller. Upon completion of the processing of Step P115, the CPU 43 executes Step P116.

In Step P116, the CPU 43 outputs a rotation speed instruction, for causing the ink fountain roller to rotate at the target rotation speed, to the motor driver 48 for driving the ink fountain roller. Upon completion of the processing of Step P116, the CPU 43 executes Step P111.

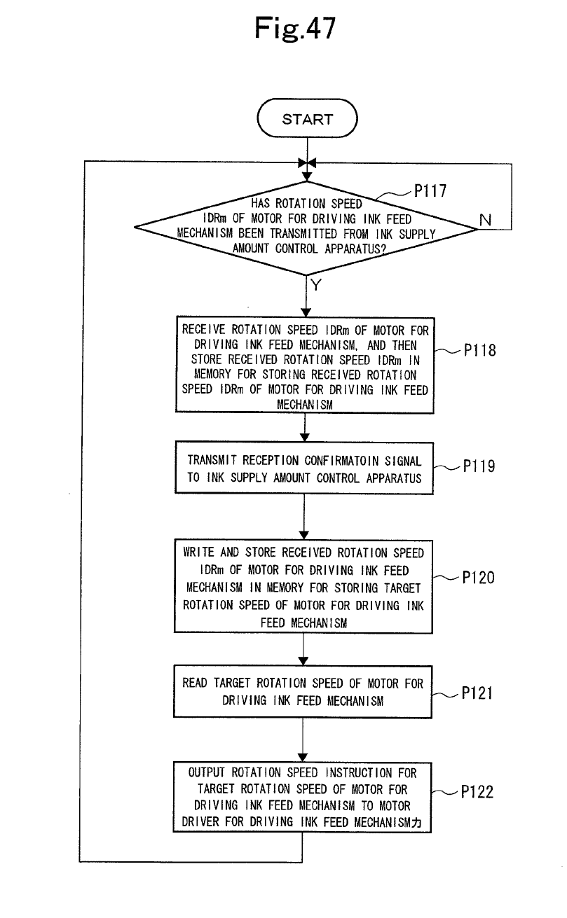

Next, descriptions will be given of the operation of the ink feeding number control device 2, which controls the number of feedings of each ink, according to the fourth embodiment of the present invention. FIG. 47 shows an operational flowchart of the ink feeding number control device 2, which controls the number of feedings of each ink, according to the fourth embodiment of the present invention. Hereinafter, the content of the processing of each step will be described.

In Step P117, the CPU 33 determines whether or not the rotation speed IDRm of the motor for driving the ink feed mechanism has been transmitted from the ink supply amount control apparatus 1. When the rotation speed IDRm of the motor for driving the ink feed mechanism has been transmitted from the ink supply amount control apparatus 1, the CPU 33 executes Step P118. On the other hand, when the rotation speed IDRm of the motor for driving the ink feed mechanism has not been transmitted from the ink supply amount control apparatus 1, the CPU 33 executes Step P117 again.

In Step P118, the CPU 33 receives the rotation speed IDRm of the motor for driving the ink feed mechanism, and then stores the received rotation speed IDRm of the motor for driving the ink feed mechanism in the memory M25. Upon completion of the processing of Step P118, the CPU 33 executes Step P119.

In Step P119, the CPU 33 transmits a reception confirmation signal to the ink supply amount control apparatus 1. Upon completion of the processing of Step P119, the CPU 33 executes Step P120.

In Step P120, the CPU 33 writes and stores the received rotation speed IDRm of the motor for driving the ink feed mechanism in the memory M26 for storing the target rotation speed of the motor for driving the ink feed mechanism. Upon completion of the processing of Step P120, the CPU 10 executes Step P121.

In Step P121, the CPU 33 reads, from the memory M26, the target rotation speed of the motor for driving the ink feed mechanism. Upon completion of the processing of Step P121, the CPU 33 executes Step P122.

In Step P122, the CPU 33 outputs a rotation speed instruction, for causing the motor 39 for driving the ink feed mechanism to rotate at the target rotation speed, to the motor driver 38 for driving the ink feed mechanism. Upon completion of the processing of Step P122, the CPU 33 executes Step P117.

According to the present invention, the adjustment of the amount of ink to be supplied is automatically controlled. Accordingly, variation in printing quality due to the difference between operators does not occur. In addition, the number of waste sheets of paper can be reduced, resulting in an environmental countermeasure. Moreover, a reduction in time taken for the adjustment leads to an increase in the amount of production.

The invention thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An ink feed control method for a printing press that includes: an ink fountain roller; a plurality of ink fountain keys aligned in the axial direction of the ink fountain roller; an ink ductor roller swingably provided in an ink supply path from the ink fountain roller to a printing plate; and ink ductor roller swing means for swinging the ink ductor roller,
in which printing press, ink, which is supplied to the ink fountain roller from a gap between each ink fountain key and the ink fountain roller by the rotation of the ink fountain roller, is supplied to the printing plate by swing operation of the ink ductor roller, so that a print is eventually made on a print sheet with the ink supplied to the printing plate,
the ink feed control method comprising:
measuring one of the density and the ink film thickness of a first printing product made by the printing press; and
controlling the number of times of the swing operation of the ink ductor roller relative to the rotation of the printing press, in accordance with the value of the measured one of the density and the ink film thickness.

2. The ink feed control method according to claim 1 further comprising:
measuring the same one of the density and the ink film thickness of a second printing product, that has been measured for the first printing product, the second printing product being printed after a predetermined number of printing products subsequent to the first printing product are made by the printing press;
calculating the difference between the values, for the first and the second printing products, of the measured one of the density and the ink film thickness, wherein
the number of times of the swing operation of the ink ductor roller relative to the rotation of the printing press is controlled in accordance with the calculated difference.

3. The ink feed control method according to claim 1 wherein the number of times of the swing operation of the ink ductor roller relative to the rotation of the printing press is controlled in accordance with an image area ratio of a printing product to be made by the printing press.

4. The ink feed control method according to claim 1 further comprising:
activating ink ductor roller stop means, which stops the swing of the ink ductor roller, in accordance with the value of the measured one of the density and the ink film thickness.

5. The ink feed control method according to claim 1 further comprising:
controlling the rotation speed of a dedicated motor, which is provided to the ink ductor roller swing means, in accordance with the value of the measured one of the density and the ink film thickness.

6. An ink feed control system for a printing press, comprising:
an ink fountain roller;
a plurality of ink fountain keys aligned in the axial direction of the ink fountain roller;
an ink ductor roller swingably provided in an ink supply path from the ink fountain roller to a printing plate;
ink ductor roller swing means for swinging the ink ductor roller, in which, ink, which is supplied to the ink fountain roller from a gap between each ink fountain key and the ink fountain roller by the rotation of the ink fountain roller, is supplied to the printing plate by swing operation of the ink ductor roller, so that a print is eventually made on a print sheet with the ink supplied to the printing plate;
one of density measurement means, which measures the density of a first printing product made by the printing press, and ink-film-thickness measurement means, which measures the ink film thickness of the first printing product; and
ink ductor roller swing number control means, which controls the number of times of the swing operation of the ink ductor roller relative to the rotation of the printing press, in accordance with the value of the measured one of the density and the ink film thickness.

7. The ink feed control system according to claim 6 wherein
the same one of the density and the ink film thickness of a second printing product is measured, that has been measured for the first printing product, the second printing product being printed after a predetermined number of printing products subsequent to the first printing product are made by the printing press,
the difference between the values, for the first and the second printing products, of the measured one of the density and the ink film thickness is then obtained, and
the number of times of the swing operation of the ink ductor roller relative to the rotation of the printing press is controlled in accordance with the obtained difference.

8. The ink feed control system according to claim 6 wherein the number of times of the swing operation of the ink ductor roller relative to the rotation of the printing press is controlled in accordance with an image area ratio of a printing product to be made by the printing press.

9. The ink feed control system according to claim 6 further comprising:
ink ductor roller stop means, which stops the swing of the ink ductor roller, wherein
the ink ductor roller stop means is activated in accordance with the value of the measured one of the density and the ink film thickness.

10. The ink feed control system according to claim 6 further comprising:
a dedicated motor for the ink ductor roller swing means, wherein
the rotation speed of the dedicated motor is controlled in accordance with the value of the measured one of the density and the ink film thickness.
